(19) United States
(12) Patent Application Publication
(10) Pub. No.: US 2023/0398517 A1
(43) Pub. Date: Dec. 14, 2023

(54) NOVEL FORMO-PHENOLIC RESINS, PROCESS FOR THE PREPARATION THEREOF, AND USE OF SAME IN THE EXTRACTION OF URANIUM FROM WATER

(71) Applicants: CENTRE NATIONAL DE LA RECHERCHE SCIENTIFIQUE (CNRS), PARIS CEDEX 16 (FR); UNIVERSITE DE MONTPELLIER (UM), MONTPELLIER (FR); COMMISSARIAT A L'ENERGIE ATOMIQUE ET AUX ENERGIES ALTERNATIVES (CEA), PARIS (FR); ECOLE NATIONALE SUPERIEURE DE CHIMIE DE MONTPELLIER (ENSCM), MONTPELLIER CEDEX 5 (FR)

(72) Inventors: Stéphane PELLET-ROSTAING, VILLEURBANNE (FR); Guilhem ARRACHART, ST LAURENT DES ARBRES (FR); Guillaume MOSSAND, LES ANGLES (FR); Antoine LEYDIER, TRESQUES (FR)

(21) Appl. No.: 18/250,415

(22) PCT Filed: Oct. 26, 2021
(86) PCT No.: PCT/EP2021/079703

§ 371 Date: Apr. 25, 2023

(30) Foreign Application Priority Data
Oct. 26, 2020 (FR) 2010967

(51) Int. Cl. B01J 20/26; C08G 8/20; C08G 8/10; C08G 8/24; B01J 20/30; B01J 20/34; G21F 9/12

(52) U.S. Cl. CPC B01J 20/267; C08G 8/20; C08G 8/10; C08G 8/24; B01J 20/3085; B01J 20/3021; B01J 20/3475; B01J 20/3425; G21F 9/12

(57) ABSTRACT

The subject matter of the present invention consists of formo-phenolic resins, a method for the preparation thereof, and the use of same in the extraction of uranium from an aqueous sample. The present invention also relates to novel formo-phenolic resins.

The subject matter of the present invention consists of formo-phenolic resins, a method for the preparation thereof, and the use of same in the extraction of uranium from an aqueous sample.

According to the IAEA (International Atomic Energy Agency), the world's nuclear power plant should increase from a capacity of approximately 377 GWe at the beginning of 2015 to a capacity of between 418 GWe and 683 GWe by 2035.

Consequently, the demand for uranium is expected to increase, requiring the search for new potentially exploitable resources.

One possible solution is the recovery of the uranium present in aqueous samples, particularly in seawater.

Indeed, although uranium is present in low concentration in seawater, on average at 3.3 pg/L, it is still the largest uranium resource on Earth with about 4.5 billion tons exploitable, about 500 times more than terrestrial uranium.

However, the low concentration of uranium in seawater is accompanied by the presence of other metals, such as sodium, potassium, magnesium, calcium and strontium in higher concentrations.

The first studies dealing with the recovery of uranium from seawater date from the early 1960s. Adsorption by chelating materials appears to be the most promising method for the recovery of uranium from seawater, in terms of operating simplicity, operating cost, environmental risk and storage capacity. adsorption.

In this context, formo-phenolic resins have for example been developed.

These resins can be formed by reacting phenol with formaldehyde. Examples of commercially available formo-phenolic resins are Resol and Novolac (L. Pilato (ed.), Phenolic Resins: A Century of Progress, Springer-Verlag Berlin Heidelberg 2010).

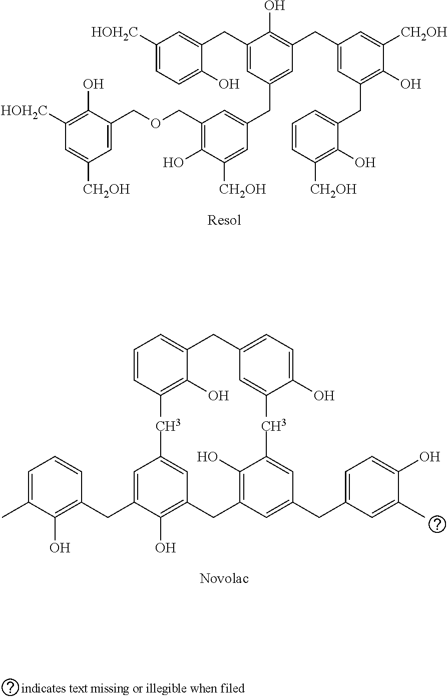

However, the materials developed to date have weaknesses in the context of their use in the extraction of uranium from a water sample, in particular a low selectivity towards competing metals.

There is therefore a real challenge in developing new materials with a very strong affinity for uranium and a very good selectivity towards several metals from seawater solution.

One of the aims of the invention is the use of formo-phenolic resins for the extraction of uranium, in particular from sea water.

One of the other objects of the invention is the provision of a method for the preparation of formo-phenolic resins.

One of the other aims of the invention is the provision of new formaldehyde-phenolic resins.

One of the other objects of the invention is to provide a method for extracting uranium from a water sample.

One of the other aims of the invention is to be able to extract uranium from a water sample with good selectivity with respect to other metals.

A first object of the present invention is the use of a crosslinked formo-phenolic resin for the extraction of uranium from an aqueous solution, in particular seawater, said resin being insoluble in an aqueous medium at a pH comprised from 3 to 10, in particular from 5 to 8, said resin consisting of a polymer containing monomer units linked together by one or more group(s) —R″—wherein R″ represents a —(CH₂)— group, a linear or branched-(CH)—C₁-C₁₀-alkyl group, a —(CH)— aryl group, a —(CH)-heteroaryl group, a linear or branched —(CH)—(C₁ to C₁₀) alkylaryl group, a linear or branched-(CH)—(C₁-C₁₀-alkyl)heteroaryl, a-(CH)-aryl-(CH)— group, a linear or branched-(CH)—(C₁ to C₁₀-alkyl)-aryl-(C₁ to C₁₀-alkyl)-(CH)-group, a-(CH)-heteroaryl-(CH), a linear or branched (CH)—(C₁ to C₁₀-alkyl)-heteroaryl-(C₁ to C₁₀-alkyl)-(CH)-group, said monomer units being:
either chelating monomer units of Formula 1

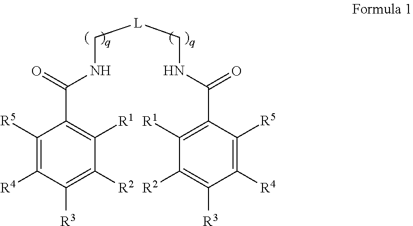

wherein:
at least one of the R¹ to R⁵ substituents represents an —OH group or a salt form, and at least one of the R¹ to R⁵ substituents represents a hydrogen atom, and wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O)NRR′ group wherein R and R′ represent independently of each other a hydrogen atom or a C₁ to C₁₀ alkyl group,
L is a linker chosen from one of the following structures:

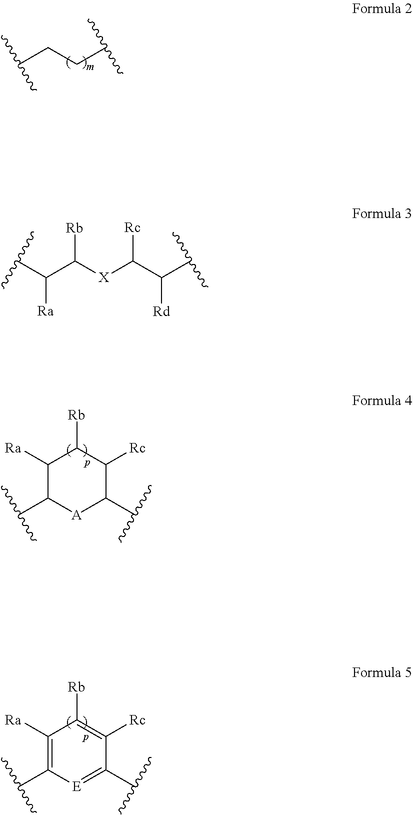

wherein:
   mm is 0, 1, 2, 3, 4 or 5,
p is 0 or 1,
A represents a —CH₂ group, a —CH—OH group, an oxygen atom, an —NH— group, a N-oxide group or a sulfur atom,
E represents a CH group, a C—OH group, an oxygen atom, a nitrogen atom, a N-oxide group or a sulfur atom,
Rₐ, R_{b}, R_{c}, and R_{d} independently represent a group chosen from:
   —OH, or a salified form, in particular chosen from —ONa, —OK, —OLi, and —OCs,
   —NH₂,
   —SH, o linear or branched C₁ to C₁₀ alkyl,
   linear or branched C₁ to C₁₀ heteroalkyl, the heteroatom being chosen in particular from O, N, S and N═O,
   aryl,
   heteroaryl, o linear or branched C₁ to C₁₀ alkylaryl,
   linear or branched C₁ to C₁₀ heteroalkylaryl, the heteroatom being chosen in particular from O, N and S, o halogen, in particular F or Cl,
   branched or unbranched C₃ to C₁₀ cycloalkyl,
   —C(O)OR wherein R represents a hydrogen atom or a C₁ to C₁₀ alkyl group,
   —P(O)(OR)(OR′) wherein R and R′ represent independently of each other a hydrogen atom, a C₁ to C₁₀ alkyl group, or a —C(O)NRR′ group wherein R and R′ represent independently of each other a hydrogen atom or a C₁ to C₁₀ alkyl group,
or chelating monomer units of Formula 6

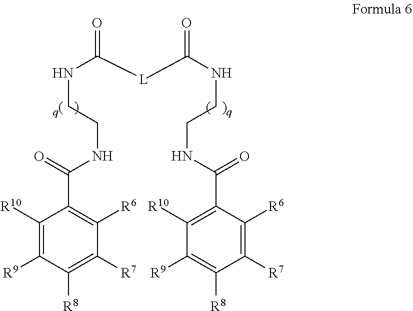

wherein:
at least one of the R⁶ to R¹⁰ substituents represent an —OH group or a salified form, and at least one of the R⁶ to R¹⁰ represent a hydrogen atom, and
wherein:
   -q and L are as defined above for Formula 1,
   —R⁶, R⁷, R⁸, R⁹ and R¹⁰ independently represent:
a hydrogen atom, or
a group chosen from:
   —OH, or a salified form, in particular chosen from —ONa, —OK, —OLi, and —OCs,
   —NH₂,
   —SH,
   linear or branched C₁ to C₁₀ alkyl,
   linear or branched C₁ to C₁₀ heteroalkyl, the heteroatom being chosen in particular from O, N, S and N═O,
   aryl,
   heteroaryl,
   linear or branched C₁ to C₁₀ alkylaryl,
   linear or branched C₁ to C₁₀ heteroalkylaryl, the heteroatom being chosen in particular from O, N and S,
   halogen, in particular F or Cl,
   branched or unbranched C₃ to C₁₀ cycloalkyl,
   —C(O)OR wherein R represents a hydrogen atom or a C₁ to C₁₀ alkyl group,
   —P(O)(OR)(OR′) wherein R and R′ independently represent a hydrogen atom, a C₁ to C₁₀ alkyl group, or a —C(O)NRR′ group wherein R and R′ represent independently of each other a hydrogen atom or a C₁ to C₁₀ alkyl group,
   or monomer units of Formula 7:

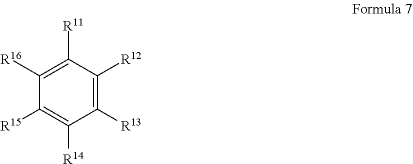

wherein:
at least one of the R¹¹ to R¹⁶ substituents represents an —OH group, or a salt form, and
at least two of the R¹¹ to R¹⁶ substituents represents a hydrogen atom, and
wherein:
—R¹¹, R¹², R¹³, R¹⁴, R¹⁵ and R¹⁶ independently represent:
a hydrogen atom, or
a group chosen from:
   —OH, or a salified form, in particular chosen from —ONa, —OK, —OLi, and —OCs,
   —NH₂,
   —SH,
   linear or branched C₁ to C₁₀ alkyl,
   linear or branched C₁ to C₁₀ heteroalkyl, the heteroatom being chosen in particular from O, N, S and N═O,
   aryl or polyaryl with 1 to 4 aromatic rings, if R¹⁵ represents an aryl or polyaryl group, said aryl or polyaryl group can be fused with the monomer unit of Formula 7 at position R¹⁶, said monomer unit of Formula 7 being in particular a naphthol,
   heteroaryl,
   linear or branched C₁ to C₁₀ alkylaryl,
   linear or branched C₁ to C₁₀ heteroalkylaryl, the heteroatom being chosen in particular from O, N and S,
   halogen, in particular F or Cl,
   linear or branched C₁ to C₁₀ alkylaryl,
   branched or unbranched C₃ to C₁₀cycloalkyl,
   —C(O)OR wherein R represents a hydrogen atom or a C₁ to C₁₀ alkyl group,
   —P(O)(OR)(OR′) wherein R and R′ independently represent a hydrogen atom, a C₁ to C₁₀ alkyl group, or a —C(O) NRR′ group wherein R and R′ are independently of each other a hydrogen atom or a C₁ to C₁₀ alkyl group,
      and wherein from 2 to 8 monomer units of Formula 7 can be linked together by a linear or branched C₁ to C₁₀ alkyl group, said monomer unit of Formula 7 being in particular a calixarene comprising from 2 to 8 monomer units of Formula 7,
      or wherein from 2 to 4 monomer units of Formula 7 can be linked together by a linear or branched C₁ to C₁₀ heteroalkyl group, the heteroatom being in particular 0, the said monomer unit of Formula 7 being in particular a crown ether comprising from 2 to 4 monomer units of Formula 7,
      or a mixture of at least two of any of the monomer units of Formulas 1, 6 and 7, wherein the structure of Formula 7 does not correspond to the structure of Formula 1 or 6, provided that if the resin consists exclusively of monomer units of Formula 7, at least two of the R″ to R¹⁶ substituent represent a group other than a hydrogen atom,
      said group —R″— being located:
either between two chelating monomer units of Formula 1, on at least one carbon atom of the monomer unit carrying a R¹ to R⁵ substituent which represents a hydrogen atom,
or between two chelating monomer units of Formula 6, on at least one carbon atom of the monomer unit carrying a R⁶ to R¹⁰ substituent which represents a hydrogen atom,
or between two monomer units of Formula 7, on at least one carbon atom of the monomer unit carrying a R¹¹ to R¹⁶ substituent which represents a hydrogen atom,
or between a chelating monomer unit of Formula 1, on at least one carbon atom of the monomer unit carrying a R¹ to R⁵ substituent which represents a hydrogen atom, and at least one carbon atom of the monomer unit of Formula 6 carrying a R⁶ to R¹⁰ substituent which represents a hydrogen atom,
or between a chelating monomer unit of Formula 1, on at least one carbon atom of the monomer unit carrying a R¹ to R⁵ substituent which represents a hydrogen atom, and at least one carbon atom of the monomer unit of Formula 7 carrying a R¹¹ to R¹⁶ substituent which represents a hydrogen atom,
or between a chelating monomer unit of Formula 6, on at least one carbon atom of the monomer unit carrying a R⁶ to R¹⁰ substituent which represents a hydrogen atom, and at least one carbon atom of the monomer unit of Formula 7 carrying a R¹¹ to R¹⁶ substituent which represents a hydrogen atom.

The inventors have surprisingly found that the resins according to the present invention, used in a method for extracting uranium, have remarkable and unprecedented extraction properties, in terms of selectivity, and in terms of ability to extraction.

A “cross-linked formo-phenolic resin”, within the meaning of the present invention, is a resin which may be the result of a reaction of monomers of Formula 1, and/or of monomers of Formula 6, and/or of monomers of Formula 7, with an aldehyde. A cross-linked structure is then formed, similar to that found in Resol or Novolac resins.

The expression “formo-phenolic” is therefore not limited to a resin based on formaldehyde and phenol, but this expression refers to resins based on any aldehyde that can lead to the —R¹¹-group as defined above. above, and the monomers as defined above.

The resins according to the present invention may, by way of example, and depending on the substitution pattern, comprise the following structural elements:

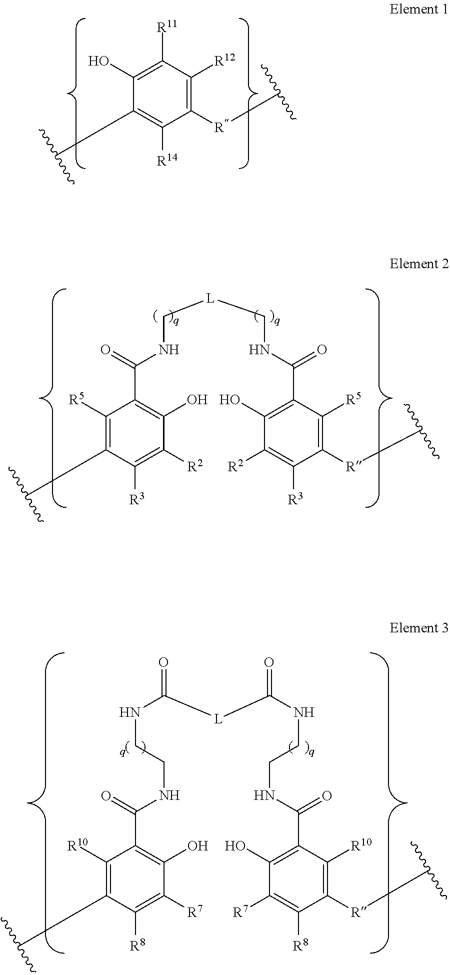

In this case, element 1 is included in a resin containing monomer units of Formula 7, wherein the R¹⁶ substituent represents an —OH group, and the R¹³ and R⁵ substituents represent a hydrogen atom.

In the resin, one or more of the R¹³ and R¹⁵ substituents no longer represent a hydrogen atom because the hydrogen atoms have been replaced by the —R″-group

The expression “at least two of the R¹¹ to R¹⁶ substituents represent a hydrogen atom,” therefore refers to the monomer units used as raw material in the formation of the resins according to the invention.

It is understood that, in the definition of the group R″, a —(CH)-alkyl group, a —(CH)-aryl group, a —(CH)-heteroaryl group, a —(CH)-alkyl aryl group, or a —(CH)-alkyl aryl group, is a group wherein the radical (CH) is attached to the monomers by two carbon-carbon bonds, as exemplified below for the particular case of —(CH)-alkyl.

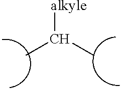

It is also understood that, in the definition of the group R¹¹, a —(CH)-aryl-(CH)— group, a —(CH)— (alkyl-aryl-alkyl)-(CH)— group, a —(CH)-heteroaryl-(CH)-group, a (CH)-alkyl-heteroaryl-alkyl)-(CH)— group, the two radicals (CH) are attached to the monomers by two carbon-carbon bonds, as exemplified below for the particular case of —(CH)-aryl-(CH)—

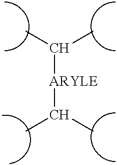

This configuration is obtained by the use of a dialdehyde in the preparation of the resin. By “linear C₁ to C₁₀ alkyl group” is meant: a C₁ methyl group, a C₂ ethyl group, a C₃ n-propyl group, a C₄ n-butyl group, a C₅ n-pentyl group, a C₆ n-hexyl group, a C₇ n-heptyl group, a C₈ n-octyl group, a C₉ n-nonyl group, or a C₁₀ n-decyl group.

By “branched alkyl group”, it is necessary to understand a linear alkyl group as defined above comprising substituents chosen from the linear alkyl groups defined above, said linear alkyl groups also being able to be branched. Among the branched alkyl groups, mention may in particular be made of a group iso-propyl, sec-butyl, iso-butyl, tert-butyl, sec-pentyl, iso-pentyl, iso-hexyl, iso-heptyl, iso-octyl, iso-nonyl and iso-decyl.

By “linear C₁ to C₁₀ heteroalkyl group”, it is meant: a linear alkyl chain of 1 to 10 carbon atom(s), in particular of 1, 2, 3, 4, 5, 6, 7, 8, 9, or 10 carbon atom(s), in particular from 2 to 10, or from 5 to 10 carbon atoms, comprising one or more heteroatoms, in particular chosen from O, S, N or NO in particular 1, 2, 3, 4 or 5 heteroatoms.

Mention may in particular be made of a chain based on ethylene glycol or ethylene amine. The linear heteroalkyl group is in particular a group —O-linear C₁ to C₁₀ alkyl, methoxy, ethoxy, n-propoxy, n-butoxy, n-pentoxy, n-hexoxy, n-heptoxy, n-octoxy, n-nonoxy, n-decoxy, or a group —NH-linear C₁ to C₁₀ alkyl, methylamine, ethylamine, n-propylamine, n-butylamine, n-pentylamine, n-hexylamine, n-heptylamine, n-octylamine, n-nonylamine, n-decylamine, or a linear —S—C₁ to C₁₀ alkyl group, methyl mercaptan, ethyl mercaptan, n-propylmercaptan, n-butylmercaptan, n-pentylmercaptan, n-hexylmercaptan, n-heptylmercaptan, n-octylmercaptan, n-nonylmercaptan,
or n-decylmercaptan,
or a —N—(O′)-linear C₁ to C₁₀ alkyl group, methylamine oxide, ethylamine oxide, n-propylamine oxide, n-butylamine oxide, n-pentylamine oxide, n-hexylamine oxide, n-heptylamine oxide, n-octylamine oxide, n-nonylamine oxide, n-decylamine oxide.

By “branched heteroalkyl group”, it is necessary to understand a heteroalkyl group as defined above comprising substituents chosen from the groups of linear alkyls or linear heteroalkyls defined above, the said linear alkyl or linear heteroalkyl groups also being capable to be branched.

The branched heteroalkyl group is in particular a branched C₃ to C₁₀-O-alkyl group, such as for example iso-propoxy, sec-butoxy, iso-butoxy, tert-butoxy, sec-pentoxy, iso-pentoxy, iso-hexoxy, iso-heptoxy, iso-octoxy, iso-nonoxy ou iso-decoxy, or a branched-NH—C₃ to C₁₀ alkyl group, such as for example iso-propylamine, sec-butylamine, iso-butylamine, tert-butylamine, sec-pentylamine, iso-pentylamine, iso-hexylamine, iso-heptylamine, iso-octylamine, iso-nonylamine ou iso-decylamine,
or a branched-S—C₃ to C₁₀ alkyl group, as per example iso-propylmercaptan, sec-butylmercaptan, iso-butylmercaptan, tert-butylmercaptan, sec-pentylmercaptan, iso-pentylmercaptan, iso-hexylmercaptan, iso-heptylmercaptan, iso-octylmercaptan, iso-nonylmercaptan ou iso-decylmercaptan,
or a —N-(O′)-branched C₃ to C₁₀ alkyl group, such as for example iso-propylamine oxide, sec-butylamine oxide, iso-butylamine oxide, tert-butylamine oxide, sec-pentylamine, iso-pentylamine oxide, iso-hexylamine oxide, iso-heptylamine oxide, iso-octylamine oxide, iso-nonylamine oxide or iso-decylamine oxide.

By “C₃ to C₁₀ cycloalkyl group” is meant: a C₃ cyclopropyl group, a C₄ cyclobutyl group, a C₅ cyclopentyl group, a C₆ cyclohexyl group, a C₇ cycloheptyl group, a C₈ cyclooctyl group, a C₉ cyclononyl group, or a C₁₀ cyclodecyl group.

A “branched cycloalkyl group” denotes a cycloalkyl group as defined above, said cycloalkyl group being substituted, in particular by a linear or branched, C₁ to C₁₀ alkyl group as defined above.

The term “aryl” denotes an aromatic group comprising 5 to 16 carbon atoms within the aromatic ring, in particular from 6 to 12 carbon atoms, in particular comprising 5, 6, 7, 8, 9, 10, 11, 12, 13, 14, 15 or 16 carbon atoms. The aryl groups according to the present invention can also be substituted, in particular by one or more substituents chosen from: a linear or branched C₁ to C₁₀ alkyl group, a linear or branched C₁ to C₁₀O-alkyl group.

Phenyl, toluyl, anisyl and naphthyl o-tolyl, m-tolyl, p-tolyl, o-xylyl, m-xylyl, p-xylyl, are examples of aryl groups according to the present invention.

The term “heteroaryl” denotes an aryl group as defined above, comprising atoms other than carbon atoms, in particular N, O or S within the aromatic ring.

Pyridyl, imidazoyl, or furanyl are examples of heteroaryl groups according to the present invention.

By way of non-limiting example, the phenolic monomer of Formula 7 can be chosen from phenol, catechol, resorcinol, hydroquinone, hydroxyquinol, phloroglucinol, pyrogallol, benzenetetrol, o-cresol, m-cresol, p-cresol, 2,3-xylenol, 2,4-xylenol, 2,5-xylenol, 2,6-xylenol, 3,4-xylenol, 3,5-xylenol, 2-hydroxybenzoic acid, 3-hydroxybenzoic acid, 4-hydroxybenzoic acid, 2,3-dihydroxybenzoic acid, 2,4-dihydroxybenzoic acid, 2,5-dihydroxybenzoic acid, 2,6-acid dihydroxybenzoic acid, 3,4-dihydroxybenzoic acid, a-resorcylic acid, pyrogallolcarboxylic acid, 2,3,5-trihydroxybenzoic acid, 2,3,6-trihydroxybenzoic acid, acid 2,4,5-trihydroxybenzoic acid, phloroglucinic acid, gallic acid, 4-hydroxybenzene phosphonic acid, 1,2-dihydroxybenzene phosphonic acid, 3,4-dihydroxybenzene phosphonic acid, 2-fluorophenol, 3-fluorophenol, 4-fluorophenol, 2,3-difluorophenol, 2,4-difluorophenol, 2,5-difluorophenol, 2,6-difluorophenol, 3,4-difluorophenol, 2,3,4-trifluorophenol, 2,3,6-trifluorophenol, 2,4,6-trifluorophenol, 2-chlorophenol, 3-chlorophenol, 4-chlorophenol, 2,3-dichlorophenol, 2,4-dichlorophenol, 2,5-dichlorophenol, 2,6-dichlorophenol, 3,4-dichlorophenol, 2,3,4- trichlorophenol, 2,3,6-trichlorophenol, 2,4,6-trichlorophenol, 2-bromophenol, 3-bromophenol, 4-bromophenol, 2,3-dibromophenol, 2,4-dibromophenol, 2,5-dibromophenol, 2,6-dibromophenol, 3,4-dibromophenol, 2,3,4-tribromophenol, 2,3,6-tribromophenol, 2,4,6-tribromophenol, bisphenol A, o-phenylphenol, m-phenylphenol, p-phenylphenol, 4-hydroxybenzo-18-crown-6,6-hydroxybenzo-15-crown-5,4-hydroxybenzo-18-crown-6,6-hydroxybenzo-18-crown-6. calix[4]resorcinarene, calix[4]hydroquinone, calix[4]arene, calix[6]arene, calix[8]arene and mixtures thereof.

The chelating monomers of Formula 1 preferably have 2, 3 or 4 R¹ to R⁵ substituents which represent a hydrogen atom,

The chelating monomers of Formula 6 preferably have 2, 3 or 4 R⁶ to R¹⁰ substituents which represent a hydrogen atom,

Monomers of Formula 7 preferably have 3 or 4 R¹¹ to R¹⁶ substituents which represent a hydrogen atom.

According to another particular embodiment, the present invention relates to the use as defined above, wherein said resin consists of a polymer containing said monomer units linked together by one or more —(CH₂)-group(s) or by one or more —(CH₂)—CH₃ group(s).

It is respectively a resin based on formaldehyde, or based on acetaldehyde.

According to another particular embodiment, the present invention relates to the use as defined above, wherein said resin consists of a polymer containing said monomer units linked together by one or more —(CH₂)-group(s).

According to this preferred embodiment, the monomer units of Formula 1 and/or of Formula 6 and/or of Formula 7 are linked together by one or more —(CH₂)-group(s).

It is a formaldehyde-based resin, or a resin that can be obtained by reacting said monomer units with formaldehyde.

According to another particular embodiment, the present invention relates to the use as defined above, wherein the chelating monomer units are of Formula 1,
wherein:
at least one of the R¹ to R⁵ substituents represents an —OH group or a form salified, and
at least one of the R¹ to R⁵ substituents represents a hydrogen atom,
and wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O and N
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
   L is a linker chosen from one of the following structures:

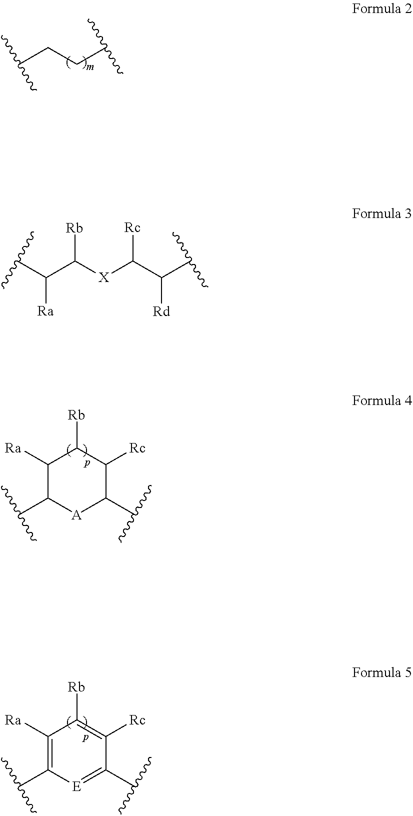

wherein:
   m is 0, 1, 2, 3, 4 or 5,
   p is 0 or 1,
   A represents a —CH₂ group, a —CH—OH group, an oxygen atom, an —NH— group, a N-oxide group or a sulfur atom,
   -E represents a CH group, a C—OH group, an oxygen atom, a nitrogen atom, a N-oxide group or a sulfur atom,
   Rₐ, R_{b}, R_{c}, and R_{d} independently represent
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N and S,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
   said chelating monomer units of Formula 1 possibly being mixed with at least one of the monomer units of Formulas 6 and 7 as defined above.

According to another particular embodiment, the present invention relates to the use as defined above, wherein the chelating monomer units are of Formula 1,
wherein:
at least one of the R¹ to R⁵ substituents represent an —OH group or a form salified,
and
at least one of the R¹ to R⁵ substituents represent a hydrogen atom, and
wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
   L is a linker chosen from one of the following structures:

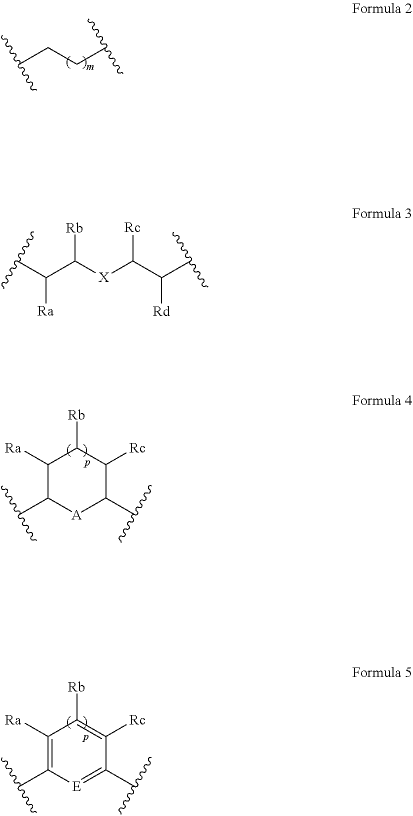

wherein
   m is 0, 1, 2, 3, 4 or 5,
   p is 0 or 1,
   A represents a group —CH₂,
   E represents a CH group, or a C—OH group,
   Rₐ, R_{b}, R_{c}, and R_{d} represent independently
   a group chosen from:
      —OH, or a salified form, in particular chosen from —ONa, —OK, —OLi, and —OCs,
      linear or branched C₁ to C₁₀ alkyl,
   said chelating monomer units of Formula 1 possibly being mixed with at least one of the monomer units of Formulas 6 and 7 as defined above.

According to another particular embodiment, the present invention relates to the use as defined above, wherein the chelating monomer units are of Formula 6,
wherein:
at least one of the R⁶ to R¹⁰ substituents represents an —OH group or a form salified, and
at least one of the R⁶ to R¹⁰ substituents represents a hydrogen atom,
and wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O and N,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
   L is a linker chosen from one of the following structures:

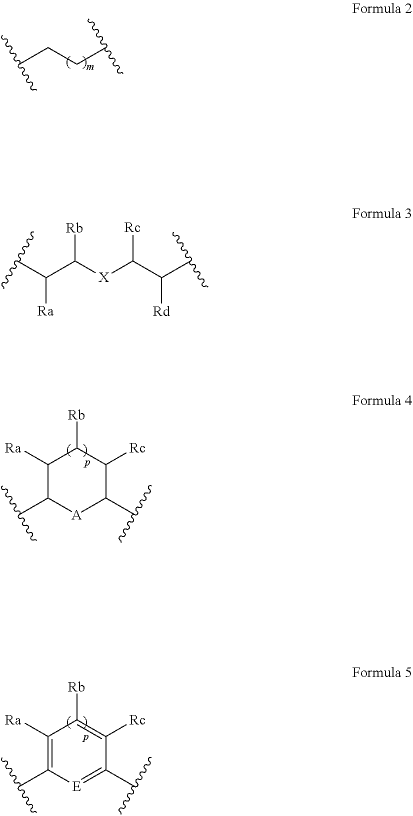

wherein:
   m is 0, 1, 2, 3, 4 or 5,
   p is 0 or 1,
   A represents a —CH₂ group, a —CH—OH group, an oxygen atom, an —NH— group, a N-oxide group or a sulfur atom,
   -E represents a CH group, a C—OH group, an oxygen atom, a nitrogen atom, a N-oxide group or a sulfur atom,
   —Rₐ, R_{b}, R_{c}, and R_{d} represent independently
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N and S,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
said chelating monomer units of Formula 6 possibly being mixed with at least one of the monomer units of Formulas 1 and 7 as defined above

According to another particular embodiment, the present invention relates to the use as defined above,
wherein the chelating monomer units are of Formula 6,
wherein:
at least one of the R⁶ to R¹⁰ substituents represent an —OH group or a form salified, and
at least one of the R⁶ to R¹⁰ substituents represent a hydrogen atom,
and wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
   L is a linker chosen from one of the following structures

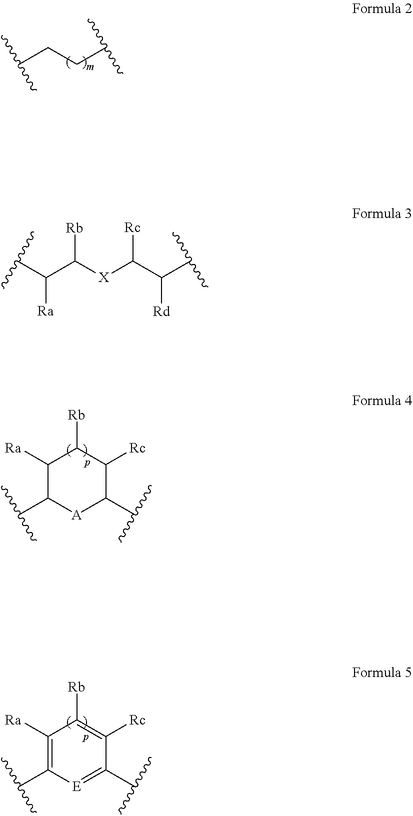

wherein
   m is 0, 1, 2, 3, 4 or 5,
   p is 0 or 1,
   A represents a —CH₂ group,
   E represents a CH group, or a C—OH group,
   Rₐ, R_{b}, R_{c}, and R_{d} represent independently
   a group chosen from:
      —OH, or a salified form, in particular chosen from —ONa, —OK, —OLi, and —OCs,
      linear or branched C₁ to C₁₀ alkyl,
said chelating monomer units of Formula 6 possibly being mixed with at least one of the monomer units of Formulas 1 and 7 as defined above.

According to another particular embodiment, the present invention relates to the use as defined above, wherein the monomer units are of Formula 7,
wherein:
at least one of the R¹¹ to R¹⁶ substituents represents an —OH group, or a form salified, and
at least two of the R¹¹ to R¹⁶ substituents represent a hydrogen atom,
and wherein:
   —R¹¹, R¹², R¹³, R¹⁴, R¹⁵ and R¹⁶ independently represent:
   a hydrogen atom,
   or a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O, N and S,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      linear or branched C₁ to C₁₀ alkylaryl,
      linear or branched C₁ to C₁₀ heteroalkylaryl, the heteroatom being chosen in particular from O, N and S,
      branched or unbranched C₃ to C₁₀ cycloalkyl,
said monomer units of Formula 7 possibly being mixed with at least one of the chelating monomer units of Formulas 1 and 6 as defined above.

According to another particular embodiment, wherein the monomer units are of Formula 7, wherein:
at least one of the R¹¹ to R¹⁶ substituents represents an —OH group, or a salified form, and
at least two of the R¹¹ to R¹⁶ substituents represent an atom of hydrogen, and wherein:
   —R¹¹, R¹², R¹³, R¹⁴, R¹⁵ and R¹⁶ independently represent:
   a hydrogen atom,
   or a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being O,
      aryl,
      linear or branched C₁ to C₁₀ alkylaryl,
      halogen, in particular F or Cl,
      linear or branched C₁ to C₁₀ alkylaryl,
      halogen, in particular F or Cl,
said monomer units of Formula 7 possibly being mixed with at least one of the chelating monomer units of Formulas 1 and 6 as defined above.

According to another particular embodiment, the present invention relates to the use as defined above, wherein the chelating monomer units of Formula 1 have the structure of Formula 8:

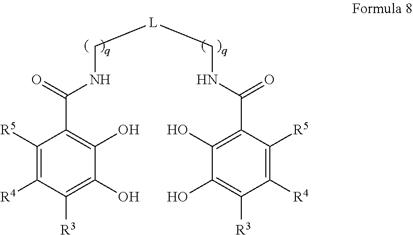

L, q, R³, R⁴ and R⁵ being as defined above, in particular the structure of Formula 9:

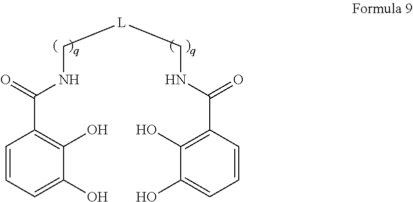

L and q being as defined above.

According to another particular embodiment, the present invention relates to the use as defined above, wherein the chelating monomer units of Formula 1 have the structure chosen from the structures of Formula 10, of Formula 11, and of Formula 12:

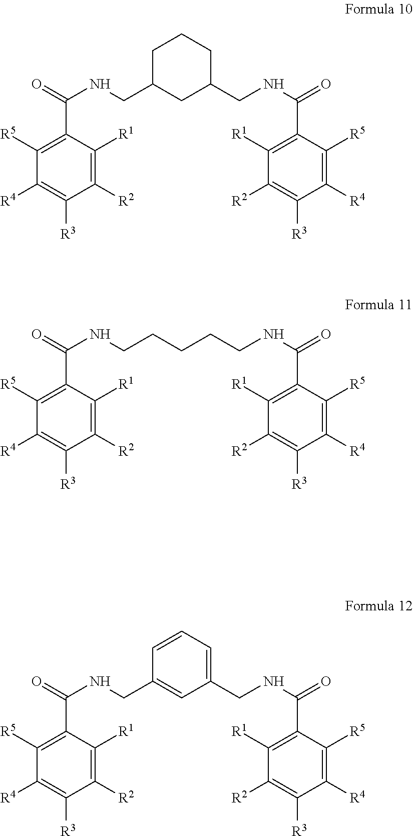

R¹, R², R³, R⁴ and R⁵ being as defined above,
in particular chosen from the structures of Formula 13, of Formula 14, and of Formula 15:

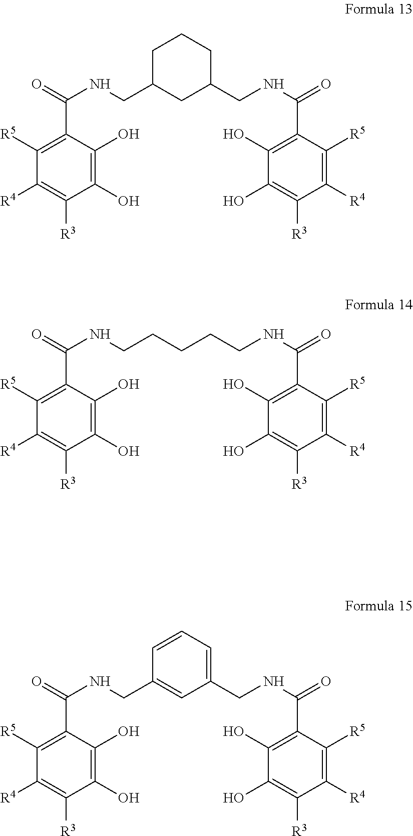

R³, R⁴ and R⁵ being as defined above,
in particular chosen from the structures Formula 16, of Formula 17, and of Formula 18:

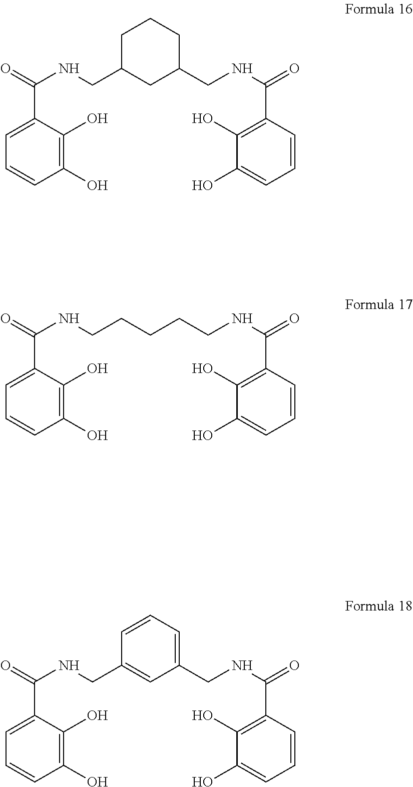 [SMILES: O=C(NCC1CCCC(CNC(=O)c2cccc(O)c2O)C1)c1cccc(O)c1O ; O=C(NCCCCCNC(=O)c1cccc(O)c1O)c1cccc(O)c1O ; O=C(NCc1cccc(CNC(=O)c2cccc(O)c2O)c1)c1cccc(O)c1O]

According to another particular embodiment, the present invention relates to the use as defined above, wherein the chelating monomer units of Formula 6 have the structure of Formula 19:

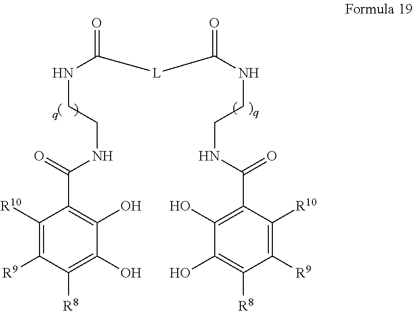

L, q, R⁸, R⁹ and R¹⁰ being as defined above.

According to another particular embodiment, the present invention relates to the use as defined above, wherein the chelating monomer units of Formula 6 have the structure of Formula 20:

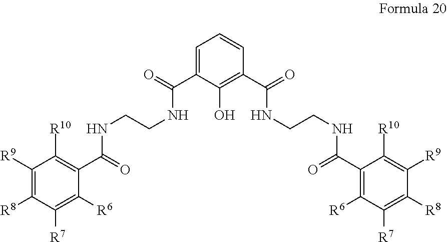

R⁶, R⁷, R⁸, R⁹ and R¹⁰ being as defined above,
in particular the structure of Formula 21

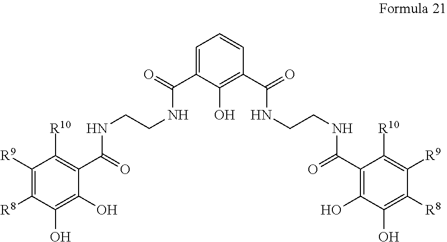

R⁸, R⁹ and R¹⁰ being as defined above,
in particular the structure of Formula 22:

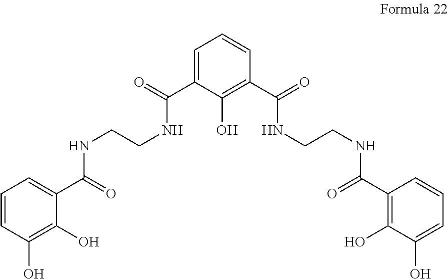 [SMILES: O=C(NCCNC(=O)c1cccc(C(=O)NCCNC(=O)c2cccc(O)c2O)c1O)c1cccc(O)c1O]

According to another particular embodiment, the present invention relates to the use as defined above, wherein the monomer units of Formula 7 have the structure of Formula 23, 24, 25 or

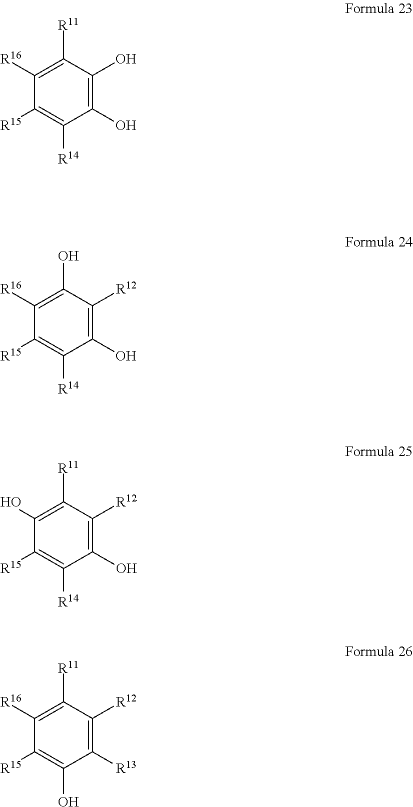

R¹¹, R¹², R¹⁴, R¹⁵ and R¹⁶ being as defined above,
in particular the structure of Formula 27, 28, or 29:

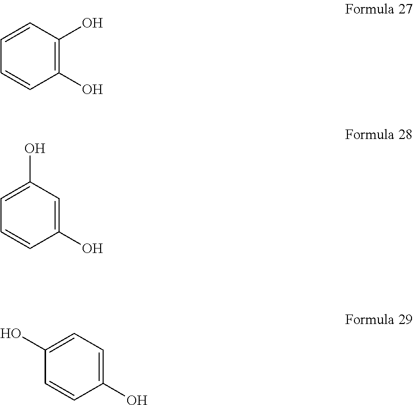 [SMILES: Oc1ccccc1O ; Oc1cccc(O)c1 ; Oc1ccc(O)cc1]

According to another particular embodiment, the present invention relates to the use as defined above, wherein the monomer units of Formula 7 have the structure of Formula 30, or 31, in particular the structure of Formula 32, or Formula 33:

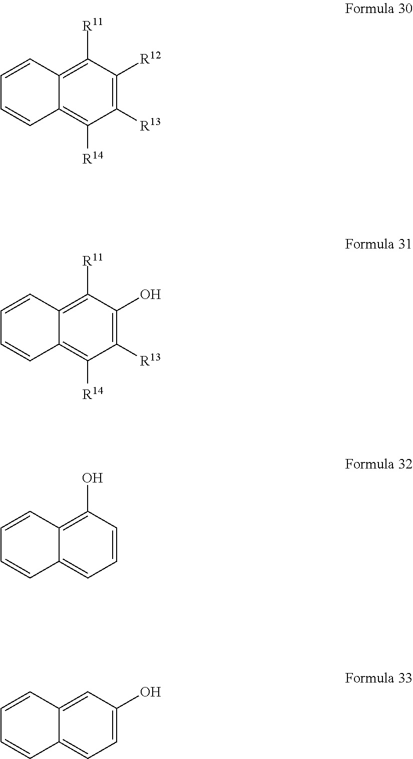

R¹¹, R¹², R¹³ and R¹⁴ being as defined above, or the structure of Formula 34, in particular the structure of Formula 35, in particular the structure of Formula 36:

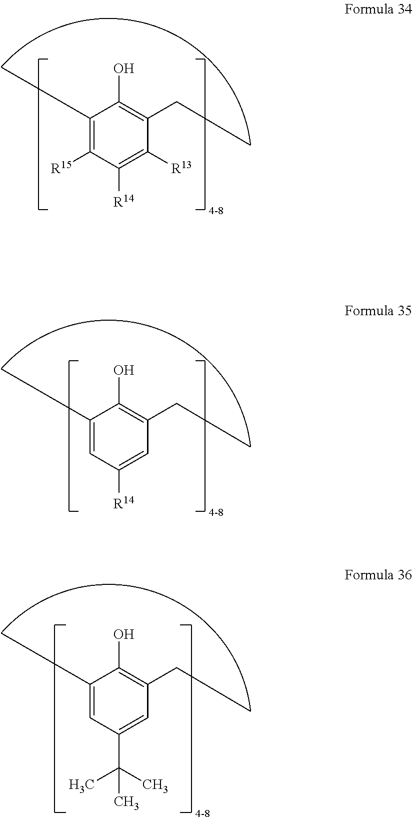

R¹³, R¹⁴ and R¹⁵ being as defined above, or the structure of Formula 37,
in particular the structure of Formula 38:

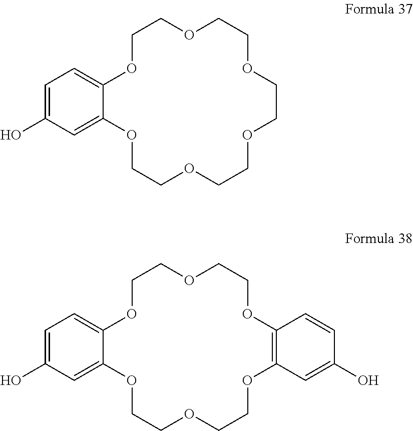 [SMILES: Oc1ccc2c(c1)OCCOCCOCCOCCOCCO2 ; Oc1ccc2c(c1)OCCOCCOc1cc(O)ccc1OCCOCCO2]

According to another particular embodiment, the present invention relates to a use as defined above, wherein: the chelating monomer units of Formula 1 have the structure of Formula 8, 9, 10, 11, 12, 13, 14 or 15:

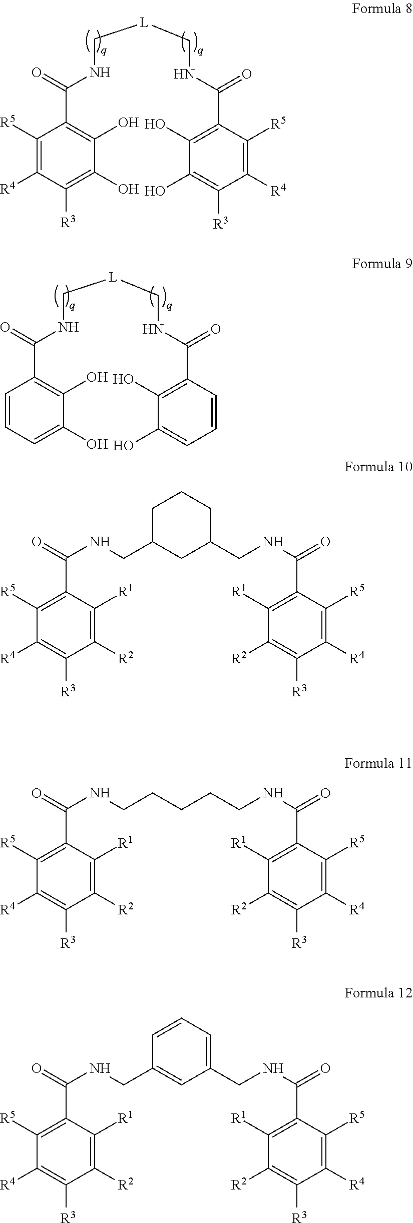

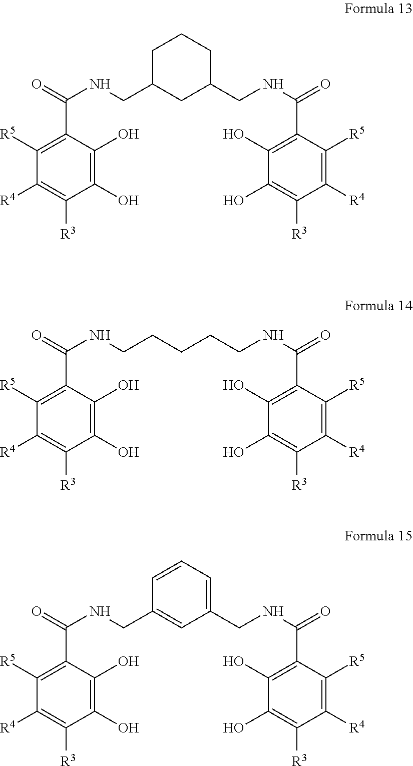

R¹, R², R³, R⁴, R⁵, L and q being as defined above,
in particular the structure of Formula 16, 17 or 18:

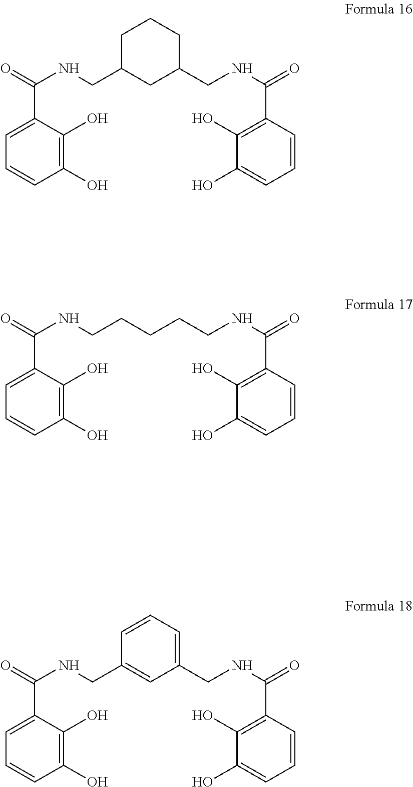 [SMILES: O=C(NCC1CCCC(CNC(=O)c2cccc(O)c2O)C1)c1cccc(O)c1O ; O=C(NCCCCCNC(=O)c1cccc(O)c1O)c1cccc(O)c1O ; O=C(NCc1cccc(CNC(=O)c2cccc(O)c2O)c1)c1cccc(O)c1O]

Formulas 8, 9, 13, 14, 15, 16, 17 and 18 wherein the —OH groups are in particular in a salified form, in particular in the —ONa form, and/or wherein the chelating monomer units of Formula 6 have the structure of Formula 19, 20 or 21:

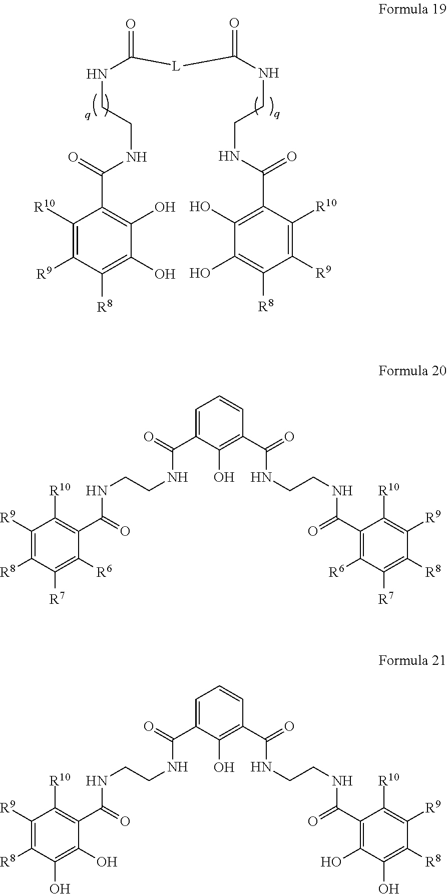

L, q, R⁶, R⁷, R⁸, R⁹ and R¹⁰ being as defined above,
in particular the structure of Formula 22:

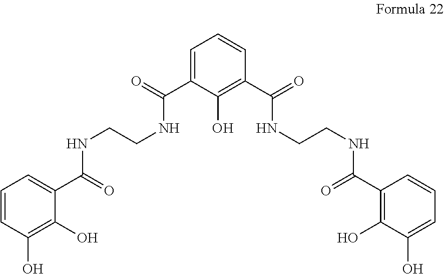 [SMILES: O=C(NCCNC(=O)c1cccc(C(=O)NCCNC(=O)c2cccc(O)c2O)c1O)c1cccc(O)c1O]

Formulas 19, 21 and 22 wherein the —OH groups are in particular in a salified form, in particular in the —ONa form, and/or
wherein the monomer units of Formula 7 have the structure of Formula 23, 24, 25 or 26:

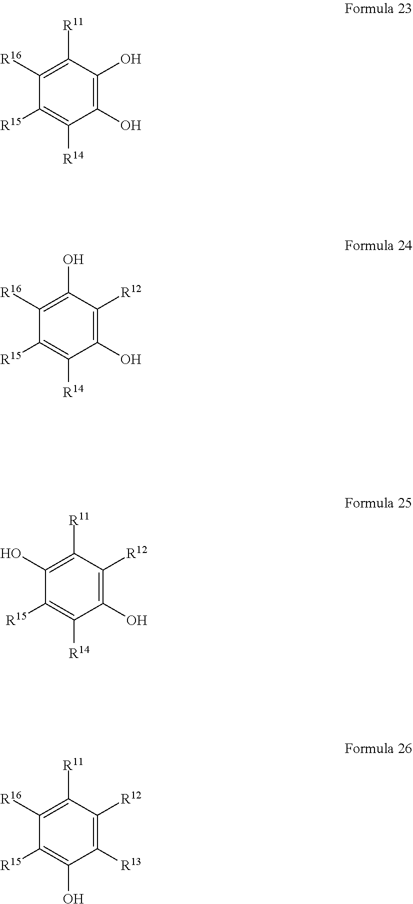

R¹¹, R¹², R¹⁴, R¹⁵ and R¹⁶ being as defined above,
in particular the structure of Formula 27, 28, or 29:

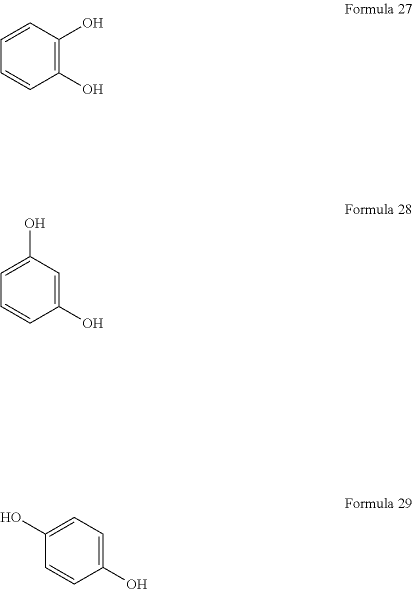 [SMILES: Oc1ccccc1O ; Oc1cccc(O)c1 ; Oc1ccc(O)cc1]

Formulas 23, 24, 25, 26, 27, 28 and 29 wherein the OH groups are in particular in a salified form, in particular in the —ONa form.

According to another particular embodiment, the present invention relates to a use as defined above, wherein said monomer units are:
either chelating monomer units of Formula 1:

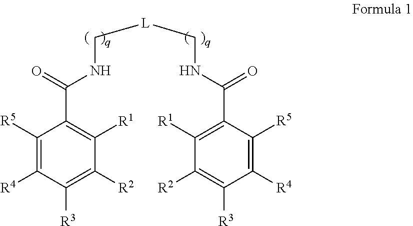

wherein:
at least one of the R¹ to R⁵ substituents represents an —OH group or a salt form, and
at least one of the R¹ to R⁵ substituents represents a hydrogen atom,
and wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O) NRR′ group wherein R and R′ represent independently of each other a hydrogen atom or a C₁ to C₁₀ alkyl group,
   L is a linker chosen from one of the following structures:

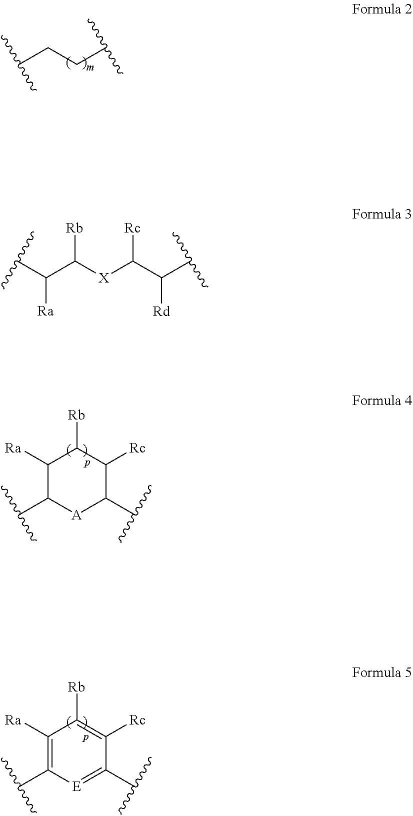

wherein:
   m is 0, 1, 2, 3, 4 or 5,
   p is 0 or 1,
   A represents a —CH₂ group, a —CH—OH group, an oxygen atom, an —NH— group, a N-oxide group or a sulfur atom,
   E represents a CH group, a C—OH group, an oxygen atom, a nitrogen atom, a N-oxide group or a sulfur atom,
   Rₐ, R_{b}, R_{c}, and R_{d} represent independently
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O) NRR′ group wherein R and R′ represent independently of each other a hydrogen atom or a C₁ to C₁₀ alkyl group,
   or chelating monomer units of Formula 6:

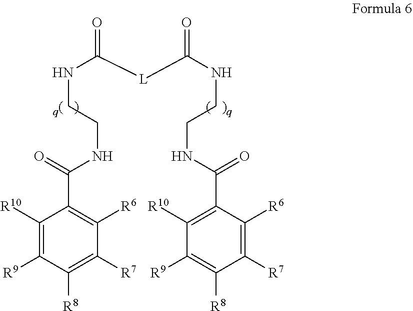

wherein:
at least one of the R⁶ to R¹⁰ substituents represents an —OH group or a salified form, and at least one of the R⁶ to R¹⁰ substituents represents a hydrogen atom,
and wherein:
   q and L are as defined above for Formula 1,
   R⁶, R⁷, R¹, R⁹ and R¹⁰ independently represent:
   a hydrogen atom, or
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O) NRR′ group wherein R and R′ independently of each other represent a hydrogen atom or a C₁ to C₁₀ alkyl group,
      and optionally monomer units of Formula 7:

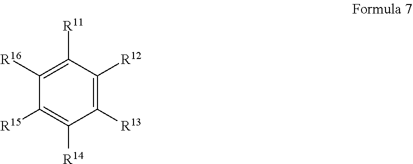

wherein:
at least one of the R¹¹ to R¹⁶ substituents represents an —OH group or a salt form, and at least two of the R¹¹ to R¹⁶ substituents represent a hydrogen atom,
and wherein:
   —R¹¹, R¹², R¹³, R¹⁴, R¹⁵ and R¹⁶ independently represent:
   a hydrogen atom, or
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl, or polyaryl of 1 to 4 aromatic rings, if R¹⁵ represents an aryl or polyaryl group, said aryl or polyaryl group can be fused with the monomer unit of Formula 7 at the R¹⁶ position, said monomer unit of Formula 7 being in particular a naphthol,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O) NRR′ group wherein R and R′ are independently of each other a hydrogen atom or a C₁ to C₁₀ alkyl group,
and wherein from 2 to 8 monomer units of Formula 7 can be linked together by a linear or branched C₁ to C₁₀ alkyl group, said monomer unit of Formula 7 being in particular a calixarene comprising from 2 to 8 monomer units of Formula 7,
or wherein from 2 to 4 monomer units of Formula 7 can be linked together by a linear or branched C₁ to C₁₀ heteroalkyl group, the heteroatom being in particular 0, the said monomer unit of Formula 7 being in particular a crown ether comprising from 2 to 4 monomer units of Formula 7,
or one of at least two of any of the monomer units of Formulas 1, 6 and 7, wherein the structure of Formula 7 does not correspond to the structure of Formula 1 or 6, said group —R¹¹— being located:
   either between two chelating monomer units of Formula 1, on at least one carbon atom of the monomer unit carrying a R¹ to R⁵ substituent which represents a hydrogen atom,
   or between two chelating monomer units of Formula 6, on at least one carbon atom of the monomer unit carrying a R⁶ to R¹⁰ substituent which represents a hydrogen atom,
   or between a chelating monomer unit of Formula 1, on at least one carbon atom of the monomer unit carrying a R¹ to R⁵ substituent which represents a hydrogen atom, and at least one carbon atom of the monomer unit of Formula 6 carrying a R⁶ to R¹⁰ substituent which represents a hydrogen atom,
   or between a chelating monomer unit of Formula 1, on at least one carbon atom of the monomer unit carrying a R¹ to R⁵ substituent which represents a hydrogen atom, and at least one carbon atom of the monomer unit of Formula 7 carrying a R¹¹ to R¹⁶ substituent which represents a hydrogen atom,
   or between a chelating monomer unit of Formula 6, on at least one carbon atom of the monomer unit carrying a R⁶ to R¹⁰ substituent which represents a hydrogen atom, and
at least one carbon atom of the monomer unit of Formula 7 carrying a R¹¹ to R¹⁶ substituent which represents a hydrogen atom.

According to another particular embodiment, the present invention relates to the use as defined above, wherein the polymer consists of 100% of chelating monomer units of Formula 1.

According to another particular embodiment, the present invention relates to the use as defined above, wherein the polymer consists of 100% of chelating monomer units of Formula 6.

According to another particular embodiment, the present invention relates to the use as defined above, wherein the polymer consists of 100% of monomer units of Formula 7, Formula 7 wherein at least two of the R¹¹ to R¹⁶ substituent represent a group other than a hydrogen atom.

According to another particular embodiment, the present invention relates to the use as defined above, wherein the polymer consists of a mixture of chelating monomer units of Formula 1 and chelating monomer units of Formula 6.

According to another particular embodiment, the present invention relates to the use as defined above, wherein the polymer consists of a mixture of chelating monomer units of Formula 1 and monomer units of Formula 7.

According to another particular embodiment, the present invention relates to the use as defined above, wherein the polymer consists of a mixture of chelating monomer units of Formula 6 and monomer units of Formula 7.

According to another particular embodiment, the present invention relates to the use as defined above, wherein the polymer consists of a mixture of chelating monomer units of Formula 1, of chelating monomer units of Formula 6, and monomer units of Formula 7.

According to another particular embodiment, the present invention relates to the use as defined above, wherein the polymer consists of:
100% Formula 1 chelating monomer units, or
100% chelating monomer units of Formula 6, or
100% monomer units of Formula 7, Formula 7 wherein at least two of the R¹¹ to R¹⁶ substituents represent a group other than a hydrogen atom, or
a mixture of chelating monomer units of Formula 1 and chelating monomer units of Formula 6, or
a mixture of chelating monomer units of Formula 1 and monomer units of Formula 7, or
a mixture of chelating monomer units of Formula 6 and monomer units of Formula 7, or
a mixture of Formula 1 chelating monomer units, Formula 6 chelating monomer units, and Formula 7 monomer units.

According to another particular embodiment, the present invention relates to the use as defined above, wherein the polymer comprises a structural unit of the Formula 39, or Formula 40:

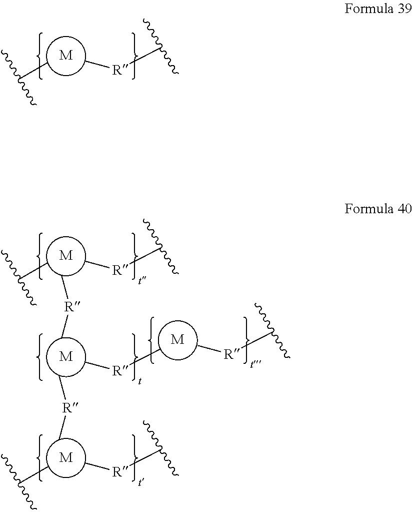

wherein:
   M is a Formula 1, Formula 6, or Formula 7 monomer unit,
   R″ is as defined above,
   t, t′, t″ and t′″ are whole numbers of 0 or 1,
   t+t′+t″+t′″=1, 2, 3 or 4.

According to this embodiment, the polymer, or the resin, is a homopolymer.

According to another particular embodiment, the present invention relates to the use as defined above, wherein the polymer comprises a structural unit of Formula 41, or of Formula 42:

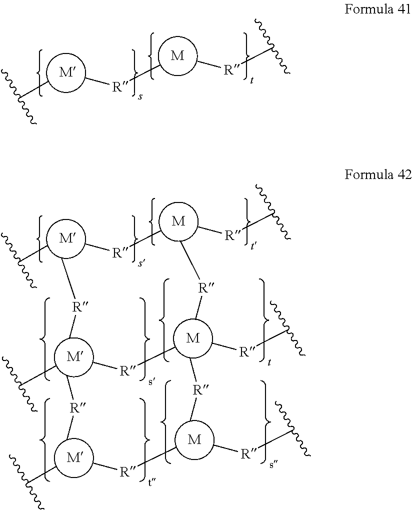

wherein:
   M and M′ are monomer units of Formula 1, Formula 6, or Formula 7,
   R″ is as defined above,
s, s′, s″, t, t′ and t″ are whole numbers equal to 0 or 1,
s+s′+s″+t+t′+t″=1, 2, 3, 4, 5 or 6.

According to this embodiment, the polymer, or the resin, is a copolymer comprising either a mixture of monomers of Formula 1 and of Formula 6, or a mixture of monomers of Formula 1 and of Formula 7, or a mixture of monomers of Formula 6 and Formula 7.

According to another particular embodiment, the present invention relates to the use as defined above, wherein the polymer comprises a structural unit of the Formula 43, or Formula 44:

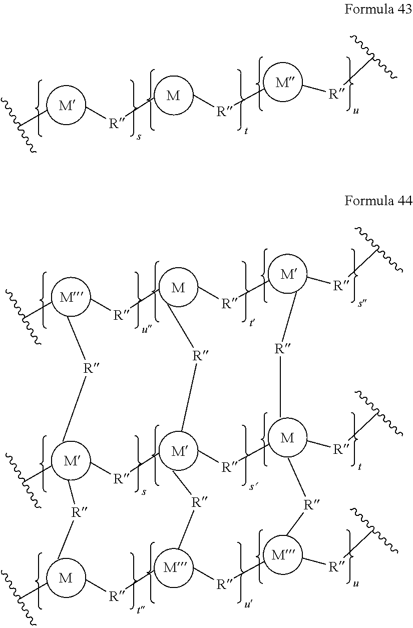

wherein:
   M, M′ and M″ are monomer units of Formula 1, Formula 6, or Formula 7,
   R″ is as defined above,
   s, s′, s″, t, t′, t″, u, u′ and u″ are whole numbers equal to 0 or 1,
   s+s′+s″+t+t′+t″+u+u′+u″=1, 2, 3, 4, 5, 6, 7, 8 or 9.

According to this embodiment, the polymer, or the resin, is a copolymer comprising a mixture of monomers of Formula 1, Formula 6 and Formula 7.

According to another particular embodiment, the present invention relates to the use as defined above, wherein the polymer consists of:
chelating monomers of Formula 17 and resorcinol, in a ratio of 50:50 or 34:66, said chelating monomer of Formula 17 and said resorcinol being salified in the form of a sodium salt,
chelating monomers of Formula 18 and resorcinol, in a ratio of 50:50 or 34:66, said chelating monomer of Formula 18 and said resorcinol being salified in the form of a sodium salt.

A second object of the present invention is a method for preparing a crosslinked formaldehyde resin, said method comprising a step of heating a reaction medium comprising:
100% chelating monomer units of Formula 1-A. or
100% chelating monomer units of Formula 6-A, or
a mixture of chelating monomer units of Formula 1-A and Formula 6-A, or
a mixture of monomer units of Formula 1-A and Formula 7-A, or
a mixture of monomer units of Formula 6-A and Formula 7-A, or
a mixture of monomer units of Formula 1-A, of Formula 6-A, and of Formula 7-A,
   and an aldehyde having the structure R′″—(CHO)ᵥ, wherein R′″ represents an atom of hydrogen, a linear or branched C₁ to C₉ alkyl group, an aryl group, a heteroaryl group, a linear or branched C₁ to C₉-alkylearyl group, a linear or branched C₁ to C₉-heteroalkyl-aryl group, a linear or branched C₁ to C₉-alkylheteroaryl group, a linear or branched C₁ to C₉-alkyl-aryl-C₁ to C₉ alkyl group, a linear or branched C₁ to C₉-alkyl-heteroaryl-C₁ to C₉-alkyl,
   and wherein v represents 1 or 2,
   a base, and optionally a solvent,
   wherein the chelating monomer units of Formula 1-A have the following structure:

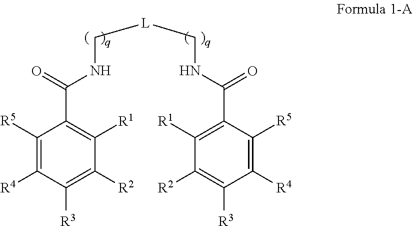

wherein:
at least one of the R¹ to R⁵ substituents represents an —OH group or a salified form, and
at least one of the R¹ to R⁵ substituents represents a hydrogen atom,
and wherein:
q is 0, 1, 2 or 3,
R¹, R², R³, R⁴ to R⁵ independently represent:
a hydrogen atom, or
a group chosen from:
   —OH, or a salified form, in particular chosen from —ONa, —OK, —OLi, and —OCs,
   —NH₂,
   —SH,
   linear or branched C₁ to C₁₀ alkyl,
   linear or branched C₁ to C₁₀ heteroalkyl, the heteroatom being chosen in particular from O, N, S and N═O,
   aryl,
   linear or branched C₁ to C₁₀ alkylaryl,
   linear or branched C₁ to C₁₀ heteroalkylaryl, the heteroatom being chosen in particular from O, N and S,
   halogen, in particular F or Cl,
   branched or unbranched C₃ to C₁₀ cycloalkyl,
   —C(O)OR wherein R represents a hydrogen atom or a C₁ to C₁₀ alkyl group,
   —P(O)(OR)(OR′) wherein R and R′ independently represent a hydrogen atom, a C₁ to C₁₀ alkyl group, or a —C(O) NRR′ group wherein R and R′ represent independently of each other a hydrogen atom or a C₁ to C₁₀ alkyl group,
L is a linker chosen from one of the following structures:

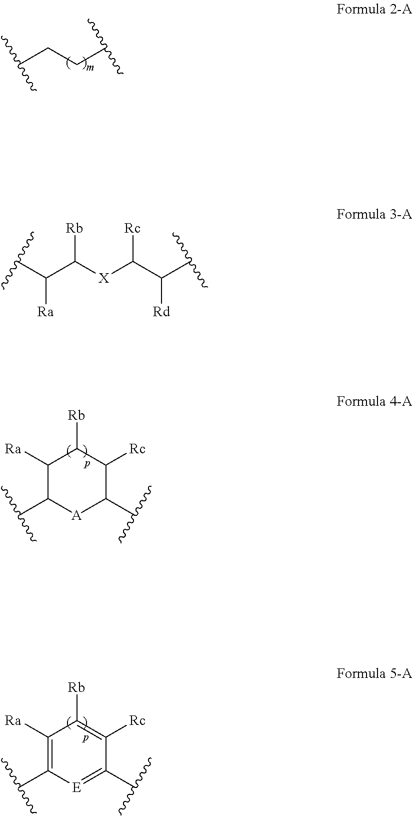

wherein:
m is 0, 1, 2, 3, 4 or 5,
p is 0 or 1,
A represents a —CH₂ group, a —CH—OH group, an oxygen atom, an —NH— group, a N-oxide group or a sulfur atom,
E represents a CH group, a C—OH group, an oxygen atom, a nitrogen atom, a N-oxide group or a sulfur atom,
Rₐ, R_{b}, R_{c}, and R_{d} represent independently
a group chosen from:
   —OH, or a salified form, in particular chosen from —ONa, —OK, —OLi, and —OCs,
   —NH₂,
   —SH,
   linear or branched C₁ to C₁₀ alkyl,
   linear or branched C₁ to C₁₀ heteroalkyl, the heteroatom being chosen in particular from O, N, S and N═O,
   aryl,
   linear or branched C₁ to C₁₀ alkylaryl,
   linear or branched C₁ to C₁₀ heteroalkylaryl, the heteroatom being chosen in particular from O, N and S,
   halogen, in particular F or Cl,
   branched or unbranched C₃ to C₁₀ cycloalkyl,
   —C(O)OR wherein R represents a hydrogen atom or a C₁ to C₁₀ alkyl group,
   —P(O)(OR)(OR′) wherein R and R′ independently represent a hydrogen atom, a C₁ to C₁₀ alkyl group, or a —C(O)NRR′ group wherein R and R′ are independently hydrogen or C₁ to C₁₀ alkyl, and wherein the chelating monomer units of Formula 6-A have the following structure:

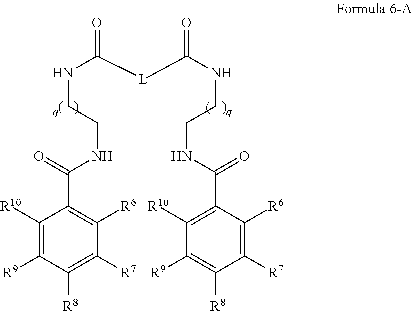

wherein:
at least one of the R⁶ to R¹⁰ substituents represents an —OH group or a salified form, and
at least one of the substituents R⁶ to R¹⁰ substituents represents a hydrogen atom, and
wherein:
-q and L are as defined above for Formula 1-A,
—R⁶, R⁷, R¹, R⁹ and R¹⁰ independently represent:
a hydrogen atom, or
a group chosen from:
   —OH, or a salified form, in particular chosen from —ONa, —OK, —OLi, and —OCs,
   —NH₂,
   —SH,
   linear or branched C₁ to C₁₀ alkyl,
   linear or branched C₁ to C₁₀ heteroalkyl, the heteroatom being chosen in particular from O, N, S and N═O,
   aryl,
   linear or branched C₁ to C₁₀ alkylaryl,
   linear or branched C₁ to C₁₀ heteroalkylaryl, the heteroatom being chosen in particular from O, N and S,
   halogen, in particular F or Cl,
   branched or unbranched C₃ to C₁₀ cycloalkyl,
   —C(O)OR wherein R represents a hydrogen atom or a C₁ to C₁₀ alkyl group,
   —P(O)(OR)(OR′) wherein R and R′ independently represent a hydrogen atom, a C₁ to C₁₀ alkyl group, or a —C(O)NRR′ group wherein R and R′ are independently hydrogen or C₁ to C₁₀ alkyl, and wherein the monomer units of Formula 7-A have the following structure:

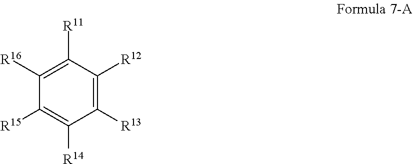

wherein:
at least one of the R¹¹ to R¹⁶ substituents represents an —OH group or a salified form, and
at least two of the R¹¹ to R¹⁶ substituents represent a hydrogen atom, and
wherein:
R¹¹, R¹², R¹³, R¹⁴, R¹⁵ and R¹⁶ independently represent:
a hydrogen atom, or
a group chosen from:
   —OH, or a salified form, in particular chosen from —ONa, —OK, —OLi, and —OCs,
   —NH₂,
   —SH,
   linear or branched C₁ to C₁₀ alkyl,
   linear or branched C₁ to C₁₀ heteroalkyl, the heteroatom being chosen in particular from O, N, S and N═O,
   aryl, or polyaryl of 1 to 4 aromatic rings, if R¹⁵ represents an aryl or polyaryl group, said aryl or polyaryl group can be fused with the monomer unit of Formula 7-A at the R¹⁶ position, said monomer unit of Formula 7-A being in particular a naphthol,
   linear or branched C₁ to C₁₀ alkylaryl,
   linear or branched C₁ to C₁₀ heteroalkylaryl, the heteroatom being chosen in particular from O, N and S,
   halogen, in particular F or Cl,
   branched or unbranched C₃ to C₁₀ cycloalkyl,
   —C(O)OR wherein R represents a hydrogen atom or a C₁ to C₁₀ alkyl group,
   —P(O)(OR)(OR′) wherein R and R′ independently represent a hydrogen atom, a C₁ to C₁₀ alkyl group, or a —C(O)NRR′ group wherein R and R′ are independently of each other a hydrogen atom or a C₁ to C₁₀ alkyl group,
      and wherein from 2 to 8 monomer units of Formula 7-A can be linked together by a linear or branched C₁ to C₁₀ alkyl group, said monomer unit of Formula 7-A being in particular a calixarene comprising from 2 to 8 monomer units of Formula 7-A,
      or wherein from 2 to 4 monomer units of Formula 7-A may be linked to each other by a linear or branched C₁ to C₁₀ heteroalkyl group, the heteroatom being in particular 0, the said monomer unit of Formula 7-A being in particular a crown ether comprising from 2 to 4 monomer units of Formula 7-A, to obtain a crosslinked resin consisting of a polymer containing monomer units bonded together by an —R″— group.

According to another particular embodiment, the present invention relates to a method of preparation as defined above, wherein the chelating monomer units are of Formula 1-A, said chelating monomer units of Formula 1-A possibly being mixed with at least one of the monomer units of Formulas 6-A and 7-A as defined above, said Formula 1-A being such that:
at least one of the R¹ to R⁵ substituents represents an —OH group or a salified form, and
at least one of the R¹ to R⁵ substituents represents a hydrogen atom, and
   -q is 0, 1, 2 or 3,
   —R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O and N,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      L is a linker chosen from one of the following structures:

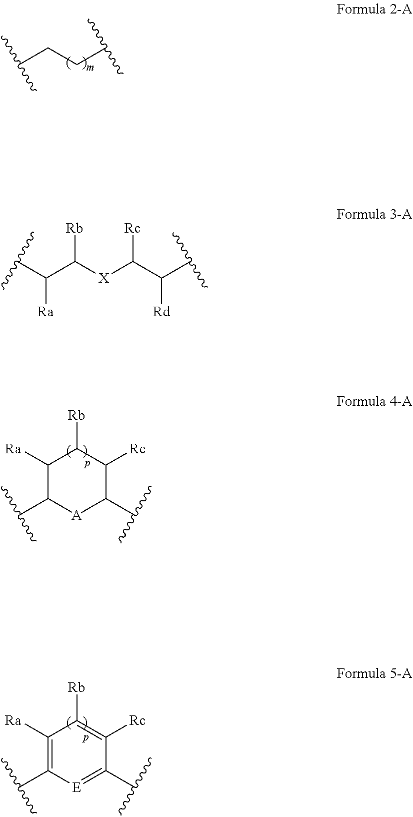

wherein:
   m is 0, 1, 2, 3, 4 or 5,
   p is 0 or 1,
   A represents a —CH₂ group, a —CH—OH group, an oxygen atom, an —NH— group, an N-oxide group or a sulfur atom,
   E represents a CH group, a C—OH group, an oxygen atom, a nitrogen atom, an N-oxide group or a sulfur atom,
   Rₐ, R_{b}, R_{c}, and R_{d} represent independently
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N and S,
      aryl,
      heteroaryl, linear or branched C₁ to C₁₀ alkylaryl, linear or branched C₁ to C₁₀ heteroalkylaryl, the heteroatom being chosen in particular from O, N and S,
      halogen, in particular F or Cl,
      branched or unbranched C₃ to C₁₀ cycloalkyl.

According to another particular embodiment, wherein the chelating monomer units are of Formula 1-A,
said chelating monomer units of Formula 1-A being able to be mixed with at least one of the monomer units of Formulas 6-A and 7-A as defined above,
said Formula 1-A being such that:
at least one of the R¹ to R⁵ substituents represents an —OH group or a salified form, and
at least one of the R¹ to R⁵ substituents represents a hydrogen atom, and
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
   L is a linker chosen from one of the following structures:

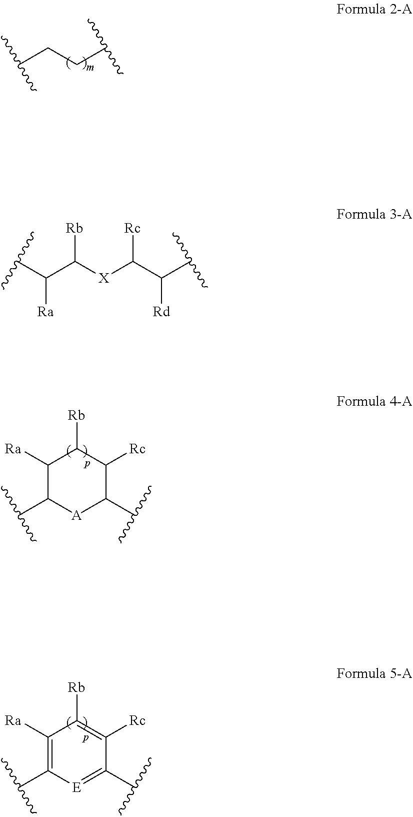

Wherein:
   m is 0, 1, 2, 3, 4 or 5,
   p is 0 or 1,
   A represents a —CH₂ group,
   E represents a CH group, or a C—OH group,
   Rₐ, R_{b}, R_{c}, and R_{d} represent independently
   a group chosen from:
      —OH, or a salified form, in particular chosen from —ONa, —OK, —OLi, and —OCs,
      linear or branched C₁ to C₁₀ alkyl.

According to another particular embodiment, wherein the chelating monomer units are of Formula 6-A,
said chelating monomer units of Formula 6-A being able to be mixed with at least one of the monomer units of Formulas 1-A and 7-A as defined above,
said Formula 6-A being such that:
at least one of the R⁶ to R¹⁰ substituents represents an —OH group or a salified form, and
at least one of the R⁶ to R¹⁰ substituents represents a hydrogen atom, and
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O and N,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
   L is a linker chosen from one of the following structures:

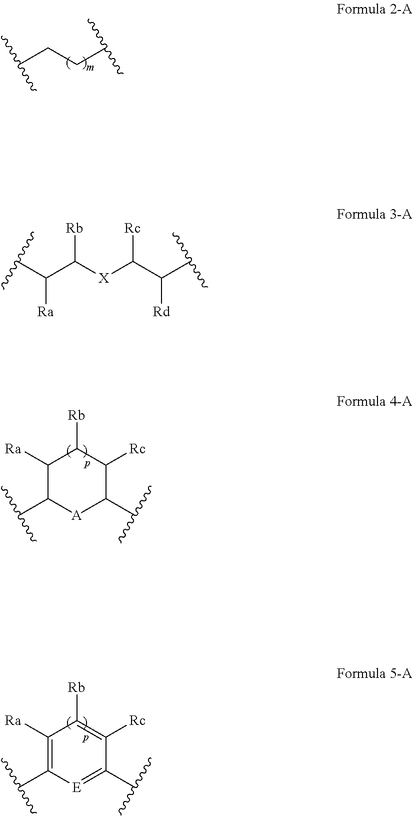

wherein:
   m is 0, 1, 2, 3, 4 or 5,
   p is 0 or 1,
   A represents a —CH₂ group, a —CH—OH group, an oxygen atom, an —NH— group, an N-oxide group or a sulfur atom,
   E represents a CH group, a C—OH group, an oxygen atom, a nitrogen atom, an N-oxide group or a sulfur atom,
   Rₐ, R_{b}, R_{c}, and R_{d} represent independently a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N and S,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl.

According to another particular embodiment, the present invention relates to a method of preparation as defined above, wherein the chelating monomer units are of Formula 6-A, said chelating monomer units of Formula 6-A possibly being mixed with at least one of the monomer units of Formulas 1-A and 7-A as defined above,
said Formula 6-A being such that:
at least one of the R⁶ to R¹⁰ substituents represents an —OH group or a salified form, and
at least one of the R⁶ to R¹⁰ substituents represents a hydrogen atom, and
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
   L is a linker chosen from one of the following structures:

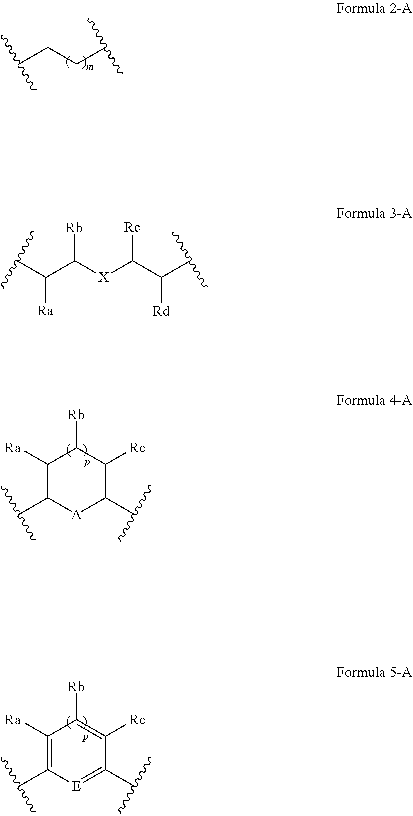

wherein:
   m is 0, 1, 2, 3, 4 or 5,
   p is 0 or 1,
   A represents a —CH₂ group,
   E represents a CH group, or a C—OH group,
   Rₐ, R_{b}, R_{c}, and R_{d} represent independently
   a group chosen from:
      —OH, or a salified form, in particular chosen from —ONa, —OK, —OLi, and —OCs,
      linear or branched C₁ to C₁₀ alkyl.

According to another particular embodiment, the present invention relates to a method of preparation as defined above, wherein the monomer units are of Formula 7-A, said monomer units of Formula 7-A being mixed with one at least monomer units of Formula 1-A and 6-A as defined above,
said Formula 7-A being such that: at least one of the R¹¹ to R¹⁶ substituents represents an —OH group or a salified form, and
at least two of the R¹¹ to R¹⁶ substituents represent a hydrogen atom,
and
   R¹¹, R¹², R¹³, R¹⁴, R¹⁵ and R¹⁶ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O, N and S,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl.

According to another particular embodiment, wherein the monomer units are of Formula 7-A, said monomer units of Formula 7-A being mixed with at least one of the monomer units of Formula 1-A and 6-A such as defined above,
said Formula 7-A being such that:
at least one of the R¹¹ to R¹⁶ substituents represents an —OH group or a salified form, and
at least two of the R¹¹ to R¹⁶ substituents represent a hydrogen atom, and
   R¹¹, R¹², R¹³, R¹⁴, R¹⁵ and R¹⁶ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being 0,
      aryl,
      linear or branched C₁ to C₁₀ alkylaryl,
      halogen, in particular F or Cl,
      linear or branched C₁ to C₁₀ alkylaryl,
      halogen, in particular F or Cl.

According to another particular embodiment, the present invention relates to a preparation method as defined above, wherein the base is a strong base, chosen in particular from lithium hydroxide, sodium hydroxide, potassium hydroxide or cesium hydroxide, in particular sodium hydroxide.

According to another particular embodiment, the present invention relates to a preparation method as defined above, wherein the solvent is water.

According to another particular embodiment, the present invention relates to a preparation method as defined above, wherein the aldehyde is chosen from formaldehyde, acetaldehyde, ethanal, n-propanal, isopropanal, n-butanal, isobutanal, n-pentanal, isopentanal, n-hexanal, isohexanal, n-heptanal, isoheptanal, n-octanal, isooctanal, n-nonanal, isononanal, n-decanal, isodecanal, benzaldehyde, terephthalaldehyde, isophthalaldehyde, glyoxal, furfural, succinaldehyde, glutaraldehyde, and trimesaldehyde.

According to another particular embodiment, the present invention relates to a preparation method as defined above, wherein the aldehyde is formaldehyde or acetaldehyde.

According to another particular embodiment, the present invention relates to a preparation method as defined above, wherein the aldehyde is formaldehyde, in particular in the form of formaldehyde, paraformaldehyde, or 1,3,5-tri oxane.

According to another particular embodiment, the present invention relates to a preparation method as defined above, wherein the heating step is carried out at a temperature of between 80° C. and 150° C.

“Temperature between 80° C. and 150° C.” also means the following ranges: from 80° C. to 140° C., from 80° C. to 130° C., from 80° C. to 120° C., from 80° C. ° C. to 110° C., from 80° C. to 100° C., from 80° C. to 90° C., from 90° C. to 150° C., from 100° C. to 150° C., from 110° C. to 150° C., 120° C. to 150° C., 130° C. to 150° C., 140° C. to 150° C., 90° C. to 140° C., and 100° C. to 120° C.

According to another particular embodiment, the present invention relates to a method of preparation as defined above, wherein the heating step is carried out for a time comprised from 16 to 96 hours, in particular approximately 24, 48, or 72 hours.

According to another particular embodiment, the present invention relates to a preparation method as defined above, further comprising, after the heating step, at least one washing step, said washing step being carried out in particular with:
an aqueous solution of a strong base, in particular sodium hydroxide, then water, to obtain a formo-phenolic resin wherein the —OH groups are salified, in particular in the —ONa form, or
an aqueous solution of a strong base, in particular sodium hydroxide, then an aqueous solution of hydrochloric acid, then water, to obtain a formo-phenolic resin comprising —OH groups.

According to another particular embodiment, the present invention relates to a preparation method as defined above, wherein:
the base is a strong base, chosen in particular from lithium hydroxide, sodium hydroxide, potassium hydroxide or cesium hydroxide, in particular sodium hydroxide, and/or
the solvent is water, and/or
the heating step is carried out at a temperature between 80° C. and 150° C., and/or
the heating step is carried out for a time ranging from 16 to 96 hours.

According to another particular embodiment, the present invention relates to a method of preparation as defined above, further comprising, after the heating step, or after the washing step, a drying step, in particular in an oven at a temperature of 80° C., for 24 hours, to obtain a dried formo-phenolic resin.

According to another particular embodiment, the present invention relates to a method of preparation as defined above, further comprising, after the heating step, after the washing step, or after the drying step, a grinding step, to obtain a ground formo-phenolic resin.

According to another particular embodiment, the present invention relates to a preparation method as defined above, further comprising, after the heating step, at least one washing step, said washing step being carried out in particular with:
an aqueous solution of a strong base, in particular sodium hydroxide, then water, to obtain a formo-phenolic resin wherein the —OH groups are salified, in particular in the —ONa form, or
an aqueous solution of a strong base, in particular sodium hydroxide, then an aqueous solution of hydrochloric acid, then water, to obtain a formo-phenolic resin comprising —OH groups,
   and/or further comprising, after the heating step, or after the washing step, a drying step, in particular in an oven at a temperature of 80° C., for 24 hours, to obtain a dried formo-phenolic resin, and/or further comprising, after the heating step, after the washing step, or after the drying step, a grinding step, to obtain a ground formo-phenolic resin.

A third object of the present invention relates to a crosslinked formo-phenolic resin as obtained by the preparation method as defined above.

A fourth object of the present invention relates to a new crosslinked formo-phenolic resin, consisting of a polymer containing monomer units linked together by one or more —R¹¹— group(s),
wherein R″ represents a —(CH₂)— group, a linear or branched —(CH)— C₁ to C₁₀ alkyl group, a —(CH)-aryl group, a —(CH)-heteroaryl group, a linear or branched —(CH)—(C₁ to C₁₀-alkyl)aryl, a linear or branched —(CH)—(C₁ to C₁₀-alkyl)heteroaryl, a —(CH)-aryl-(CH)— group, a linear or branched —(CH)—(C₁ to C₁₀-alkyl)-aryl-(C₁ to C₁₀-alkyl)-(CH)—, —(CH)-heteroaryl-(CH)—, a linear or branched (CH)—(C₁ to C₁₀-alkyl)-heteroaryl-(C₁ to C₁₀-alkyl)-(CH)-group, said monomer units being:
   either chelating monomer units of Formula 1-B:

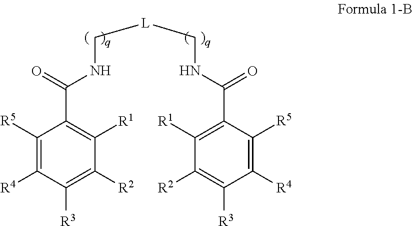

wherein:
at least one of the substituents represents an —OH group or a salt form, and
at least one of the R¹ to R⁵ substituents represents a hydrogen atom,
and wherein:
   q is 0, 1,2 or 3,
   R¹, R², R³, R⁴ and R⁵ independently represent: a hydrogen atom, or a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O) NRR′ group wherein R and R′ represent independently of each other a hydrogen atom or a C₁ to C₁₀ alkyl group,
   -L is a linker chosen from one of the following structures:

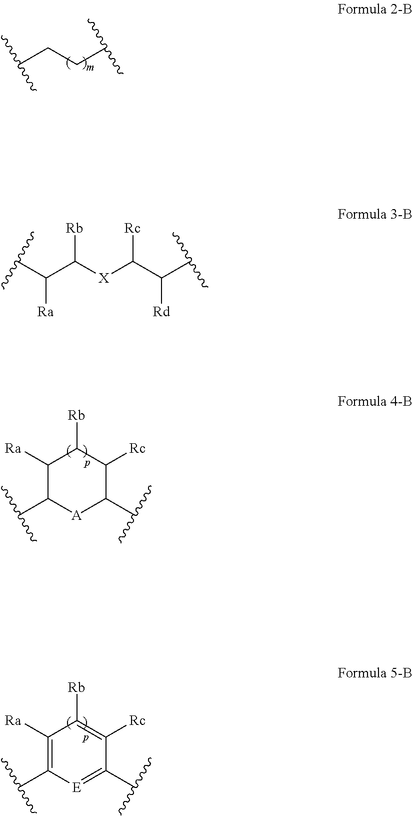

wherein:
   m is 0, 1, 2, 3, 4 or 5,
   p is 0 or 1,
   A represents a —CH₂ group, a —CH—OH group, an oxygen atom, an —NH— group, a N-oxide group or a sulfur atom,
   E represents a CH group, a C—OH group, an oxygen atom, a nitrogen atom, a N-oxide group or a sulfur atom,
   Rₐ, R_{b}, R_{c}, and R_{d} represent independently
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O) NRR′ group wherein R and R′ represent independently of each other a hydrogen atom or a C₁ to C₁₀ alkyl group,
   or chelating monomer units of Formula 6-B:

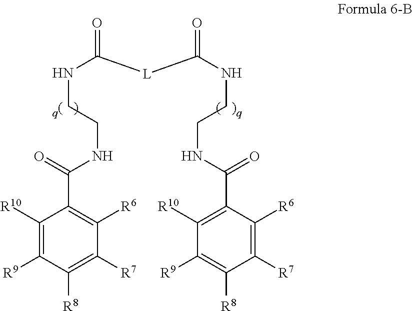

wherein:
at least one of the R⁶ to R¹⁰ substituents represents an —OH group or a salified form, and
at least one of the R⁶ to R¹⁰ substituents represents a hydrogen atom,
and wherein:
   q and L are as defined above top for Formula 1-B,
   R⁶, R⁷, R¹, R⁹ and R¹⁰ independently represent:
   a hydrogen atom, or
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O) NRR′ group wherein R and R′ independently represent a hydrogen atom or a C₁ to C₁₀ alkyl group,
and optionally monomer units of Formula 7-B:

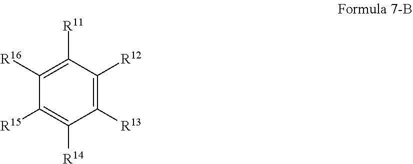

wherein:
at least one of the R¹¹ to R¹⁶ substituents represents an —OH group or a salt form, and
at least two of the R¹¹ to R¹⁶ substituents represents a hydrogen atom, wherein:
   R¹¹, R¹², R¹³, R¹⁴, R¹⁵ and R¹⁶ independently represent:
   a hydrogen atom, or
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N, S and N═O,
      aryl, or polyaryl of 1 to 4 aromatic rings, if R¹⁵ represents an aryl or polyaryl group, said aryl or polyaryl group can be fused with the monomer unit of Formula 7-B at the R¹⁶ position, said monomer unit of Formula 7-B being in particular a naphthol,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
      —P(O)(OR)(OR′) wherein R and R′ independently represent a hydrogen atom, a C₁ to C₁₀ alkyl group, or a —C(O) NRR′ group wherein R and R′ independently of each other represent a hydrogen atom or a C₁-C₁₀ alkyl group,
and wherein from 2 to 8 monomer units of Formula 7-B can be linked together by a linear or branched C₁ to C₁₀ alkyl group, said monomer unit of Formula 7-B being in particular a calixarene comprising from 2 to 8 monomer units of Formula 7-B,
or wherein from 2 to 4 monomer units of Formula 7-B may be linked to each other by a linear or branched C₁ to C₁₀ heteroalkyl group, the heteroatom being in particular 0, the said monomer unit of Formula 7-B being in particular a crown ether comprising from 2 to 4 monomer units of Formula 7-B,
or one of at least two of any of the monomer units of Formula 1-B, 6-B and 7-B,
wherein the structure of Formula 7-B does not correspond to the structure of Form 1-B or 6-B, said group —R¹¹— being located:
   either between two chelating monomer units of Formula 1-B, on at least one carbon atom of the monomer unit carrying a R¹ to R⁵ substituent which represents a hydrogen atom,
   or between two chelating monomer units of Formula 6-B, on at least one carbon atom of the monomer unit carrying a R⁶ to R¹⁰ substituent which represents a hydrogen atom,
   or between a chelating monomer unit of Formula 1-B, on at least one carbon atom of the monomer unit carrying a R¹ to R⁵ substituent which represents a hydrogen atom, and at least one carbon atom of the monomer unit of Formula 6-B carrying a R⁶ to R¹⁰ substituent which represents a hydrogen atom,
   or between a chelating monomer unit of Formula 1-B, on at least one carbon atom of the monomer unit carrying a R¹ to R⁵ substituent which represents a hydrogen atom, and at least one carbon atom of the monomer unit of Formula 7-B carrying a R¹¹ to R¹⁶ substituent which represents a hydrogen atom,
   or between a chelating monomer unit of Formula 6-B, on at least one carbon atom of the monomer unit carrying a R⁶ to R¹⁰ substituent which represents a hydrogen atom, and at least one carbon atom of the monomer unit of Formula 7-B carrying a R¹¹ to R¹⁶ substituent which represents a hydrogen atom.

According to another particular embodiment, the present invention relates to a new formo-phenolic resin as defined above, wherein said resin consists of a polymer containing said monomer units bonded together by one or more —(CH₂)-group(s).

According to another particular embodiment, the present invention relates to a novel formo-phenolic resin as defined above, wherein the chelating monomer units are of Formula 1-B, wherein:
at least one of the R¹ to R⁵ substituents represents an —OH group or a salt form, and
at least one of the R¹ to R⁵ substituents represents a hydrogen atom,
and wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O and N,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
   -L is a linker chosen from one of the following structures:

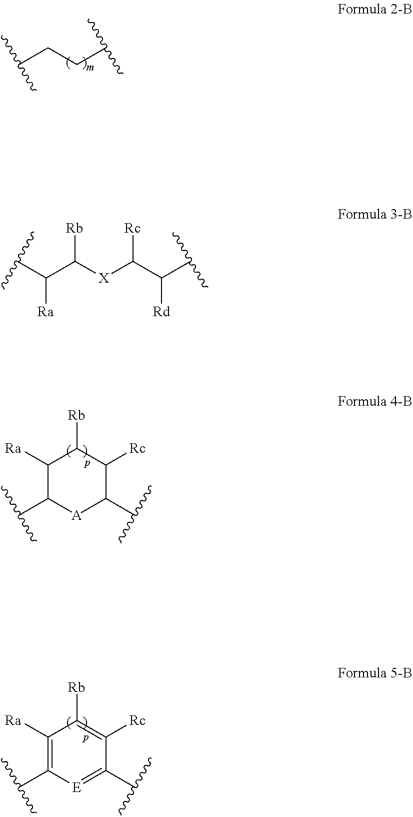

wherein:
   m is 0, 1, 2, 3, 4 or 5,
   p is 0 or 1,
   A represents a —CH₂ group, a —CH—OH group, an oxygen atom, an —NH— group, a N-oxide group or a sulfur atom,
   E represents a CH group, a C—OH group, an oxygen atom, a nitrogen atom, a N-oxide group or a sulfur atom,
   Rₐ, R_{b}, R_{c}, and R_{d} represent independently
   a group chosen from:
      —OH, or a salified form, in particular chosen from —ONa, —OK, —OLi, and —OCs,
      —NH₂,
      —SH,
      linear or branched C₁ to C₁₀ alkyl,
      linear or branched C₁ to C₁₀ heteroalkyl, the heteroatom being chosen in particular from O, N and S,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl, said chelating monomer units of Formula 1-B may be mixed with at least one of the monomer units of Formulas 6-B and 7-B as defined above.

According to another particular embodiment, the present invention relates to a novel formo-phenolic resin as defined above, wherein the chelating monomer units are of Formula 1-B, wherein:
at least one of the R¹ to R⁵ substituents represents a group —OH or a salified form, and
at least one of the R¹ to R⁵ substituents represents a hydrogen atom,
and
wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
   L is a linker chosen from one of the following structures:

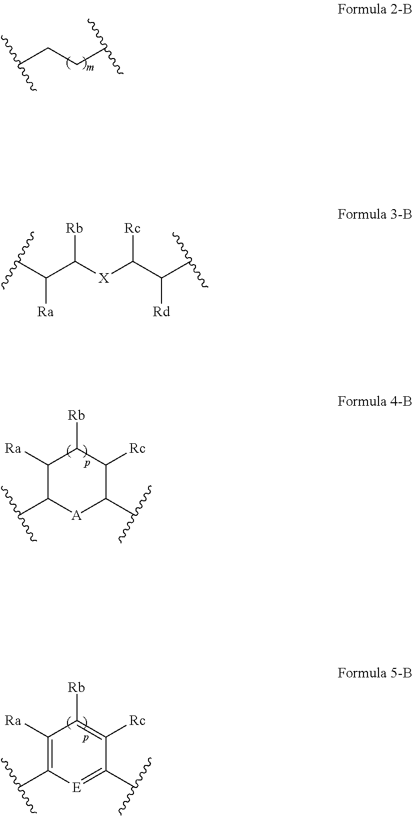

wherein:
   m is 0, 1, 2, 3, 4 or 5,
   p is 0 or 1,
   A represents a —CH₂ group,
   E represents a CH group, or a C—OH group,
   Rₐ, R_{b}, R_{c}, and R_{d} represent independently
   a group chosen from:
      —OH, or a salified form, in particular chosen from —ONa, —OK, —OLi, and —OCs,
      linear or branched C₁ to C₁₀ alkyl, said chelating monomer units of Formula 1-B may be mixed with at least one of the monomer units of Formulas 6-B and 7-B as defined above.

According to another particular embodiment, the present invention relates to a novel formo-phenolic resin as defined above, wherein the chelating monomer units are of Formula 6-B, wherein:
at least one of the R⁶ to R¹⁰ substituents represents a group —OH or a salified form, and
at least one of the R⁶ to R¹⁰ substituents represents a hydrogen atom,
and wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O and N,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
      —C(O)OR wherein R represents a hydrogen atom or a C₁ to C₁₀ alkyl group,
   L is a linker chosen from one of the following structures:

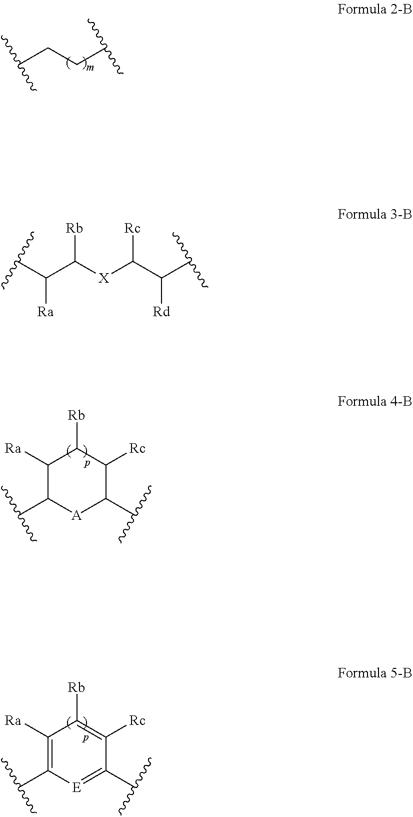

wherein
   m is 0, 1, 2, 3, 4 or 5,
   p is 0 or 1,
   A represents a —CH₂ group, a —CH—OH group, an oxygen atom, an —NH— group, a N-oxide group or a sulfur atom,
   E represents a CH group, a C—OH group, an oxygen atom, a nitrogen atom, a N-oxide group or a sulfur atom,
   Rₐ, R_{b}, R_{c}, and R_{d} represent independently a group chosen from:
      —OH, or a salified form, in particular chosen from —ONa, —OK, —OLi, et-OCs,
      —NH₂,
      —SH,
      linear or branched C₁ to C₁₀ alkyl,
      linear or branched C₁ to C₁₀ heteroalkyl, the heteroatom being chosen in particular from O, N and S,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
said chelating monomer units of Formula 6-B may be mixed with at least one of the monomer units of Formulas 1-B and 7-B as defined above.

According to another particular embodiment, wherein the chelating monomer units are of Formula 6-B,
wherein:
at least one of the R⁶ to R¹⁰ substituents represents an —OH group or a salified form, and
at least one of the R⁶ to R¹⁰ substituents represents an atom of hydrogen,
and wherein:
   q is 0, 1, 2 or 3,
   R¹, R², R³, R⁴ and R⁵ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
   L is a linker chosen from one of the following structures:

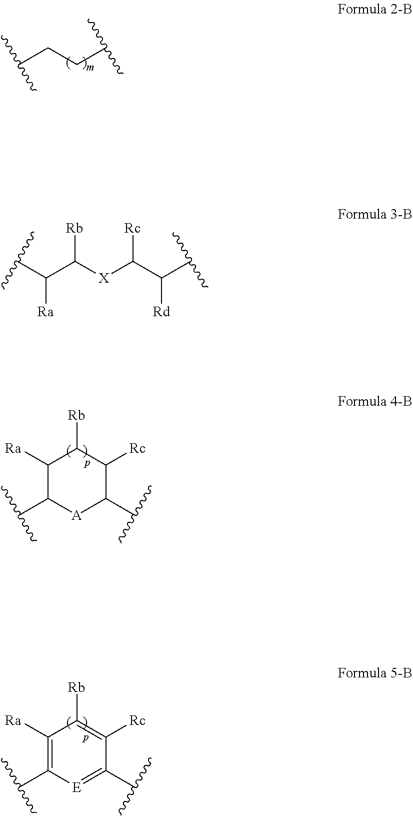

wherein:
   m is 0, 1, 2, 3, 4 or 5,
   p is 0 or 1,
   A represents a —CH₂ group,
   E represents a CH group, or a C—OH group,
   Rₐ, R_{b}, R_{c}, and R_{d} represent independently
   a group chosen from:
      —OH, or a salified form, in particular chosen from —ONa, —OK, —OLi, and —OCs,
      linear or branched C₁ to C₁₀ alkyl, said chelating monomer units of Formula 6-B may be mixed with at least one of the monomer units of Formulas 1-B and 7-B as defined above.

According to another particular embodiment, wherein the monomer units are of Formula 7-B, wherein:
at least one of the R¹¹ to R¹⁶ substituents represents an —OH group or a salified form, and
at least two of the R¹¹ to R¹⁶ substituents represent an atom of hydrogen,
and wherein:
   —R¹¹, R¹², R¹³, R¹⁴, R¹⁵ and R¹⁶ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being chosen in particular from O, N and S,
      aryl,
      heteroaryl,
      linear or branched C₁ to C₁₀ alkylaryl,
      linear or branched C₁ to C₁₀ heteroalkylaryl, the heteroatom being chosen in particular from O, N and S,
      halogen, in particular F or Cl,
      branched or unbranched C₃ to C₁₀ cycloalkyl,
said monomer units of Formula 7-B are mixed with at least one of the monomer units of Formula 1-B and 6-B as defined above.

According to another particular embodiment, wherein the monomer units are of Formula 7-B, wherein:
at least one of the R¹¹ to R¹⁶ substituents represents an —OH group or a salified form, and
at least two of the R¹¹ to R¹⁶ substituents represent an atom of hydrogen,
and wherein:
   —R¹¹, R¹², R¹³, R¹⁴, R¹⁵ and R¹⁶ independently represent:
   a hydrogen atom, or
   a group chosen from:
      —OH, or a salified form, in particular chosen from —ONa, —OK, —OLi, and —OCs,
      linear or branched C₁ to C₁₀ alkyl,
      linear or branched C₁ to C₁₀ heteroalkyl, the heteroatom being 0,
      aryl,
      linear or branched C₁ to C₁₀ alkylaryl,
      halogen, in particular F or Cl,
      linear or branched C₁ to C₁₀ alkylaryl,
      halogen, in particular F or Cl, said monomer units of Formula 7-B are mixed with at least one of the monomer units of Formula 1-B and 6-B as defined above.

According to another particular embodiment, the present invention relates to a novel formo-phenolic resin as defined above, wherein the chelating monomer units of Formula 1-B have the structure of Formula 8-B

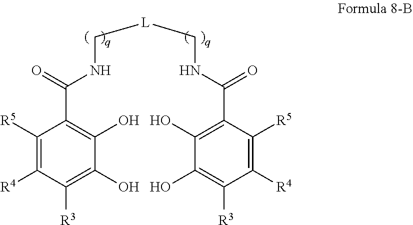

L, q, R³, R⁴ and R⁵ being as defined above,
in particular the structure of Formula 9-B,

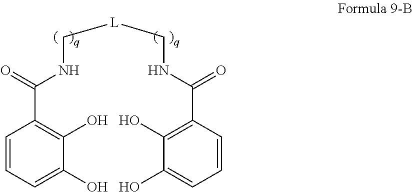

L and q being as defined above.

According to another particular embodiment, the present invention relates to a novel formo-phenolic resin as defined above, wherein the chelating monomer units of Formula 1-B have the structure chosen from the structures of Formulas 10-B, of Formula 11-B, and of Formula 12-B:

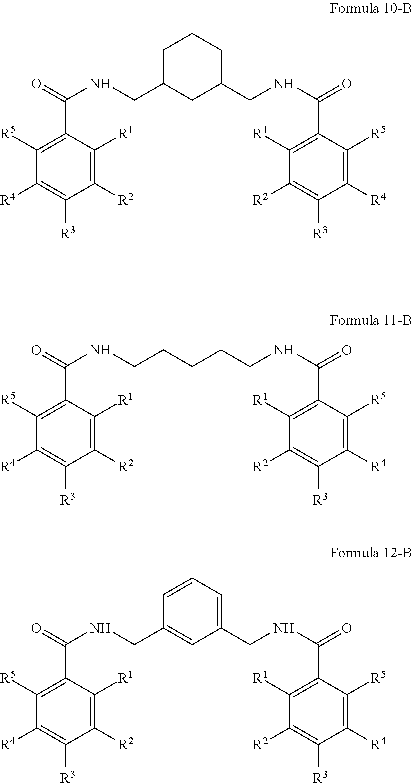

R¹, R², R³, R⁴ and R⁵ being as defined above, in particular chosen from the structures of Formulas 13-B, of Formula 14-B, and of Formula 15-B:

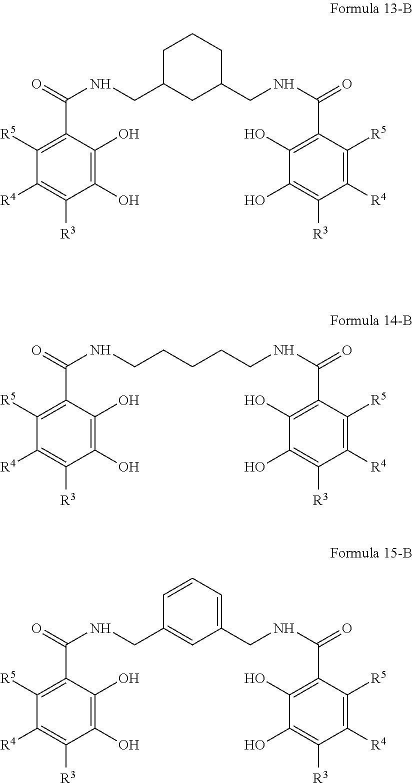

R³, R⁴ and R⁵ being as defined above, in particular chosen from the structures of Formulas 16-B, of Formula 17-B, and of Formula 18-B:

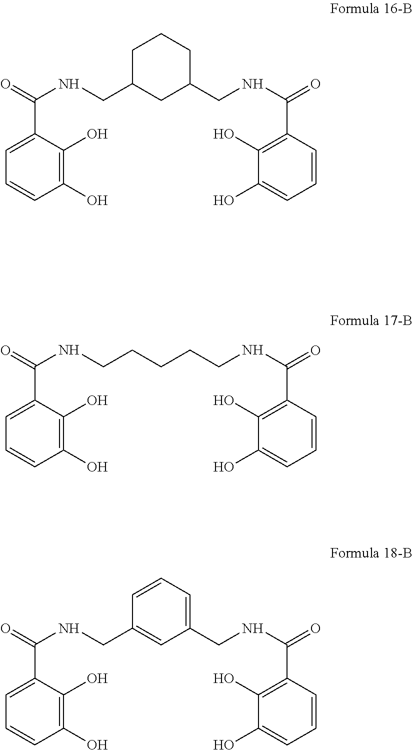 [SMILES: O=C(NCC1CCCC(CNC(=O)c2cccc(O)c2O)C1)c1cccc(O)c1O ; O=C(NCCCCCNC(=O)c1cccc(O)c1O)c1cccc(O)c1O ; O=C(NCc1cccc(CNC(=O)c2cccc(O)c2O)c1)c1cccc(O)c1O]

According to another particular embodiment, wherein the chelating monomer units of Formula 6-B have the structure of Formula 19-B:

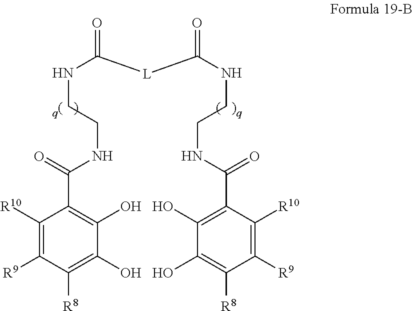

L, q, R⁸, R⁹ and R¹⁰ being as defined above.

According to another particular embodiment, the present invention relates to a novel formo-phenolic resin as defined above, wherein the chelating monomer units of Formula 6-B have the structure of Formula 20-B:

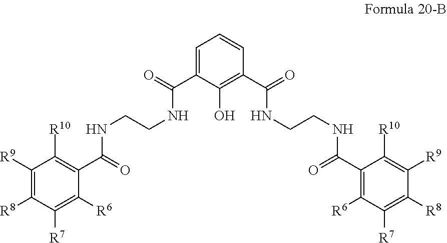

R⁶, R⁷, R⁸, R⁹ and R¹⁰ being as defined above, in particular the structure of Formula 21-B:

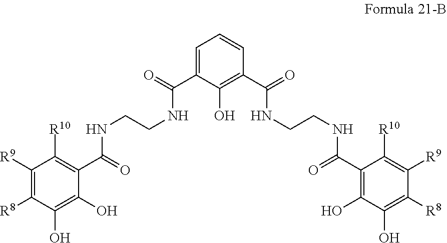

R⁸, R⁹ and R¹⁰ being as defined above, in particular the structure of Formula 22-B:

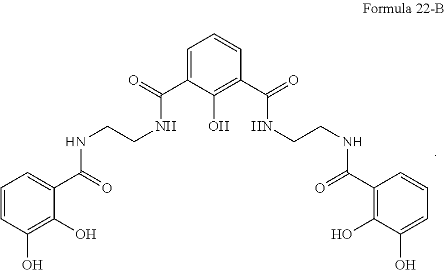 [SMILES: O=C(NCCNC(=O)c1cccc(C(=O)NCCNC(=O)c2cccc(O)c2O)c1O)c1cccc(O)c1O]

According to another particular embodiment, the present invention relates to a novel formo-phenolic resin as defined above, wherein the monomer units of Formula 7-B have the structure of Formula 23-B, 24-B, 25-B or 26-B:

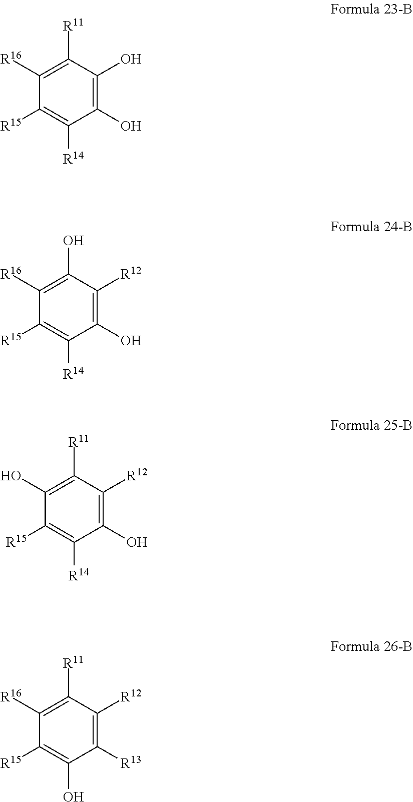

R¹¹, R¹², R¹⁴, R¹⁵ and R¹⁶ being as defined above, in particular the structure of Formula 27-B, 28-B, or 29-B:

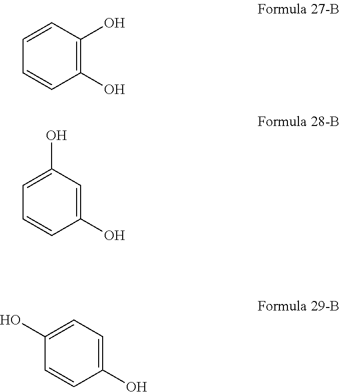

According to another particular embodiment, the present invention relates to a new formo-phenolic resin as defined above, wherein the chelating monomer units of Formula 1-B have the structure of Formula 8-B, 9-B, 10-B, 11-B, 12-B 13-B, 14-B or 15-B:

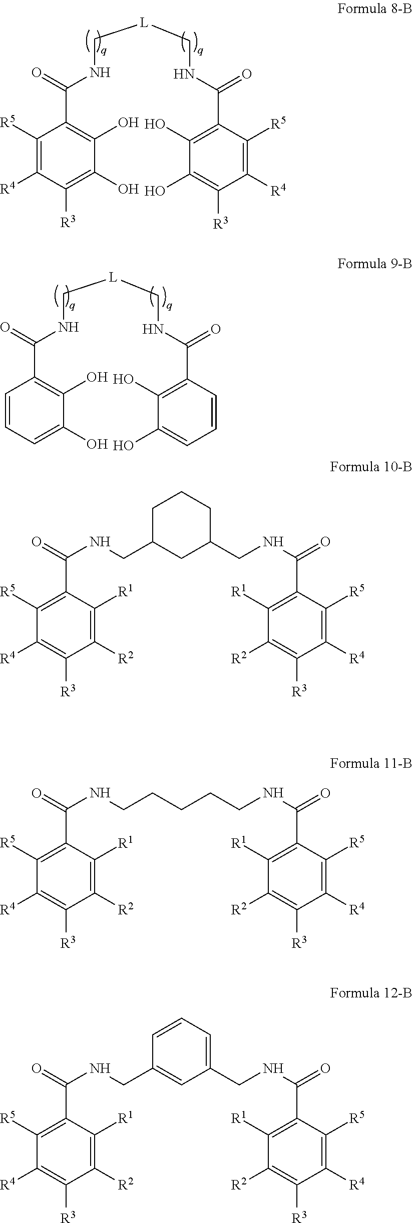

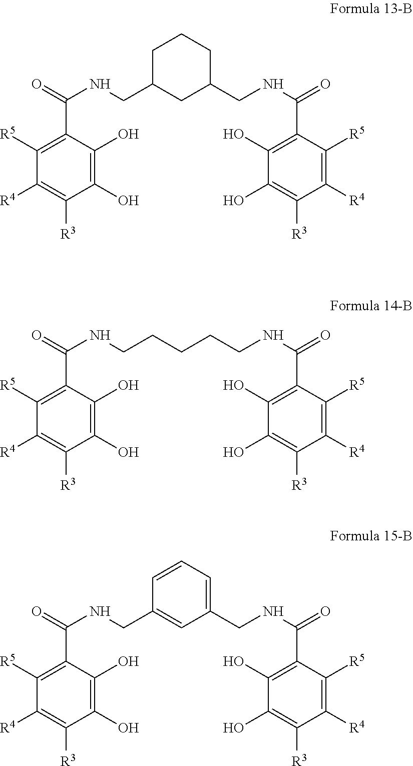

R¹, R², R³, R⁴, R⁵, L and q being as defined above, in particular the structure of Formula 16-B, 17-B or 18-B:

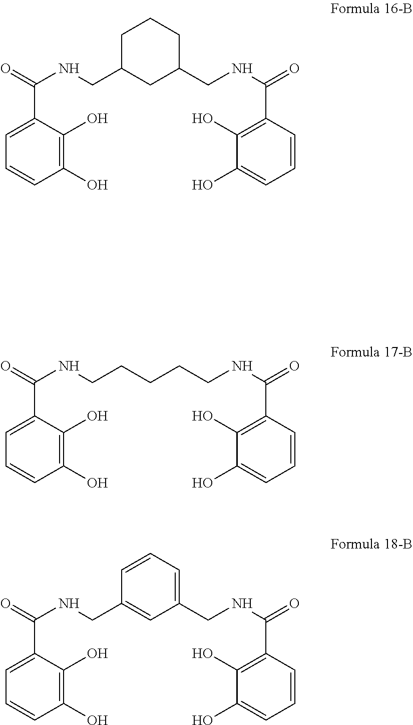 [SMILES: O=C(NCC1CCCC(CNC(=O)c2cccc(O)c2O)C1)c1cccc(O)c1O ; O=C(NCCCCCNC(=O)c1cccc(O)c1O)c1cccc(O)c1O ; O=C(NCc1cccc(CNC(=O)c2cccc(O)c2O)c1)c1cccc(O)c1O]

Formulas 8-B, 9-B, 13-B, 14-B, 15-B, 16-B, 17-B and 18-B wherein the —OH groups are in particular in a salified form, in particular in the form —ONa, and/or wherein the chelating monomer units of Formula 6 have the structure of Formula 19-B:

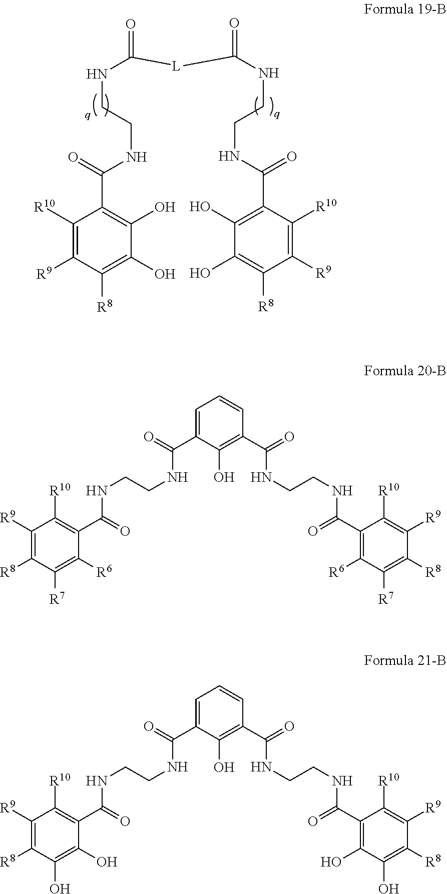

L, q, R⁶, R⁷, R⁸, R⁹ and R¹⁰ being as defined above, in particular the structure of Formula 22-B:

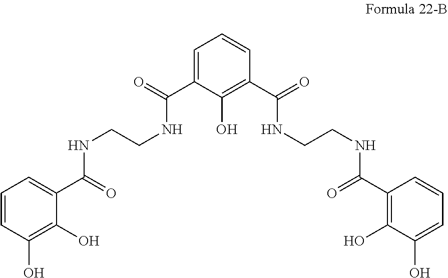 [SMILES: O=C(NCCNC(=O)c1cccc(C(=O)NCCNC(=O)c2cccc(O)c2O)c1O)c1cccc(O)c1O]

Formulas 19-B, 21-B and 22-B wherein the —OH groups are in particular in a salified form, in particular in the —ONa form, and/or wherein the monomer units of Formula 7 have the structure of Formula 23-B, 24-B, 25-B or 26-B:

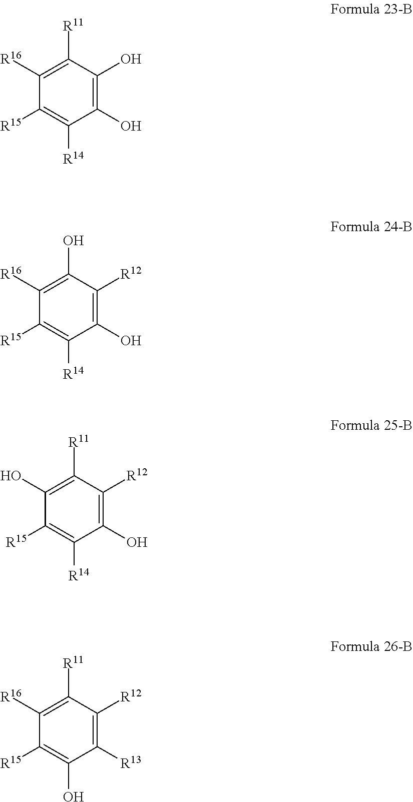

R¹¹, R¹, R¹, R¹⁵ and R¹⁶ being as defined above,
in particular the structure of Formula 27-B, 28-B, or 29-B:

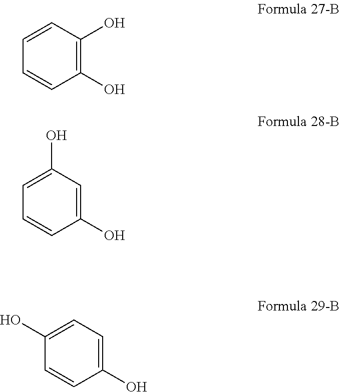

Formulas 23-B, 24-B, 25-B, 26-B, 27-B, 28-B and 29-B n which the —OH groups are in particular in a salified form, in particular in the —ONa form.

According to another particular embodiment, the present invention relates to a novel formo-phenolic resin as defined above, wherein the monomer units of Formula 7-B have the structure of Formula 30-B, or of Formula 31-B, in particular of structure of Formula 32-B, or of Formula 33-B:

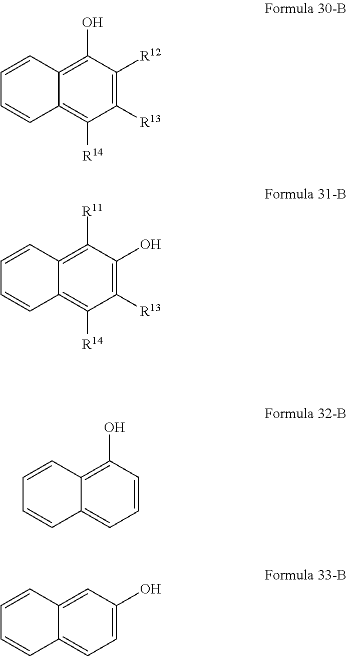

R¹¹, R¹², R¹³ and R¹⁴ being as defined above, or the structure of Formula 34-B, in particular the structure of Formula 35-B, in particular the structure of Formula 36-B:

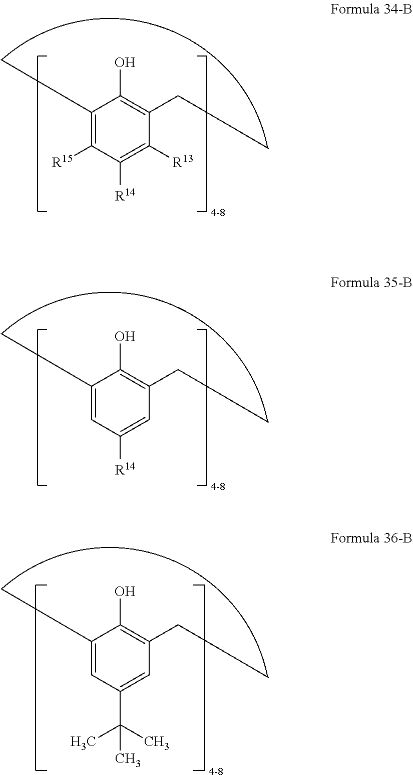

R¹³, R¹⁴ and R¹⁵ being as defined above, or the structure of Formula 37-B, in particular the structure of Formula 38-B:

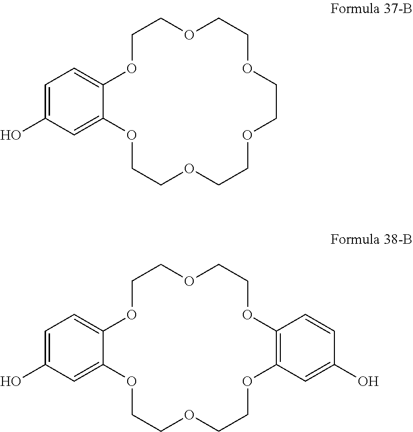 [SMILES: Oc1ccc2c(c1)OCCOCCOCCOCCOCCO2 ; Oc1ccc2c(c1)OCCOCCOc1cc(O)ccc1OCCOCCO2]

According to another particular embodiment, the present invention relates to a novel formo-phenolic resin as defined above, wherein the polymer consists of 100% chelating monomer units of Formula 1-B.

According to another particular embodiment, the present invention relates to a new formo-phenolic resin as defined above, wherein the polymer consists of 100% of chelating monomer units of Formula 6-B.

According to another particular embodiment, the present invention relates to a novel formo-phenolic resin as defined above, wherein the polymer consists of a mixture of chelating monomer units of Formula 1-B and monomer units Formula 6-B chelators.

According to another particular embodiment, the present invention relates to a novel formo-phenolic resin as defined above, wherein the polymer consists of a mixture of chelating monomer units of Formula 1-B and monomer units of Formula 7-B.

According to another particular embodiment, the present invention relates to a new formo-phenolic resin as defined above, wherein the polymer consists of a mixture of chelating monomer units of Formula 6-B and monomer units of Formula 7-B.

According to another particular embodiment, the present invention relates to a novel formo-phenolic resin as defined above, wherein the polymer consists of a mixture of chelating monomer units of Formula 1-B, monomer units chelators of Formula 6-B, and monomer units of Formula 7-B.

According to another particular embodiment, the present invention relates to a novel formo-phenolic resin as defined above, wherein the polymer consists of:
100% chelating monomer units of Formula 1-B, or
100% chelating monomer units of Formula 6-B, or
a mixture of chelating monomer units of Formula 1-B and chelating monomer units of Formula 6-B, or
a mixture of chelating monomer units of Formula 1-B and monomer units of Formula 7-B, or
a mixture of chelating monomer units of Formula 6-B and monomer units of Formula 7-B, or
a mixture of chelating monomer units of Formula 1-B, chelating monomer units of Formula 6-B, and monomer units of Formula 7-B.

According to another particular embodiment, the present invention relates to a novel formo-phenolic resin as defined above, wherein the polymer comprises a structural unit of Formula 39, or of Formula 40 as defined above.

According to another particular embodiment, the present invention relates to a novel formo-phenolic resin as defined above, wherein the polymer comprises a structural unit of Formula 41, or of Formula 42 as defined above.

According to another particular embodiment, the present invention relates to a novel formo-phenolic resin as defined above, wherein the polymer comprises a structural unit of Formula 43, or of Formula 44 as defined above.

According to another particular embodiment, the present invention relates to a novel formo-phenolic resin as defined above, wherein the resin has a capacity for adsorption of uranium Q_{ads} greater than 5 mg/g, in particular greater than 10, 50, 10, 150, or 200 mg/g.

The adsorption capacity, noted Q_{ads}, expressed in mg of metal extracted per gram of resin, represents the quantity of this cation present in the resin, and which is determined by the following Formula 1:

$${Q}_{ads} = ( {C}_{i} - {C}_{f} ) \cdot \frac{V}{m} \qquad Formula 1$$

wherein:
Cᵢ=initial concentration of the cation in solution (mg/L),
C_{f}=concentration of the cation in solution after extraction (mg/L),
V=volume of solution (mL),
m=mass of resin (mg).

According to another particular embodiment, the present invention relates to a formaldehyde resin as defined above, wherein the percentage of extraction of uranium E is greater than 10, in particular greater than 15, 20, 25, 30, 40, or 50.

The percentage of extraction, noted E and expressed in %, which represents the percentage of cation extracted by the resin compared to the initial quantity of cation, and which is determined by the following Formula 2:

$$E = \frac{{C}_{i} - {C}_{f}}{{C}_{i}} \cdot 100 \qquad Formula 2$$

wherein:
Cᵢ=initial concentration of the cation in solution (mg/L),
C_{f}=concentration of the cation in solution after extraction (mg/L),

According to another particular embodiment, the present invention relates to a formo-phenolic resin as defined above, wherein the distribution coefficient Ka is greater than 100 mL/g, in particular greater than 500 or 1000 mL/g.

The distribution coefficient, noted K_{D} and expressed in mL/g, which represents the ratio between the quantity of this cation present in the resin and the quantity of this cation remaining in solution after extraction, and which is determined by the following Formula 3:

$${K}_{D} = \frac{{C}_{i} - {C}_{f}}{{C}_{f}} \cdot \frac{V}{m} \cdot 1000 \qquad Formula 3$$

wherein:
Cᵢ=initial concentration of the cation in solution (mg/L),
C_{f}=concentration of the cation in solution after extraction (mg/L),
V=volume of solution (mL),
m=mass of resin (mg).

According to another particular embodiment, the present invention relates to a formo-phenolic resin as defined above, wherein the FS_{U/M} separation factor is greater than 2, in particular greater than 5, 10, 50 or 100, in where U is uranium and M is the competing metal.

The separation factor, denoted FS_{U/M}, represents the ratio between the K_{D} of uranium and the K_{D} of another metal, which makes it possible to quantify the selectivity of a resin to extract uranium with respect to another metal.

The separation factor is determined by the following Formula 4:

$${FS}_{U / M} = \frac{{K}_{{D}_{U}}}{{K}_{{D}_{M}}} \qquad Formula 4$$

wherein:
M represents a competing metal,
K_{Du} represents the uranium distribution coefficient,
K_{DM} represents the competitor metal distribution coefficient.

Among the competing metals M are other metals that may be present in an aqueous sample, in particular a sample of seawater.

Strontium, calcium, magnesium, sodium and kalium are examples of competing metals.

Said competing metals being present in a cationic form.

A fifth object of the present invention is a method for extracting uranium comprising: a step of bringing a formo-phenolic resin as defined above into contact with an aqueous solution comprising uranium, said solution aqueous being in particular sea water.

According to another particular embodiment, the present invention relates to a method for extracting uranium as defined above, further comprising, after the contacting step, a step for recovering the uranium, said recovery step being carried out in particular by eluting the resin with an alkaline aqueous solution.

According to another particular embodiment, the present invention relates to a method for extracting uranium as defined above, a step for regenerating the resin, in particular by washing the resin with:
an aqueous solution of soda, then water, or
an aqueous solution of soda, then an aqueous solution of hydrochloric acid, then water, to obtain a regenerated resin.

According to another particular embodiment, the present invention relates to a method for extracting uranium as defined above, wherein the uranium is in an ionic form, in particular in the form of UO₂²⁺.

The present invention also relates to a method for extracting uranium, in particular in an ionic form, in particular in the form of UO₂²⁺, comprising: a step of bringing a formo-phenolic resin as defined above, with an aqueous solution comprising uranium, said aqueous solution being in particular sea water or river water.

According to another particular embodiment, the present invention relates to a method for extracting uranium as defined above, further comprising, after the contacting step, a step for recovering the uranium, said recovery step being carried out in particular by eluting the formo-phenolic resin with an alkaline aqueous solution, and optionally a step of regenerating the formo-phenolic resin, in particular by washing the formo-phenolic resin with:
an aqueous solution of soda, then water, or
an aqueous solution of soda, then an aqueous solution of hydrochloric acid, then water, to obtain a regenerated formo-phenolic resin.

According to another particular embodiment, the present invention relates to a method for extracting uranium as defined above, wherein the resin has a capacity for adsorption of uranium Q_{ads} greater than 5 mg/g, in particular greater than at 10, 50, 10, 150, or 200 mg/g.

According to another particular embodiment, the present invention relates to a method for extracting uranium as defined above, wherein the percentage of extraction of uranium E is greater than 10, in particular greater than 15, 20, 25, 30, 40, or 50.

According to another particular embodiment, the present invention relates to a method for extracting uranium as defined above, wherein the distribution coefficient Ka is greater than 100 mL/g, in particular greater than 500 or 1000 mL/g.

According to another particular embodiment, the present invention relates to a method for extracting uranium as defined above, wherein the separation factor FS_{U/M} is greater than 2, in particular greater than 5, 10, 50 or 100, where U is uranium and M is the competing metal.

According to another particular embodiment, the present invention relates to a method for extracting uranium as defined above, wherein:
the formo-phenolic resin has a Q_{ads} uranium adsorption capacity greater than 5 mg/g, and/or
the percentage of uranium E extraction is greater than 10, and/or
the distribution coefficient Ka is greater than 100 mL/g, and/or
the FS_{U/M} separation factor is greater than 2, where LT is uranium and M is the competing metal.

The inventors have found, quite surprisingly, that the extraction method according to the present invention allows selective extraction of uranium, with a remarkable extraction percentage.

The resins have an unprecedented adsorption capacity.

The following examples illustrate the invention, without limiting its scope.

### Example 1: Synthesis of Chelating Monomer Units of Formula 1

The chelating monomers of Formula 1 were obtained according to General Scheme 1:

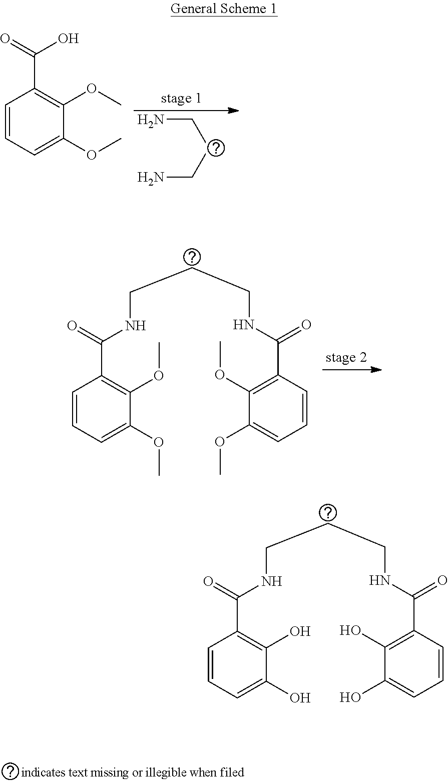

### Example 1A: Synthesis of Methylated Bis-Catecholamides—Stage 1

To a solution of 2,3-dimethoxybenzoic acid (2.2 eq.) in anhydrous dichloromethane (0.8 M) was added dropwise oxalyl chloride (3 eq.) at room temperature.

A few drops of anhydrous 7V,7V-dimethylformamide were added and the medium was stirred for 2 h, until the end of the evolution of HCl. After evaporation of the solvents and residual oxalyl chloride, the residue was redissolved in anhydrous dichloromethane (0.8 M) and added dropwise to a solution of diamine (1 eq) and triethylamine (2.5 eq.) in anhydrous dichloromethane (0.8 M).

After 17 hours of stirring, the medium was washed twice with an aqueous solution of 1 M HCl, a saturated aqueous solution of NaCl, then dried over MgSO₄ and evaporated under reduced pressure.

The residue obtained is purified by flash chromatography on silica gel using a cyclohexane/ethyl acetate gradient ranging from a ratio of 8/2 v/v to a ratio of 2/8 v/v in order to obtain a methylated bis-catecholamide in the form of a thick colorless oil with a yield of between 86% and 100%.

The following compounds were obtained:

### N,N′-(cyclohexane-1,3-diylbis(methylene))bis(2,3-dimethoxybenzamide)

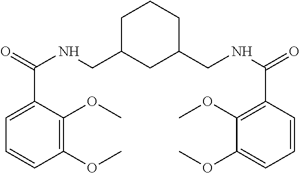 [SMILES: COc1cccc(C(=O)NCC2CCCC(CNC(=O)c3cccc(OC)c3OC)C2)c1OC]

RMN ¹H (CD₂Cl₂, 400 MHz, 25° C.) δ (ppm): 8.02 (te, 1.5H), 7.96 (te, 0.5H), 7.60 (dd, J=7.9, 1.6 Hz, 1.5H), 7.57 (dd, J=8.0, 1.7 Hz, 0.5H), 7.12 (q, J=8.0 Hz, 2H), 7.04 (dd, J=8.1, 1.6 Hz, 2H), 3.87 (s, 6H), 3.86 (s, 6H), 3.39 (t, J=6.6 Hz, 1H), 3.30 (t, J=6.2 Hz, 3H), 1.90 (d, J=12.7 Hz, 1H), 1.83 (d, J=11.4 Hz, 2H), 1.70-1.53 (m, 3H), 1.41-1.25 (m, 2H), 1.03-0.84 (m, 2H);

RMN ¹³C (CD₂Cl₂, 100 MHz, 25° C.) δ (ppm): 165.11, 153.13, 147.87, 127.38, 124.52, 122.81, 115.52, 61.54, 56.35, 46.23, 43.97, 38.29, 35.67, 33.55, 33.15, 31.20, 29.82, 25.83, 21.07.

### N,N′-(pentane-1,5-diyl)bis(2,3-dimethoxybenzamide)

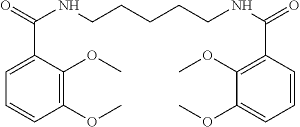 [SMILES: COc1cccc(C(=O)NCCCCCNC(=O)c2cccc(OC)c2OC)c1OC]

RMN ¹H (CD₂Cl₂, 400 MHz, 25° C.) δ (ppm): 7.96 (se, 2H), 7.59 (d, J=7.9 Hz, 2H), 7.13 (t, J=7.9 Hz, 2H), 7.05 (d, J=7.9 Hz, 2H), 3.87 (s, 6H), 3.86 (s, 6H), 3.44 (q, J=6.4 Hz, 4H), 1.67 (quint, J=7.3 Hz, 4H), 1.54-1.45 (m, 2H);

RMN ¹³C (CD₂C₂, 100 MHz, 25° C.) δ (ppm): 165.12, 153.15, 147.90, 127.41, 124.54, 122.75, 115.51, 61.48, 56.36, 39.82, 29.76, 24.94.

### N,N′-(1,3-phenylene bis(methylene))bis(2,3-dimethoxybenzamide)

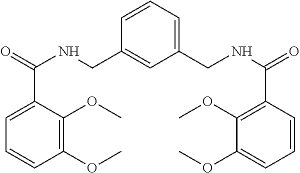 [SMILES: COc1cccc(C(=O)NCc2cccc(CNC(=O)c3cccc(OC)c3OC)c2)c1OC]

RMN ¹H (CD₂Cl₂, 400 MHz, 25° C.) δ (ppm): 8.33 (se, 2H), 7.64 (d, J=7.9 Hz, 2H), 7.35-7.27 (m, 4H), 7.14 (t, J=7.9 Hz, 2H), 7.07 (d, J=8.0 Hz, 2H), 4.63 (d, J=5.7 Hz, 4H), 3.87 (s, 6H), 3.81 (s, 6H);

RMN ¹³C (CD₂Cl₂, 100 MHz, 25° C.) δ (ppm): 165.26, 153.19, 148.08, 139.89, 129.24, 127.06, 126.88, 126.70, 124.59, 122.91, 115.82, 61.58, 56.40, 43.86.

### Example 1B: Synthesis of Bis-Catecholamides—Stage 2

To a solution of methylated bis-catecholamide synthesized in example IA (1 eq.) in anhydrous dichloromethane (0.08 M) was added dropwise BBr₃ (7 eq.) with vigorous stirring at 0° C. The solution obtained (yellow or orange depending on the precursor) was stirred for 18 hours at room temperature then carefully added to crushed ice with vigorous stirring until the end of the hydrolysis.

The precipitate thus obtained was filtered, washed three times with ice water, and once with cold dichloromethane, then dissolved in methanol under reflux.

The solution was poured into water to precipitate the product.

The precipitate was filtered, washed three times with water and dried in order to obtain a phenolic monomer of Formula 1 in the form of a grey, beige or pink powder depending on the nature of the precursor with a yield of between 85% and 94%.

The following compounds were obtained:

### N,N′-(cyclohexane-1,3-diylbis(methylene))bis(2,3-dihydroxybenzamide)—CYCAM

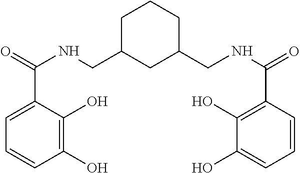 [SMILES: O=C(NCC1CCCC(CNC(=O)c2cccc(O)c2O)C1)c1cccc(O)c1O]

RMN ¹H (CD₃OD, 400 MHz, 25° C.) δ (ppm): 7.20 (d, J=8.2 Hz, 2H), 6.92 (d, J=7.8 Hz, 2H), 6.68 (t, J=8.1 Hz, 2H), 4.86 (s, 6H), 3.21 (d, J=6.8 Hz, 4H), 1.87-1.76 (m, 3H), 1.66-1.53 (m, 3H), 1.33-1.21 (m, 2H), 0.90 (qd, J=12.8, 2.9 Hz, 2H);

RMN ¹³C(CD₃OD, 100 MHz, 25° C.) δ (ppm): 171.42, 150.05, 147.26, 119.59, 119.52, 118.70, 116.92, 46.71, 44.40, 38.95, 36.29, 34.06, 31.84, 30.43, 26.49.

### N,N′-(pentane-1,5-diyl)bis(2,3-dihydroxybenzamide)-5-LICAM

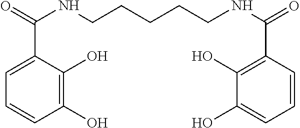 [SMILES: O=C(NCCCCCNC(=O)c1cccc(O)c1O)c1cccc(O)c1O]

RMN ¹H (CD₃OD, 400 MHz, 25° C.) δ (ppm): 7.19 (dd, J=8.1, 1.1 Hz, 2H), 6.91 (dd, J=7.9, 1.1 Hz, 2H), 6.70 (t, J=8.0 Hz, 2H), 4.93 (s, 6H), 3.39 (t, J=7.1 Hz, 4H), 1.67 (quint, J=7.4 Hz, 4H), 1.50-1.42 (m, 2H);

RMN ¹C(CD₃OD, 100 MHz, 25° C.) δ (ppm): 171.47, 150.22, 147.30, 119.53, 118.59, 40.35, 30.08, 25.36.

### N,N′-(1,3-phenylenebis(methylene))bis(2,3-dihydroxybenzamide)-m-BENZCAM

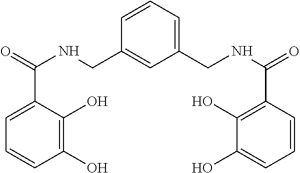 [SMILES: O=C(NCc1cccc(CNC(=O)c2cccc(O)c2O)c1)c1cccc(O)c1O]

RMN ¹H (CD₃OD, 400 MHz, 25° C.) δ (ppm): 7.35-7.21 (m, 6H), 6.92 (dd, J=7.9, 1.1 Hz, 2H), 6.70 (t, J=8.0 Hz, 2H), 4.93 (s, 6H), 4.56 (s, 4H);

RMN ¹³C(CD₃OD, 100 MHz, 25° C.) δ (ppm): 171.46, 150.29, 147.31, 140.37, 129.76, 127.39, 127.31, 119.68, 119.63, 118.70, 116.68, 43.87.

### Example 2: Synthesis of the Chelating Monomer Units of Formula 6

The chelating monomers of Formula 6 were obtained according to General Scheme 2

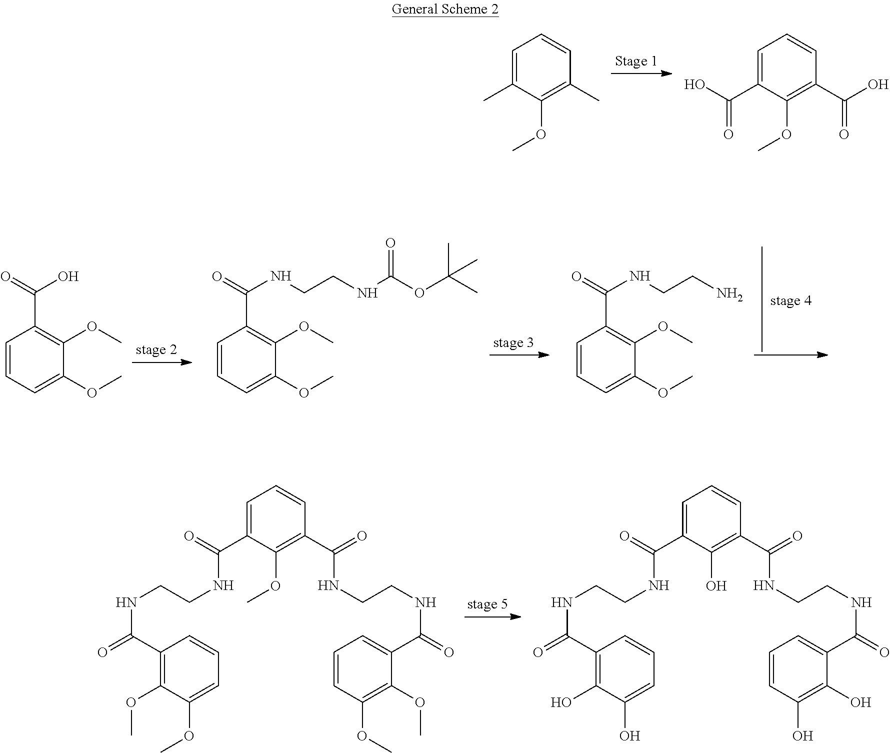

### Example 2A: Synthesis of Isophthalic Acid—Stage 1

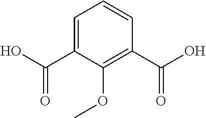

To a solution of 2,6-dimethylanisole (1 eq.) in water (0.22 M) was added KMnO₄ (2.1 eq.).

The solution was heated for 4 hours under reflux.

Another quantity of KMnO₄ (2.1 eq.) was added and the reflux is maintained for an additional 2.5 hours.

The reaction medium was then left stirring for 17 hours at room temperature and then filtered through celite.

The precipitate was washed twice with hot water and the filtrate was concentrated under reduced pressure to one third of the initial volume.

The solution thus obtained was acidified to a pH of 2.5 by adding a concentrated solution of HCl. The precipitate thus obtained was filtered, washed with water and dried to obtain 2-methoxyisophthalic acid in the form of a white powder with a yield of 73%.

RMN ¹H (DMSO-d6, 400 MHz, 25° C.) δ (ppm): 13.10 (s, 2H), 7.81 (d, J=7.7 Hz, 2H), 7.25 (t, J=7.7 Hz, 1H), 3.80 (s, 3H); RMN ¹³C (DMSO-d6, 100 MHz, 25° C.) δ (ppm): 167.03, 157.74, 133.50, 127.76, 123.60, 62.98.

### Example 2B: Synthesis of Dimethoxybenzamide/V-Boc—Stage 2

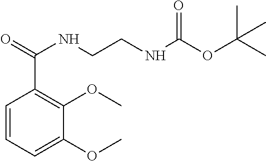 [SMILES: COc1cccc(C(=O)NCCNC(=O)OC(C)(C)C)c1OC]

To a solution of 2,3-dimethoxybenzoic acid (1.1 eq.) in anhydrous dichloromethane (0.4 M) was added oxalyl chloride (1.5 eq.).

After adding a few drops of N,N-dimethylformamide, the medium was stirred for 2 hours until the end of the release of HCl. After evaporation of the solvents and the residual oxalyl chloride, the residue was dissolved again in anhydrous dichloromethane (0.4 M) and added dropwise to a solution of N-Boc-ethylenediamine (1 eq.) and triethylamine (1.3 eq.) in anhydrous dichloromethane (0.4 M).

After 20 hours of stirring at room temperature, the medium was washed twice with an aqueous solution of 1 M HCl, a saturated solution of NaCl, then dried with MgSO₄ and evaporated under reduced pressure.

The residue was purified by flash chromatography on silica gel with a gradient of dichloromethane/ethyl acetate from 10/0 to 4/6 in order to obtain the (2-(2,3-dimethoxybenzamido)ethyl)carbamate of tert-butyl in the form of a thick colorless oil with a yield of 93%.

RMN ¹H (CD₂Cl₂, 400 MHz, 25° C.) δ (ppm): 8.17 (s, 1H), 7.60 (d, J=7.9 Hz, 1H), 7.14 (t, J=7.9 Hz, 1H), 7.06 (d, J=7.8 Hz, 1H), 5.02 (se, 1H), 3.89 (s, 3H), 3.88 (s, 3H), 3.53 (q, J=5.9 Hz, 2H), 3.32 (t, J=5.9 Hz, 2H), 1.40 (s, 9H);

RMN ¹³C (CD₂C₂, 100 MHz, 25° C.) δ (ppm): 166.00, 156.41, 153.18, 148.08, 126.98, 124.54, 122.74, 115.81, 79.36, 61.53, 56.39, 41.27, 40.07, 28.46.

### Example 2C: Synthesis of Dimethoxybenzamide—Stage 3

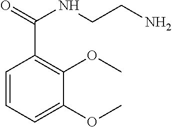 [SMILES: COc1cccc(C(=O)NCCN)c1OC]

To a solution of (2-(2,3-dimethoxybenzamido)ethyl)carbamate of tert-butyl (1 eq.), synthesized according to Example 2B, in dichloromethane (0.13 M) at 0° C. was added a solution of trifluoroacetic acid (20 eq.) in dichloromethane (3 M).

The solution thus obtained was stirred for 3 hours at room temperature then washed twice with an aqueous solution of NaOH until a pH>10 was obtained, a saturated solution of NaCl, water then evaporated under reduced pressure in order to obtain N-(2-aminoethyl)-2,3-dimethoxybenzamide in the form of an orange oil with a yield of 95%.

RMN ¹H (CD₂Cl₂, 400 MHz, 25° C.) δ (ppm): 8.26 (se, 1H), 7.60 (d, J=7.8 Hz, 1H), 7.13 (t, J=8.0 Hz, 1H), 7.05 (d, J=7.9 Hz, 1H), 3.89 (s, 3H), 3.87 (s, 3H), 3.46 (q, J=5.9 Hz, 2H), 2.89 (t, J=5.9 Hz, 2H), 1.47 (s, 2H);

RMN ¹³C (CD₂Cl₂, 100 MHz, 25° C.) δ (ppm): 165.39, 153.21, 148.03, 124.49, 122.73, 115.57, 61.52, 56.37, 42.81, 41.96.

### Example 2D: Synthesis of Methylated Isophthalamide-Bis-Catecholamide—Stage 4

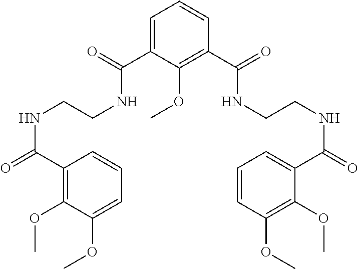 [SMILES: COc1cccc(C(=O)NCCNC(=O)c2cccc(C(=O)NCCNC(=O)c3cccc(OC)c3OC)c2OC)c1OC]

To a solution of 2-methoxyisophthalic acid, synthesized according to example 2A, (1 eq.) and hydrated HOBT (2.1 eq.) in THE (0.05 M) was added dropwise a solution of DCC (2.1 eq.) in THE (0.23 M) at 0° C. then the medium was stirred for four hours at room temperature.

The precipitate thus formed was filtered off and the filtrate was added dropwise to a solution of A-(2-aminoethyl)-2,3-dimethoxybenzamide (2.1 eq.) previously synthesized in THE (0.11 M) at 0° C. then the medium was stirred for twenty-four hours at room temperature.

Dichloromethane was then added to the reaction medium and the latter was washed twice with an aqueous solution of 1 M NaOH and water.

The organic phase was dried with MgSO₄ and then concentrated under vacuum.

The residue was purified by flash chromatography on silica gel using a gradient of dichloromethane/methanol from 100/0 to 97/3 in order to obtain N¹,N³-bis(2-(2,3-dimethoxybenzamido)ethyl)-2-methoxyisophthalamide in the form of a white powder with a yield of 97%.

RMN ¹H (CD₂Cl₂, 400 MHz, 25° C.) δ (ppm): 8.28 (se, 2H), 8.00 (d, J=7.7 Hz, 2H), 7.77 (se, 2H), 7.59 (dd, J=7.9, 1.7 Hz, 2H), 7.26 (t, J=7.7 Hz, 1H), 7.13 (t, J=7.9 Hz, 2H), 7.06 (dd, J=8.2, 1.6 Hz, 2H), 3.86 (s, 6H), 3.85 (s, 6H), 3.76 (s, 3H), 3.71-3.67 (m, 8H);

RMN ¹³C (CD₂Cl₂, 100 MHz, 25° C.) δ (ppm): 166.13, 165.75, 156.59, 153.16, 148.08, 134.35, 128.49, 126.80, 125.09, 124.55, 122.65, 115.86, 63.78, 61.55, 56.36, 40.59, 39.84.

### Example 2E: Synthesis of Isophthalamide-Bis-Catecholamide-IPACAM—Stage 5

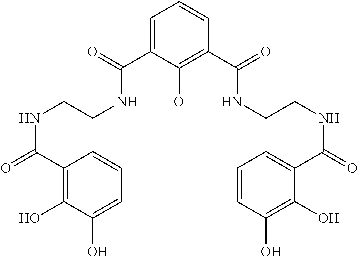 [SMILES: O=C(NCCNC(=O)c1cccc(C(=O)NCCNC(=O)c2cccc(O)c2O)c1O)c1cccc(O)c1O]

To a solution of N¹,N³-bis(2-(2,3-dimethoxybenzamido)ethyl)-2-methoxyisophthalamide, synthesized according to Example 2D (1 eq.) in anhydrous dichloromethane (0.08 M) was added dropwise drop of BBr₃ (9 eq.) with vigorous stirring at 0° C. The solution thus obtained was stirred for three days at room temperature and then carefully added to crushed ice with vigorous stirring until the end of the hydrolysis.

The precipitate thus obtained was filtered, washed three times with water and then dissolved in methanol under reflux.

The solution was added to water to precipitate the product.

The precipitate was filtered, washed three times with water and dried to obtain the phenolic monomer IPACAM, in the form of a beige powder with a yield of 95%.

RMN ¹H (CD₃OD, 400 MHz, 25° C.) δ (ppm): 7.96 (d, J=7.9 Hz, 2H), 7.18 (dd, J=8.0, 0.9 Hz, 2H), 6.96-6.90 (m, 3H), 6.69 (t, J=8.0 Hz, 2H), 4.94 (s, 9H), 3.63 (s, 8H);

RMN ¹³C(CD₃OD, 100 MHz, 25° C.) δ (ppm): 172.08, 170.07, 161.40, 150.38, 147.31, 134.09, 119.69, 119.57, 119.26, 118.62, 116.54, 40.42, 40.17.

### Example 3: Synthesis of Formo-Phenolic Resins

Formo-phenolic resins have been synthesized using:
one of the chelating monomers synthesized in Example 1 or in Example 2 above as first phenolic monomer or as sole phenolic monomer,
phenol, catechol or resorcinol as second phenolic monomer or as sole phenolic monomer,
formaldehyde as an aldehyde,
an aqueous solution of sodium hydroxide as a strong base,
and water, with
A chelating monomer/phenolic monomer/strong base/H2O/formaldehyde molar ratio of 0/1/1.5/100/2.5 when the resin contains only phenol as monomer, of 1/0/3/100/3.75, 0.5/0.5/3/100/3.75, 0.34/0.66/3/100/3.75 when the resin contains partly or only IPACAM, and 1/0/3/100/2.5, 0.5/0.5/3/100/2.5, 0.34/0.66/3/100/2.5 and 0/1/3/100/2.5 in all other cases.

A mixture of chelating monomer and phenolic monomer, or only chelating monomer, or only phenolic monomer was first dissolved in a NaOH solution with stirring.

Then, water is added in order to reach 100 equivalents with respect to the mixture of chelating monomer and phenolic monomer, or only to the chelating monomer, or only to the phenolic monomer.

The resulting solution was stirred and then the formaldehyde was added.

The reaction mixture was kept under stirring for 24 hours, after which it was transferred to a container with a wide neck and a flat bottom, such as a beaker, and then heated in a ventilated oven at 100° C. for 96 hours.

After solidification and then hardening of this mixture, the resin thus formed was recovered, ground using a ball mill and then washed.

Two types of successive washes were used depending on the form of resin to be obtained.

In all cases, the solutions used were added to the resin at a concentration of 40 mL/g of resin:
0.1 M NaOH, 0.1 M HCl, then twice water to keep the resin in the protonated —OH form,
0.1 M NaOH, then water three times in order to keep the resin in the deprotonated form
—ONa.

The resins thus washed were dried in a ventilated oven at 80° C. for 24 hours.

After drying, the resins were dispersed using a mortar and then dried again at 80° C. for 5 hours after which they were stored.

Twenty-six resins presented in Table 1 were thus synthesized.

The nature and the molar ratio of the various monomers used as well as the form wherein the resin was preserved after washing are also indicated.

TABLE 1

| | First phenolic | Molar | Second phenolic | Molar | Resin |
|---|---|---|---|---|---|
| Name of the resin | monomer | ratio | monomer | ratio | form |
| CYCAM100-H | CYCAM | 1 | — | — | —OH |
| 5-LICAM100-H | 5-LICAM | 1 | — | — | —OH |
| m-BENZCAM100-H | m-BENZCAM | 1 | — | — | —OH |
| IPACAM100-H | IPACAM | 1 | — | — | —OH |
| IPACAM100-Na | IPACAM | 1 | — | — | —ONa |
| CYCAM50-P50-H | CYCAM | 0.5 | Phenol | 0.5 | —OH |
| CYCAM34-P66-H | CYCAM | 0.34 | Phenol | 0.66 | —OH |
| IPACAM50-P50-H | IPACAM | 0.5 | Phenol | 0.5 | —OH |
| IPACAM34-P66-H | IPACAM | 0.34 | Phenol | 0.66 | —OH |
| IPACAM50-C50-H | IPACAM | 0.5 | Catechol | 0.5 | —OH |
| IPACAM50-C50-Na | IPACAM | 0.5 | Catechol | 0.5 | —ONa |
| IPACAM34-C66-H | IPACAM | 0.34 | Catechol | 0.66 | —OH |
| IPACAM34-C66-Na | IPACAM | 0.34 | Catechol | 0.66 | —ONa |
| 5-LICAM50-R50-H | 5-LICAM | 0.5 | Resorcinol | 0.5 | —OH |
| 5-LICAM50-R50-Na | 5-LICAM | 0.5 | Resorcinol | 0.5 | —ONa |
| 5-LICAM34-R66-H | 5-LICAM | 0.34 | Resorcinol | 0.66 | —OH |
| 5-LICAM34-R66-Na | 5-LICAM | 0.34 | Resorcinol | 0.66 | —ONa |
| m-BENZCAM50-R50-H | m-BENZCAM | 0.5 | Resorcinol | 0.5 | —OH |
| m-BENZCAM50-R50-Na | m-BENZCAM | 0.5 | Resorcinol | 0.5 | —ONa |
| m-BENZCAM34-R66-H | m-BENZCAM | 0.34 | Resorcinol | 0.66 | —OH |
| m-BENZCAM34-R66-Na | m-BENZCAM | 0.34 | Resorcinol | 0.66 | —ONa |
| P100-H | — | — | Phenol | 1 | —OH |
| C100-H | — | — | Catechol | 1 | —OH |
| C100-Na | — | — | Catechol | 1 | —ONa |
| R100-H | — | — | Resorcinol | 1 | —OH |
| R100-Na | — | — | Resorcinol | 1 | —ONa |

The resins in Table 1 were characterized by elemental analysis.

By way of example, the elemental analysis results for the m-BENZCAM100-H, m-BENZCAM50-R50-H and m-BENZCAM34-R66-H resins are given below.

m-BENZCAM100-H:

Elemental analysis: C: 57.36%, H: 4.34%, N: 6.03%.

m-BENZCAM50-R50-H:

Elemental analysis: C: 56.79%, H: 4.39%, N: 4.56%.

m-BENZCAM34-R66-H:

Elemental analysis: C: 56.12%, H: 4.47%, N: 3.53%.

### Example 4: Selective Extraction of Uranium by Resins According to the Invention

The ability of the resins to selectively extract uranium from seawater was determined by extraction tests carried out in discontinuous mode (batch), using, as aqueous solution, three different solutions, respectively referred to below solutions 1, 2 and 3, and consisting of:
Solution 1: a solution simulating seawater doped with 50 ppm in uranium (1.9.10⁻⁴ M in uranyl) and 60 ppm in carbonates (1.0.10⁻³M) at a pH of 8.25±0.1.
Solution 2: a solution simulating seawater doped with 200 ppm in uranium (7.4.10⁻⁴M in uranyl) and 226 ppm in carbonates (3.8.10.3M) at a pH of 8.25±0.1
Solution 3: a solution simulating seawater doped with 50 ppm in uranium (1.9.10-⁴M in uranyl), 100 ppm in strontium (1.2.10.3M), 200 ppm in sodium (8.7.10.3M), 200 ppm in potassium (5.2.10⁻M), 200 ppm in calcium (5.1.10⁻³M), 200 ppm in magnesium (8.4.10⁻³M) and 60 ppm in carbonates (1.0.10⁻³M) at a pH of 8.25±0.1.
Solution 4: a solution corresponding to water from the Rhône doped with 50 ppm in uranium (1.9.10⁻⁴M in uranyl).
These tests consist in bringing a certain quantity of resin into contact with a certain volume of solution 1, 2 or 3, in leaving the mixture under stirring at 22° C. for 15 hours, then, after centrifugation, in removing the supernatant, in filtering (on a 0.22 μm cellulose acetate membrane) and in measuring the concentration of the various cations present in the filtrate by atomic emission spectrometry with induction coupled plasma (ICP-AES) or by mass spectrometry with plasma coupled by induction (ICP-MS) when the uranium concentrations are very low and difficult to measure by ICP-AES.
Thus, for each cation were determined:
The adsorption capacity, noted Q_{ads} and expressed in mg of extracted metal/g of resin, which represents the quantity of this cation present in the resin, and which was determined by the following formula:

$${Q}_{ads} = ( {C}_{i} - {C}_{f} ) \cdot \frac{V}{m} \qquad Formule 1$$

The percentage of extraction, noted E and expressed in %, which represents the percentage of cation extracted by the resin compared to the initial quantity of cation, and which was determined by the following formula:

$$E = \frac{{C}_{i} - {C}_{f}}{{C}_{i}} \cdot 100 \qquad Formule 2$$

The distribution coefficient, noted K_{D} and expressed in mL/g, which represents the ratio between the quantity of this cation present in the resin and the quantity of this cation remaining in solution after extraction, and which was determined by the following formula:

$${K}_{D} = \frac{{C}_{i} - {C}_{f}}{{C}_{f}} \cdot \frac{V}{m} \cdot 1000 \qquad Formule 3$$

The separation factor, denoted FS_{U/M}, where M represents a competing metal, which represents the ratio between the K_{D} of uranium and the K_{D} of another metal, which makes it possible to quantify the selectivity of a resin to be extracted uranium with respect to another metal, and which was determined by the following formula:

$${FS}_{U / M} = \frac{{K}_{{D}_{U}}}{{K}_{{D}_{M}}} \qquad Formule 4$$

avec:
Cᵢ=initial concentration of the cation in solution (mg/L),
C_{f}=concentration of the cation in solution after extraction (mg/L),
V=volume of solution (mL),
m=mass of resin (mg).

Table 2 below presents the Q_{ads}, E and K_{D} values obtained for uranium with twenty-four resins synthesized in example 3 and solutions 1 and 2 for Vim ratios equal to 1 and 4.

TABLE 2

| | | Solution 1 | | | Solution 2 | | |
|---|---|---|---|---|---|---|---|
| | | Q_{ads} | E | K_{D} | Q_{ads} | E | K_{D} |
| Name of the resin | V/m | (mg/g) | (%) | (mL/g) | (mg/g) | (%) | (mL/g) |
| CYCAM100-H | 1 | 19.3 | 38 | 615 | | | |
| 5-LICAM100-H | 1 | 22.5 | 44 | 794 | 5.8 | 3 | 29 |
| m-BENZCAM100-H | 1 | >50.3 | >99 | >100000 | 199.5 | 99 | 68855 |
| | 4 | — | — | — | 354.2 | 44 | 3110 |
| IPACAM100-H | 1 | 26.3 | 52 | 1071 | | | |
| IPACAM100-Na | 1 | | | | 88.3 | 46 | 869 |
| CYCAM50-P50-H | 1 | 30.3 | 60 | 1485 | | | |
| CYCAM34-P66-H | 1 | 42.7 | 84 | 5273 | | | |
| IPACAM50-P50-H | 1 | 23.6 | 46 | 866 | | | |
| IPACAM34-P66-H | 1 | 30.0 | 59 | 1442 | | | |
| IPACAM50-C50-H | 1 | | | | 16.8 | 9 | 97 |
| IPACAM50-C50-Na | 1 | | | | 78.0 | 41 | 697 |
| IPACAM34-C66-H | 1 | | | | 36.7 | 19 | 240 |
| IPACAM34-C66-Na | 1 | | | | 84.0 | 44 | 794 |
| 5-LICAM50-R50-H | 1 | 50.2 | 99 | 84223 | 199.8 | 99 | 76326 |
| 5-LICAM50-R50-Na | 4 | — | — | — | 353.1 | 44 | 3093 |
| 5-LICAM34-R66-H | 1 | 50.1 | 99 | 75662 | 200.0 | 99 | 81629 |
| 5-LICAM34-R66-Na | 4 | — | — | — | 408.5 | 50 | 4073 |
| m-BENZCAM50-R50-H | 1 | >50.3 | >99 | >100000 | 200.1 | 99 | 85587 |
| m-BENZCAM50-R50-Na | 4 | — | — | — | 418.4 | 52 | 4276 |
| m-BENZCAM34-R66-H | 1 | >50.3 | >99 | >100000 | 200.4 | 99 | 97367 |
| m-BENZCAM34-R66-Na | 4 | — | — | — | 446.2 | 55 | 4908 |
| P100-H | 1 | 45.1 | 89 | 7919 | | | |
| C100-H | 1 | >50.3 | >99 | >100000 | 128.5 | 68 | 2092 |
| | 4 | — | — | — | 143.0 | 19 | 928 |
| R100-H | 1 | 46.9 | 92 | 12216 | | | |

Table 3 below presents the values of Q_{ads}, E and K_{D} obtained for uranium as well as the values of FS_{U/M} (where M is a competing cation) obtained with the twenty-six resins synthesized in Example 3 and solution 3 for a V/m ratio equal to 1.

TABLE 3

| | Solution 3 | | | | | | | |
|---|---|---|---|---|---|---|---|---|
| | Q_{ads} U | E U | K_{D} U | | | | | |
| Name of the resin | (mg/g) | (%) | (mL/g) | FS_{U/Sr} | FS_{U/Ca} | FS_{U/Mg} | FS_{U/Na} | FS_{U/K} |
| CYCAM100-H | 11.6 | 22 | 287 | 13 | 7 | 13 | 12 | 12 |
| 5-LICAM100-H | 7.2 | 14 | 160 | 10 | 5 | 11 | 8 | 7 |
| m-BENZCAM100-H | 26.1 | 50 | 997 | 12 | 7 | 36 | 86 | 90 |
| IPACAM100-H | 16.1 | 31 | 445 | 19 | 10 | 19 | 20 | 20 |
| IPACAM100-Na | 48.7 | 99 | 73730 | 825 | 355 | 754 | 6615 | 7212 |
| CYCAM50-P50-H | 17.7 | 34 | 512 | 30 | 10 | 33 | 36 | 38 |
| CYCAM34-P66-H | 17.1 | 33 | 487 | 27 | 13 | 28 | 31 | 33 |
| IPACAM50-P50-H | 16.1 | 31 | 445 | 20 | 11 | 19 | 19 | 19 |
| IPACAM34-P66-H | 20.0 | 38 | 621 | 26 | 13 | 25 | 26 | 27 |
| IPACAM50-C50-H | 28.9 | 59 | 1416 | 53 | 31 | 78 | 190 | 178 |
| IPACAM50-C50-Na | 48.2 | 98 | 43038 | 577 | 302 | 627 | 3343 | 3467 |
| IPACAM34-C66-H | 46.3 | 94 | 15235 | 335 | 264 | 547 | 1542 | 1590 |
| IPACAM34-C66-Na | 48.5 | 98 | 60270 | 851 | 471 | 1043 | 6335 | 6333 |
| 5-LICAM50-R50-H | 50.5 | 97 | 28950 | 346 | 206 | 683 | 1704 | 1798 |
| 5-LICAM50-R50-Na | 49.2 | 100 | 518179 | 4237 | 2548 | 7435 | 36015 | 37041 |
| 5-LICAM34-R66-H | 51.0 | 98 | 39202 | 392 | 259 | 810 | 1984 | 2038 |
| 5-LICAM34-R66-Na | 49.2 | 100 | 327813 | 2422 | 1556 | 5204 | 29388 | 30491 |
| m-BENZCAM50-R50-H | 45.3 | 87 | 6526 | 80 | 48 | 202 | 574 | 589 |
| m-BENZCAM50-R50-Na | 49.0 | 99 | 178353 | 1450 | 899 | 3100 | 20659 | 19556 |
| m-BENZCAM34-R66-H | 50.5 | 97 | 29385 | 323 | 209 | 914 | 3568 | 3167 |
| m-BENZCAM34-R66-Na | 49.1 | 100 | 213443 | 1530 | 1026 | 3690 | 25275 | 22135 |
| P100-H | 1.4 | 3 | 27 | 2 | 1 | 1 | 2 | 2 |
| C100-H | 51.4 | 98 | 62348 | 973 | 677 | 2216 | 6014 | 5186 |
| C100-Na | 44.2 | 90 | 8626 | 76 | 59 | 185 | 1321 | 841 |
| R100-H | 30.4 | 58 | 1385 | 34 | 20 | 58 | 62 | 41 |
| R100-Na | 18.9 | 38 | 619 | 7 | 5 | 15 | 35 | 30 |

TABLE 4

| | Solution 4 | | |
|---|---|---|---|
| Name of the resin | Q_{ads} U (mg/g) | E U (%) | K_{D} U (mL/g) |
| m-BENZCAM50-R50-H | 19.4 | 95 | 18036 |
| m-BENZCAM34-R66-H | 22.8 | 97 | 39809 |

Table 4 These results show that formo-phenolic resins have a good affinity for uranium.

This affinity is greater when the resins contain a chelating monomer and even greater when they are in the deprotonated —ONa form.

In the presence of competing metals, the resins retain their good affinity for uranium.

In this case, the resins not only have a very good affinity for uranium, but also excellent selectivity with respect to all the competing metals tested.

For example, in the absence of competing metals, the m-BENZCAM34-R66-H resin makes it possible to extract almost half of its mass in uranium (Q_{ads}=446.2 mg/g).

This excellent affinity is preserved in the presence of competing metals (E=97%) with excellent selectivities.

In the presence of competing metals, the resin that seems to stand out from the others is 5-LICAM50-R50-Na with 100% uranium extraction, a uranium adsorption capacity of 49.2 mg/g and separation factors between 2548 and 37041.

This resin is indeed a striking example of the importance of adding a chelating phenolic monomer within the resin in order to increase the selectivity, since the RI 00-Na resin, containing only resorcinol, has separation only between 5 and 35.

These results, in terms of load capacity and selectivity, have never been achieved in the literature by other types of materials, for the extraction of uranium from seawater, by solid-liquid extraction.

1-17. (canceled)

18. A method for preparing a crosslinked formo-phenolic resin, said method comprising a step of heating a reaction medium comprising:
100% chelating monomer units of Formula 1-A, or
100% chelating monomer units of Formula 6-A, or
a mixture of chelating monomer units of Formula 1-A and Formula 6-A, or
a mixture of monomer units of Formula 1-A and Formula 7-A, or
a mixture of monomer units of Formula 6-A and Formula 7-A, or
a mixture of monomer units of Formula 1-A, of Formula 6-A, and of Formula 7-A,
and an aldehyde having the structure R′″—(CHO)ᵥ, wherein R′″ represents an atom of hydrogen, a linear or branched C₁ to C₉ alkyl group, an aryl group, a heteroaryl group, a linear or branched C₁ to C₉-alkylearyl group, a linear or branched C₁ to C₉-heteroalkyl-aryl group,
a linear or branched C₁ to C₉-alkylheteroaryl, a linear or branched C₁ to C₉-alkyl-aryl-C₁ to C₉ alkyl group, a linear or branched C₁ to C₉-alkyl-heteroaryl-C₁ to C₉-alkyl,
and wherein v represents 1 or 2,
in particular formaldehyde, in particular in the form of formaldehyde, paraformaldehyde, or 1,3,5-trioxane,
and a base,
and optionally a solvent,
wherein the chelating monomer units of Formula 1-A have the following structure: 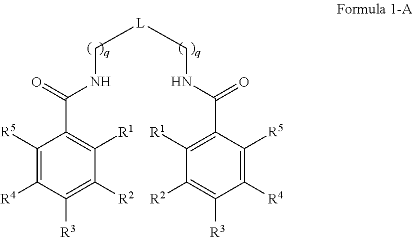
wherein:
at least one of the R¹ to R⁵ substituents represents an —OH group or a salt form,
and
at least one of the R¹ to R⁵ substituents represents a hydrogen atom,
and wherein:
q is 0, 1, 2 or 3,
R¹, R², R³, R⁴ and R⁵ independently represent: a hydrogen atom, or a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O)NRR′ group wherein R and R′ represent independently of each other a hydrogen atom or a C₁ to C₁₀ alkyl group,
L is a linker chosen from one of the following structures: 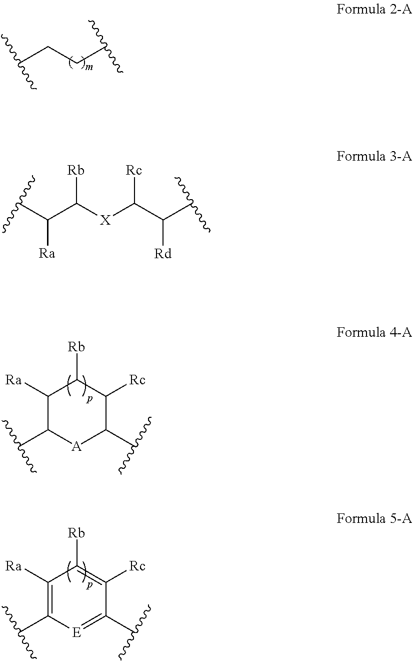
wherein
m is 0, 1, 2, 3, 4 or 5,
p is 0 or 1,
A represents a —CH₂ group, a —CH—OH group, an oxygen atom, an —NH— group, an N-oxide group or a sulfur atom,
E represents a CH group, a C—OH group, an oxygen atom, a nitrogen atom, an N-oxide group or a sulfur atom,
Rₐ, R_{b}, R_{c}, and R_{d} represent independently
a group chosen from:
—OH, or a salified form, in particular chosen from —ONa, —OK, —OLi, et-OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O) NRR′ group wherein R and R′ are independently hydrogen or C₁ to C₁₀ alkyl, and
wherein the chelating monomer units of Formula 6-A have the following structure: 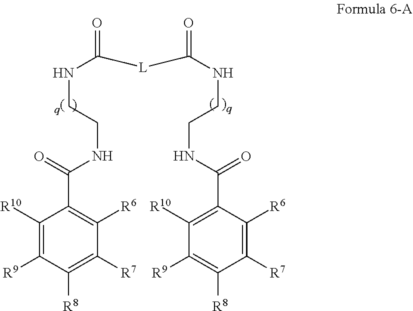
wherein:
at least one of the R⁶ to R¹⁰ substituents represents an —OH group or a salified form, and
at least one of the R⁶ to R¹⁰ substituents represents a hydrogen atom,
and wherein:
q and L are as defined above top for Formula 1-A,
R⁶, R⁷, R¹, R⁹ and R¹⁰ independently represent:
a hydrogen atom, or
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O)NRR′ group wherein R and R′ are independently hydrogen or C₁ to C₁₀ alkyl, and
wherein the monomer units of Formula 7-A have the following structure: 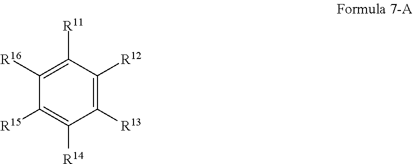
wherein:
at least one of the R¹¹ to R¹⁶ substituents represents an —OH group or a salt form, and
at least two of the R¹¹ to R¹⁶ substituents represent a hydrogen atom,
and wherein:
—R¹¹, R¹², R¹³, R¹⁴, R¹⁵ and R¹⁶ independently represent:
a hydrogen atom, or
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl, or polyaryl with 1 to 4 aromatic rings, if R¹⁵ represents an aryl or polyaryl group, said aryl or polyaryl group may be fused with the monomer unit of Formula 7-A at position R¹⁶, said monomer unit of Formula 7-A being in particular a naphthol,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O)NRR′ group wherein R and R′ are independently of each other a hydrogen atom or a C₁ to C₁₀ alkyl group,
and wherein from 2 to 8 monomer units of Formula 7-A can be linked together by a linear or branched C₁ to C₁₀ alkyl group, said monomer unit of Formula 7-A being in particular a calixarene comprising from 2 to 8 monomer units of Formula 7-A,
or wherein from 2 to 4 monomer units of Formula 7-A may be linked to each other by a linear or branched C₁ to C₁₀ heteroalkyl group, the heteroatom being in particular 0, the said monomer unit of Formula 7-A being in particular a crown ether comprising from 2 to 4 monomer units of Formula 7-A,
to obtain a crosslinked formo-phenolic resin consisting of a polymer containing monomer units linked together by a —R″-group, in particular by a —(CH₂)-group.

19. The method for preparing a crosslinked formo-phenolic resin according to claim 18, wherein the chelating monomer units are of Formula 1-A,
said chelating monomer units of Formula 1-A being able to be mixed with at least one of the monomer units of Formulas 6-A and 7-A,
said Formula 1-A being such that:
at least one of the R¹ to R⁵ substituents represents an —OH group or a salified form, and
at least one of the R¹ to R⁵ substituents represents a hydrogen atom,
and
q is 0, 1, 2 or 3,
R¹, R², R³, R⁴ and R⁵ independently represent:
a hydrogen atom, or
a group chosen from:
—OH, or a salified form, in particular chosen from —ONa, —OK, —OLi, and —OCs,
linear or branched C₁ to C₁₀ alkyl,
L is a linker chosen from one of the following structures: 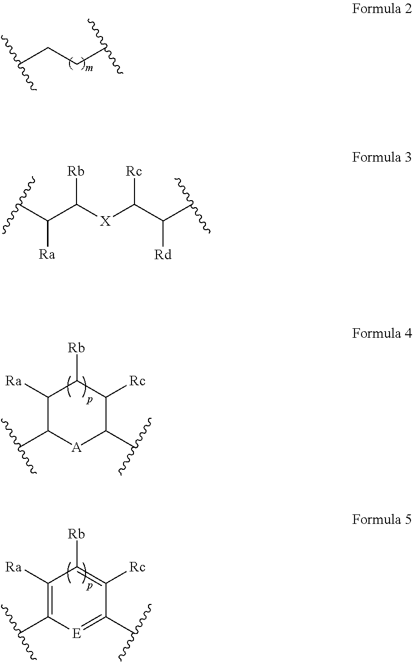
wherein
m is 0, 1, 2, 3, 4 or 5,
p is 0 or 1,
A represents a —CH₂ group,
E represents a CH group, or a C—OH group,
Rₐ, R_{b}, R_{c}, and Rₐ represent independently
-a group chosen from:
—OH, or a salified form, in particular chosen from —ONa, —OK, —OLi, and —OCs,
linear or branched C₁ to C₁₀ alkyl,
and/or
wherein the chelating monomer units are of Formula 6-A,
said chelating monomer units of Formula 6-A being able to be mixed with at least one of the monomer units of Formulas 1-A and 7-A,
said Formula 6-A being such that:
at least one of the R⁶ to R¹⁰ substituents represents an —OH group or a salified form, and
at least one of the R⁶ to R¹⁰ substituents represents a hydrogen atom,
and
q is 0, 1, 2 or 3,
R¹, R², R³, R⁴ and R⁵ independently represent:
a hydrogen atom, or
a group chosen from:
—OH, or a salified form, in particular chosen from —ONa, —OK, —OLi, and —OCs,
linear or branched C₁ to C₁₀ alkyl,
L is a linker chosen from one of the following structures: 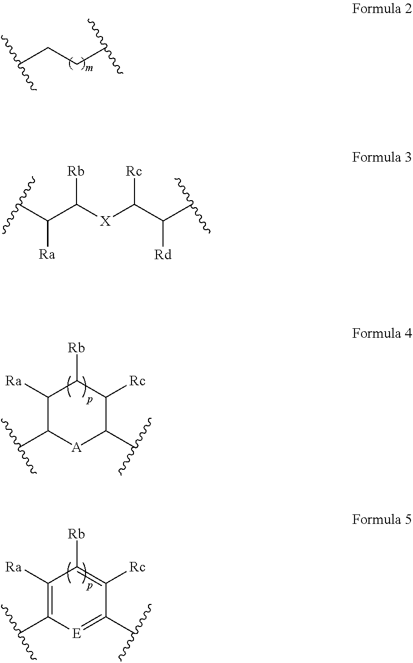
wherein:
m is 0, 1, 2, 3, 4 or 5,
p is 0 or 1,
A represents a —CH₂ group,
E represents a CH group, or a C—OH group,
Rₐ, R_{b}, R_{c}, and R_{d} represent independently
a group chosen from:
—OH, or a salified form, in particular chosen from —ONa, —OK, —OLi, and —OCs,
linear or branched C₁ to C₁₀ alkyl,
and/or
wherein the monomer units are of Formula 7-A, said monomer units of Formula 7-A being mixed with at least one of the monomer units of Formula 1-A and 6-A,
said Formula 7-A being such that:
at least one of the R¹¹ to R¹⁶ substituents represents an —OH group or a salified form,
and
at least two of the R¹¹ to R¹⁶ substituents represent a hydrogen atom, and
R¹¹, R¹², R¹³, R¹⁴, R¹⁵ and R¹⁶ independently represent:
a hydrogen atom, or
a group chosen from:
—OH, or a salified form, in particular chosen from —ONa, —OK, —OLi, and
—OCs,
linear or branched C₁ to C₁₀ alkyl,
linear or branched C₁ to C₁₀ heteroalkyl, the heteroatom being 0,
aryl,
linear or branched C₁ to C₁₀ alkylaryl,
halogen, in particular F or Cl.

20. The method according to claim 18, wherein
the base is a strong base, chosen in particular from lithium hydroxide, sodium hydroxide, potassium hydroxide or cesium hydroxide, in particular sodium hydroxide, and/or
the solvent is water, and/or
the heating step is carried out at a temperature between 80° C. and 150° C., and/or
the heating step is carried out for a time ranging from 16 to 96 hours.

21. The method according to claim 18, further comprising, after the heating step, at least one washing step, said washing step being carried out in particular with:
an aqueous solution of a strong base, in particular sodium hydroxide, then water, to obtain a formo-phenolic resin wherein the —OH groups are salified, in particular in the —ONa form, or
an aqueous solution of a strong base, in particular sodium hydroxide, then an aqueous solution of hydrochloric acid, then water, to obtain a formo-phenolic resin comprising —OH groups,
and/or further comprising, after the heating step, or after the washing step, a drying step, in particular in an oven at a temperature of 80° C., for 24 hours, to obtain a dried formo-phenolic resin,
and/or further comprising, after the heating step, after the washing step, or after the drying step, a grinding step, to obtain a ground formo-phenolic resin.

22. A cross-linked formo-phenolic resin as obtained by the method according to claim 18.

23. A cross-linked formo-phenolic resin, consisting of a polymer containing monomer units linked together by one or more —R″— group(s),
wherein R″ represents a linear or branched C₁-C₁₀-alkyl group, a linear or branched C₁ to C₁₀ alkylaryl group, a linear or branched C₁ to C₁₀-alkylaryl C₁ to C₁₀-alkyl group, a linear or branched C₁ to C₁₀-alkyl-heteroaryl-C₁ to C₁₀-alkyl group,
said monomer units being:
either chelating monomer units of Formula 1-B: 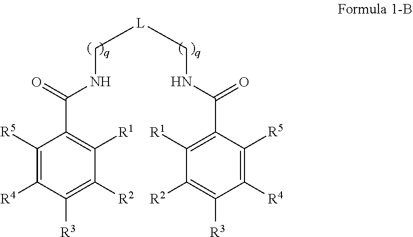
wherein:
at least one of the R¹ to R⁵ substituents represents an —OH group or a salified form, and
at least one of the R¹ to R⁵ substituents represent a hydrogen atom,
and wherein:
q is 0, 1, 2 or 3,
R¹, R², R³, R⁴ and R⁵ independently represent:
a hydrogen atom, or
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O)NRR′ group wherein R and R′ represent independently of each other a hydrogen atom or a C₁ to C₁₀ alkyl group,
L is a linker chosen from one of the following structures: 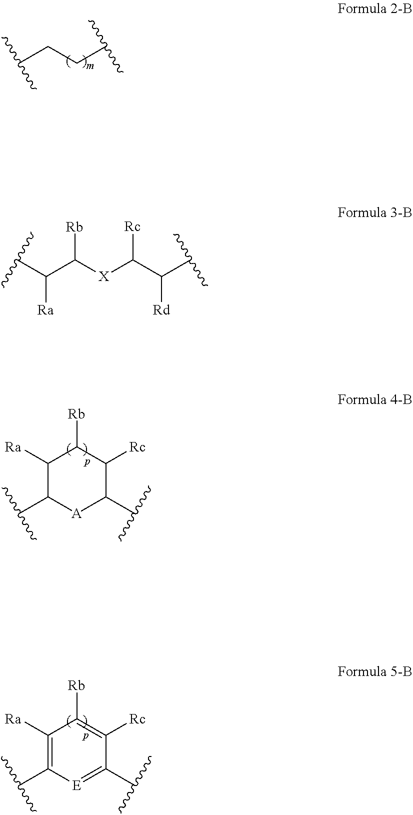
wherein
m is 0, 1, 2, 3, 4 or 5,
p is 0 or 1,
A represents a —CH₂ group, a —CH—OH group, an oxygen atom, an —NH— group, a N-oxide group or a sulfur atom,
E represents a CH group, a C—OH group, an oxygen atom, a nitrogen atom, a N-oxide group or a sulfur atom,
Rₐ, R_{b}, R_{c}, and R_{d} represent independently
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O)NRR′ group wherein R and R′ represent independently of each other a hydrogen atom or a C₁ to C₁₀ alkyl group,
or chelating monomer units of Formula 6-B: 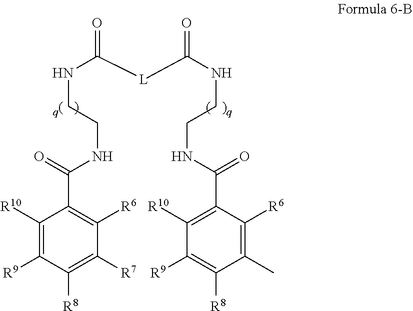
wherein:
at least one of the R⁶ to R¹⁰ substituents represents an —OH group or a salt form, and
at least one of the R⁶ to R¹⁰ substituents represent a hydrogen atom,
and wherein:
q and L are as defined above for Formula 1-B,
R⁶, R⁷, R¹, R⁹ and R¹⁰ independently represent:
a hydrogen atom, or
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O)NRR′ group wherein R and R′ independently of each other represent a hydrogen atom or a C₁ to C₁₀ alkyl group, and optionally monomer units of Formula 7-B: 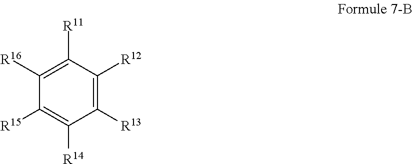
wherein:
at least one of the R¹¹ to R¹⁶ substituents represents an —OH group or a salt form, and
at least two of the R¹¹ to R¹⁶ substituents represent a hydrogen atom,
wherein:
—R¹¹, R¹², R¹³, R¹⁴, R¹⁵ and R¹⁶ independently represent:
a hydrogen atom, or
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl, or polyaryl of 1 to 4 aromatic rings, if R¹⁵ represents an aryl or polyaryl group, said aryl or polyaryl group can be fused with the monomer unit of Formula 7-B at the R¹⁶ position, said monomer unit of Formula 7-B being in particular a naphthol,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O)NRR′ group wherein R and R′ represent independently of each other a hydrogen atom or a C₁ to C₁₀ alkyl group,
and wherein from 2 to 8 monomer units of Formula 7-B can be linked together by a linear or branched C₁ to C₁₀ alkyl group, said monomer unit of Formula 7-B being in particular a calixarene comprising from 2 to 8 monomer units of Formula 7-B,
or wherein from 2 to 4 monomer units of Formula 7-B can be linked together by a linear or branched C₁ to C₁₀ heteroalkyl group, the heteroatom being in particular 0, said monomer unit of Formula 7-B being in particular a crown ether comprising from 2 to 4 monomer units of Formula 7-B,
or one of at least two any of the monomer units of Formula 1-B, 6-B and 7-B,
wherein the structure of Formula 7-B does not correspond to the structure of Formula 1-B or 6-B,
said group —R″— being located:
either between two chelating monomer units of Formula 1-B, on at least one carbon atom of the monomer unit carrying a R¹ to R⁵ substituent which represents a hydrogen atom,
or between two chelating monomer units of Formula 6-B, on at least one carbon atom of the monomer unit carrying a R⁶ to R¹⁰ substituent which represents a hydrogen atom,
or between a chelating monomer unit of Formula 1-B, on at least one carbon atom of the monomer unit carrying a R¹ to R⁵ substituent which represents a hydrogen atom, and at least one carbon atom of the monomer unit of Formula 6-B carrying a R⁶ to R¹⁰ substituent which represents a hydrogen atom,
or between a chelating monomer unit of Formula 1-B, on at least one carbon atom of the monomer unit carrying a R¹ to R⁵ substituent which represents a hydrogen, and at least one carbon atom of the monomer unit of Formula 7-B carrying a R¹¹ to R¹⁶ substituent which represents a hydrogen atom,
or between a chelating monomer unit of Formula 6-B, on at least one carbon atom of the monomer unit carrying a R⁶ to R¹⁰ substituent which represents a hydrogen atom, and at least one carbon atom of the monomer unit of Formula 7-B carrying a R¹¹ to R¹⁶ substituent which represents a hydrogen atom.

24. The phenolic-formaldehyde resin according to claim 23, wherein the chelating monomer units are of Formula 1-B wherein:
at least one of the R¹ to R⁵ substituent represents an —OH group or a salt form, and
at least one of the R¹ to R⁵ substituent represents a of hydrogen, and wherein:
q is 0, 1, 2 or 3,
R¹, R², R³, R⁴ and R⁵ independently represent:
a hydrogen atom, or
a group chosen from:
—OH, or a salified form, in particular chosen from —ONa, —OK, —OLi, and —OCs,
linear or branched C₁ to C₁₀ alkyl,
L is a linker chosen from one of the following structures: 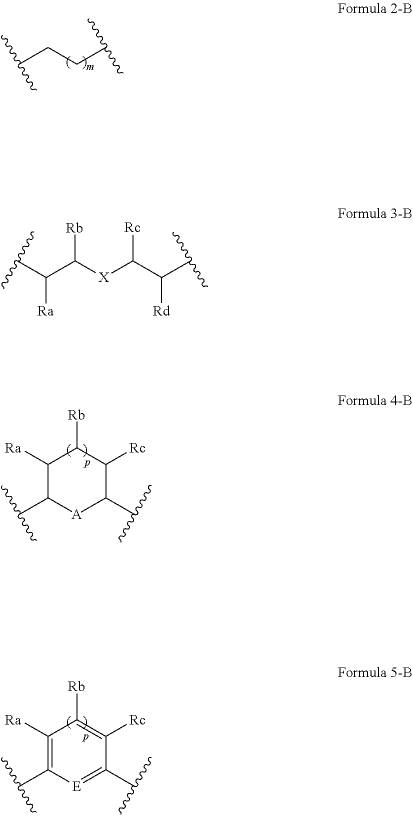
wherein
m is 0, 1, 2, 3, 4 or 5,
p is 0 or 1,
A represents a —CH₂ group,
-E represents a CH group, or a C—OH group,
Rₐ, R_{b}, R_{c}, and R_{d} represent independently
a group chosen from:
—OH, or a salified form, in particular chosen from —ONa, —OK, —OLi, and —OCs,
linear or branched C₁ to C₁₀ alkyl,
said chelating monomer units of Formula 1-B may be mixed with at least one of the monomer units of Formulas 6-B and 7-B,
and/or
wherein the chelating monomer units are of Formula 6-B wherein:
at least one of the R⁶ to R¹⁰ substituent represents an —OH group or a salified form, and
at least one of the R⁶ to R¹⁰ substituents represent a hydrogen atom,
and wherein
q is 0, 1, 2 or 3,
R¹, R², R³, R⁴ and R⁵ independently represent:
a hydrogen atom, or
a group chosen from:
—OH, or a salified form, in particular chosen from —ONa, —OK, —OLi, and —OCs,
linear or branched C₁ to C₁₀ alkyl,
-L is a linker chosen from one of the following structures: 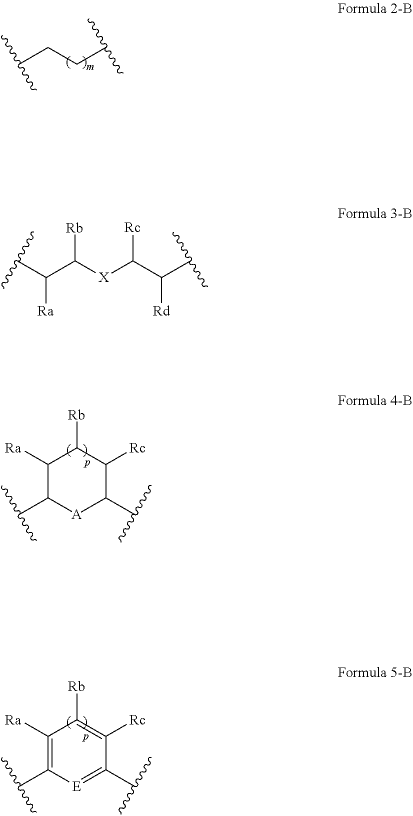
wherein
m is 0, 1, 2, 3, 4 or 5,
p is 0 or 1,
A represents a —CH₂ group,
E represents a CH group, or a C—OH group,
Rₐ, R_{b}, R_{c}, and R_{d} represent independently
a group chosen from:
—OH, or a salified form, in particular chosen from —ONa, —OK, —OLi, and —OCs,
linear or branched C₁ to C₁₀ alkyl,
said chelating monomer units of Formula 6-B may be mixed with at least one of the monomer units of Formulas 1-B and 7-B,
and/or
wherein the monomer units are of Formula 7-B wherein:
at least one of the R¹¹ to R¹⁶ substituents represents an —OH group or a salified form, and at least two of the R¹¹ to R¹⁶ substituents represent a hydrogen atom,
and wherein:
R¹¹, R¹², R¹³, R¹⁴, R¹⁵ and R¹⁶ independently represent:
a hydrogen atom, or
a group chosen from:
—OH, or a salified form, in particular chosen from —ONa, —OK, —OLi, and —OCs,
linear or branched C₁ to C₁₀ alkyl,
linear or branched C₁ to C₁₀ heteroalkyl, the heteroatom being 0,
aryl,
linear or branched C₁ to C₁₀ alkylaryl,
halogen, in particular F or Cl,
linear or branched C₁ to C₁₀ alkylaryl,
halogen, in particular F or Cl,
said monomer units of Formula 7-B are mixed with at least one of the monomer units of Formula 1-B and 6-B.

25. The formo-phenolic resin according to claim 23, wherein the chelating monomer units of Formula 1-B have the structure of Formula 8-B, 9-B, 10-B, 11-B, 12-B 13-B, 14-B or 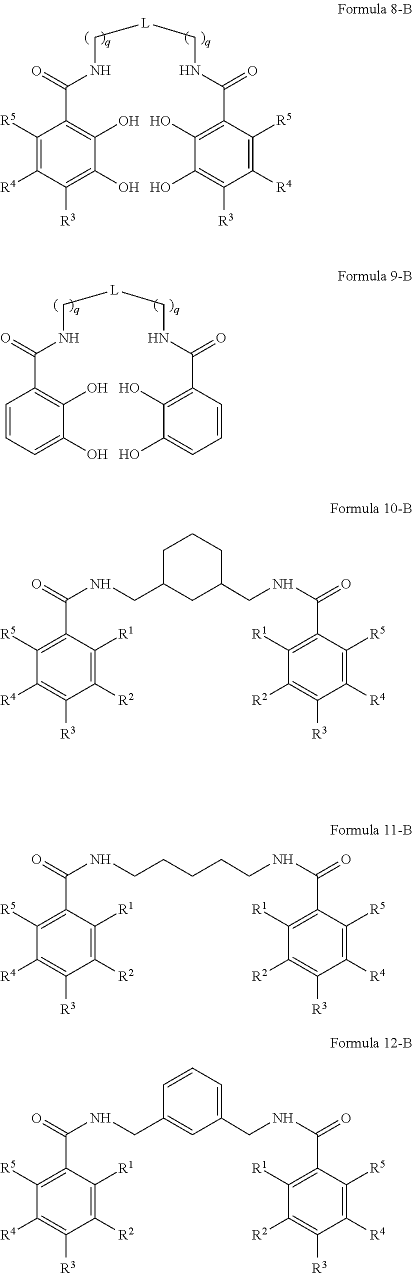 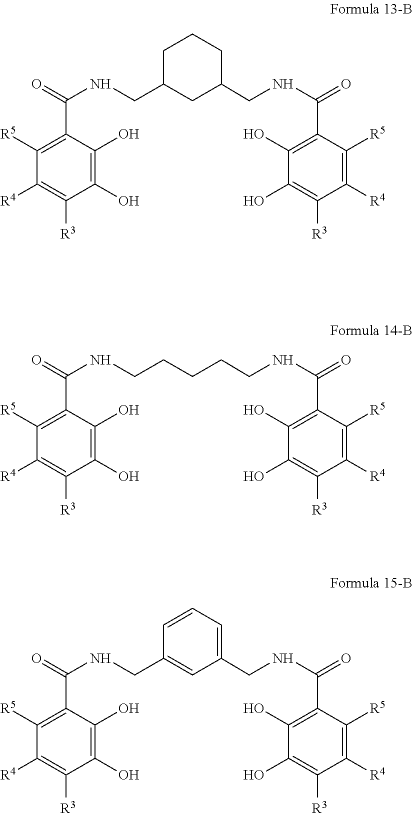
R¹, R², R³, R⁴, R⁵, L and q being as defined in claim 23,
in particular the structure of Formula 16-B, 17-B or 18-B: 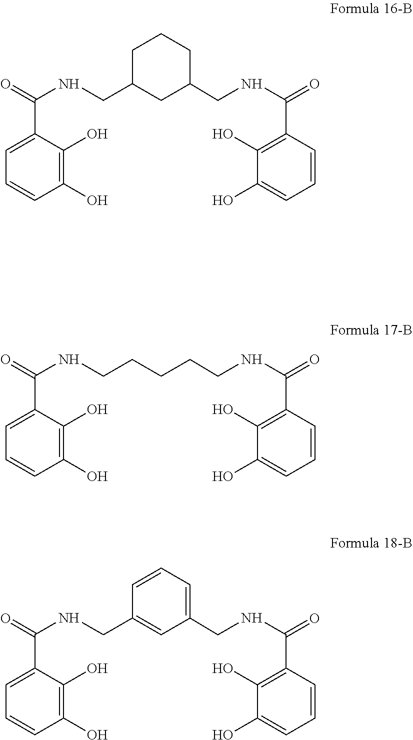 [SMILES: O=C(NCC1CCCC(CNC(=O)c2cccc(O)c2O)C1)c1cccc(O)c1O ; O=C(NCCCCCNC(=O)c1cccc(O)c1O)c1cccc(O)c1O ; O=C(NCc1cccc(CNC(=O)c2cccc(O)c2O)c1)c1cccc(O)c1O]
Formulas 8-B, 9-B, 13-B, 14-B, 15-B, 16-B, 17-B and 18-B wherein the —OH groups are in particular in a salified form, in particular in the form —ONa,
and/or
wherein the chelating monomer units of Formula 6 have the structure of Formula 19-B: 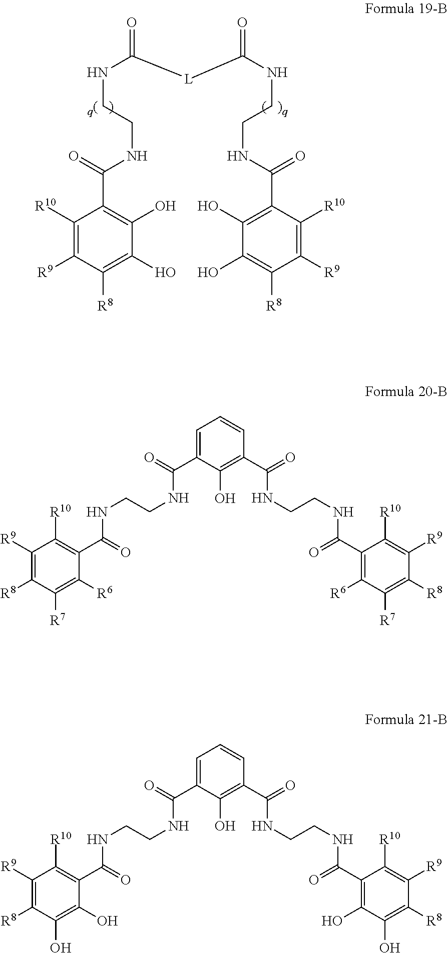
L, q, R⁶, R⁷, R⁸, R⁹ and R¹⁰ being as defined in claim 23,
in particular the structure of Formula 22-B: 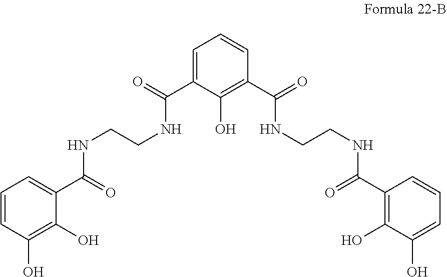 [SMILES: O=C(NCCNC(=O)c1cccc(C(=O)NCCNC(=O)c2cccc(O)c2O)c1O)c1cccc(O)c1O]
Formulas 19-B, 21-B and 22-B wherein the —OH groups are in particular in a salified form, in particular in the —ONa form,
and/or
wherein the monomer units of Formula 7 have the structure of Formula 23-B, 24-B, 25-B or 26-B: 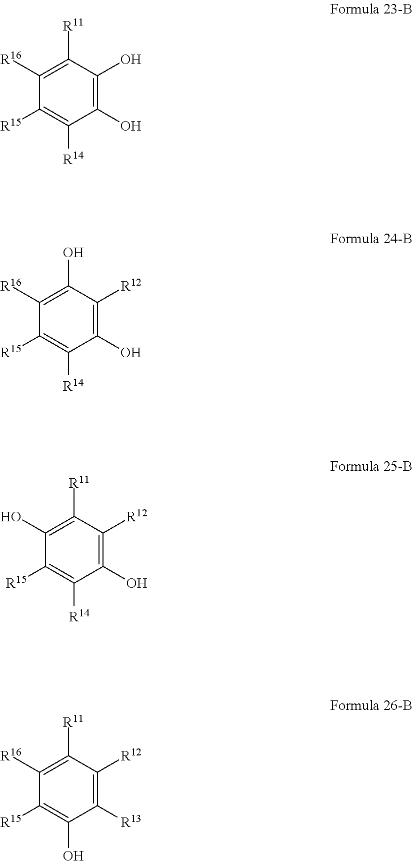
R¹¹, R¹², R¹⁴, R¹⁵ and R¹⁶ being as defined in claim 23,
in particular the structure of Formula 27-B, 28-B, or 29-B: 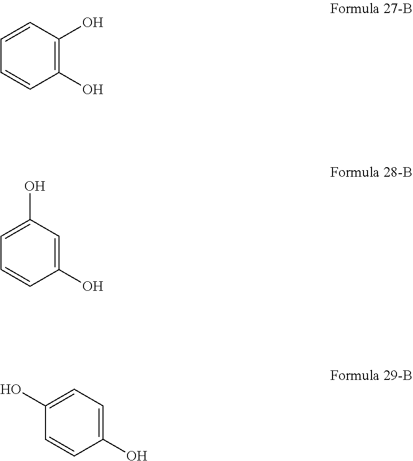 [SMILES: Oc1ccccc1O ; Oc1cccc(O)c1 ; Oc1ccc(O)cc1]
Formulas 23-B, 24-B, 25-B, 26-B, 27-B, 28-B and 29-B wherein the —OH groups are in particular in a salified form, in particular in the —ONa form.

26. The formo-phenolic resin according to claim 23, wherein the polymer consists of:
100% chelating monomer units of Formula 1-B.

27. A method for extracting uranium, in particular in an ionic form, in particular in the form of UO₂²⁺, comprising:
a step of bringing into contact a formo-phenolic resin, with an aqueous solution comprising uranium, said aqueous solution being in particular sea water, and
said formo-phenolic resin consisting of a polymer containing monomer units bonded together by one or more —R″ group(s), in particular by one or more —(CH₂)-group (s),
wherein R″ represents a —(CH₂)— group, a linear or branched —(CH)—C₁ to C₁₀-alkyl group, a —(CH)-aryl group, a —(CH)-heteroaryl group, a linear or branched —(CH)—(C₁ to C₁₀) alkylaryl group, a linear or branched —(CH)—(C₁ to C₁₀-alkyl)heteroaryl, a-(CH)-aryl-(CH)— group, a linear or branched-(CH)—(C₁ to C₁₀-alkyl)-aryl-(C₁ to C₁₀-alkyl)-(CH)-group, a-(CH)-heteroaryl-(CH), a linear or branched (CH)—(C₁ to C₁₀-alkyl)-heteroaryl-(C₁ to C₁₀-alkyl)-(CH)-group,
said monomer units being:
either chelating monomer units of Formula 1 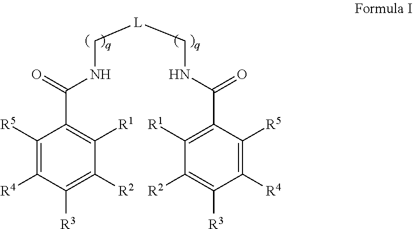
wherein:
at least one of the R¹ to R⁵ substituents represents an —OH group or a salt form, and
at least one of the R¹ to R⁵ substituents represents a hydrogen atom,
and wherein:
q is 0, 1, 2 or 3,
R¹, R², R³, R⁴ and R⁵ independently represent:
a hydrogen atom, or
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl,
heteroaryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O) NRR′ group wherein R and R′ represent independently of each other a hydrogen atom or a C₁ to C₁₀ alkyl group,
L is a linker chosen from one of the following structures: 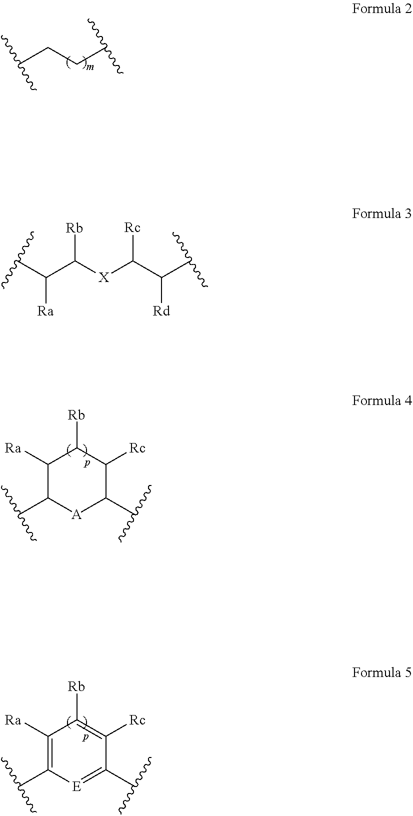
wherein:
m is 0, 1, 2, 3, 4 or 5,
up is 0 or 1,
A represents a —CH₂ group, a —CH—OH group, an oxygen atom, an —NH— group, a N-oxide group or a sulfur atom,
E represents a CH group, a C—OH group, an oxygen atom, a nitrogen atom, a N-oxide group or a sulfur atom,
Rₐ, R_{b}, R_{c}, and R_{d} independently represent a group chosen from:
—OH, or a salified form, in particular chosen from —ONa, —OK, —OLi, and OCs,
—NH2,
—SH,
linear or branched C₁ to C₁₀ alkyl,
linear or branched C₁ to C₁₀ heteroalkyl, the heteroatom being chosen in particular from O, N, S and N═O,
aryl,
heteroaryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ represent independently of each other a hydrogen atom, a C₁ to C₁₀ alkyl group, or a —C(O)NRR′ group wherein R and R′ represent independently of each other a hydrogen atom or a C₁ to C₁₀ alkyl group,
or chelating monomer units of Formula 6 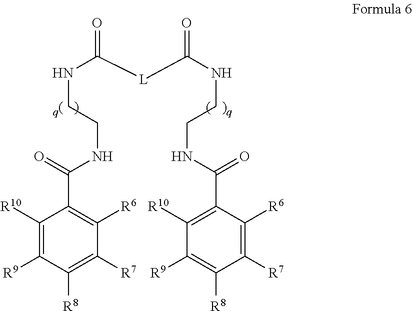
wherein:
at least one of the R⁶ to R¹⁰ substituents represents an —OH group or a salified form, and at least one of the R⁶ to R¹⁰ substituents represents a hydrogen atom,
and wherein:
q and L are as defined above for Formula 1,
R⁶, R⁷, R¹, R⁹ and R¹⁰ independently represent:
a hydrogen atom, or
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl,
heteroaryl,
linear or branched C₁ to C₁₀ alkylaryl,
linear or branched C₁ to C₁₀ heteroalkylaryl, the heteroatom being chosen in particular from O, N and S,
halogen, in particular F or Cl,
branched or unbranched C₃ to C₁₀ cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O) NRR′ group wherein R and R′ represent independently of each other a hydrogen atom or a C₁ to C₁₀ alkyl group,
or monomer units of Formula 7: 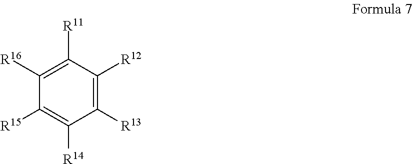
wherein:
at least one of the R¹¹ to R¹⁶ substituents represents an —OH group, or a salt form, and
at least two of the R¹¹ to R¹⁶ substituents represent a hydrogen atom,
and wherein:
—R¹¹, R¹², R¹³, R¹⁴, R¹⁵ and R¹⁶ independently represent:
a hydrogen atom, or
a group chosen from:
—OH, or a salified form, in particular chosen from —ONa, —OK, —OLi, and —OCs,
—NH₂,
—SH,
linear or branched C₁ to C₁₀ alkyl,
linear or branched C₁ to C₁₀ heteroalkyl, the heteroatom being chosen in particular from O, N, S and N═O,
aryl or polyaryl with 1 to 4 aromatic rings,
if R¹⁵ represents an aryl or polyaryl group, said aryl or polyaryl group can be fused with the monomer unit of Formula 7 at position R¹⁶, said monomer unit of Formula 7 being in particular a naphthol,
heteroaryl,
linear or branched C₁ to C₁₀ alkylaryl,
linear or branched C₁ to C₁₀ heteroalkylaryl, the heteroatom being chosen in particular from O, N and S,
halogen, in particular F or Cl,
linear or branched C₁ to C₁₀ alkylaryl,
branched or unbranched C₃ to C₁₀cycloalkyl,
—C(O)OR wherein R represents a hydrogen atom or a C₁ to C₁₀ alkyl group,
—P(O)(OR)(OR′) wherein R and R′ independently represent a hydrogen atom, a C₁ to C₁₀ alkyl group, or a —C(O)NRR′ group wherein R and R′ are independently of each other a hydrogen atom or a C₁ to C₁₀ alkyl group,
and wherein from 2 to 8 monomer units of Formula 7 can be linked together by a linear or branched C₁ to C₁₀ alkyl group, said monomer unit of Formula 7 being in particular a calixarene comprising from 2 to 8 monomer units of Formula 7,
or wherein from 2 to 4 monomer units of Formula 7 can be linked together by a linear or branched C₁ to C₁₀ heteroalkyl group, the heteroatom being in particular 0, the said monomer unit of Formula 7 being in particular a crown ether comprising from 2 to 4 monomer units of Formula 7,
or a mixture of at least two of any of the monomer units of Formulas 1, 6 and 7,
wherein the structure of Formula 7 does not correspond to the structure of Formula 1 or 6,
provided that if the resin consists exclusively of monomer units of Formula 7, at least two of the R¹¹ to R¹⁶ substituent represent a group other than a hydrogen atom,
said —R′— group being located:
either between two chelating monomer units of Formula 1, on at least one carbon atom of the monomer unit carrying a R¹ to R⁵ substituent which represents a hydrogen atom,
or between two chelating monomer units of Formula 6, on at least one carbon atom of the monomer unit carrying a R⁶ to R¹⁰ substituent which represents a hydrogen atom,
or between two monomer units of Formula 7, on at least one carbon atom of the monomer unit carrying a R¹¹ to R¹⁶ substituent which represents a hydrogen atom,
or between a chelating monomer unit of Formula 1, on at least one carbon atom of the monomer unit carrying a R¹ to R⁵ substituent which represents a hydrogen atom, and at least one carbon atom of the monomer unit of Formula 6 carrying a R⁶ to R¹⁰ substituent which represents a hydrogen atom,
or between a chelating monomer unit of Formula 1, on at least one carbon atom of the monomer unit carrying a R¹ to R⁵ substituent which represents a hydrogen atom, and at least one carbon atom of the monomer unit of Formula 7 carrying a R¹¹ to R¹⁶ substituent which represents a hydrogen atom,
or between a chelating monomer unit of Formula 6, on at least one carbon atom of the monomer unit carrying a R⁶ to R¹⁰ substituent which represents a hydrogen atom, and at least one carbon atom of the monomer unit of Formula 7 carrying a R¹¹ to R¹⁶ substituent which represents a hydrogen atom.

28. The method for extracting uranium according to claim 27, further comprising, after the contacting step, a uranium recovery step, said recovery step being carried out in particular by eluting the formo-phenolic resin with an aqueous alkaline solution, and optionally a step for regenerating the formo-phenolic resin. phenolic, in particular by washing the formo-phenolic resin with:
an aqueous solution of soda, then water, or
an aqueous solution of soda, then an aqueous solution of hydrochloric acid, then water,
to obtain a regenerated formo-phenolic resin.

29. The method for extracting uranium according to claim 27, wherein:
the formo-phenolic resin has a Q_{ads} uranium adsorption capacity greater than 5 mg/g, and/or
the percentage of uranium E extraction is greater than 10, and/or
the distribution coefficient Ka is greater than 100 mL/g, and/or
the FS_{U/M} separation factor is greater than 2, where U is uranium and M is the competing metal.

30. The formo-phenolic resin according to claim 23, wherein the polymer consists of:
100% chelating monomer units of Formula 6-B.

31. The formo-phenolic resin according to claim 23, wherein the polymer consists of:
a mixture of chelating monomer units of Formula 1-B and chelating monomer units of Formula 6-B.

32. The formo-phenolic resin according to claim 23, wherein the polymer consists of:
a mixture of chelating monomer units of Formula 1-B and monomer units of Formula 7-B.

33. The formo-phenolic resin according to claim 23, wherein the polymer consists of:
a mixture of chelating monomer units of Formula 6-B and monomer units of Formula 7-B.

34. The formo-phenolic resin according to claim 23, wherein the polymer consists of:
a mixture of chelating monomer units of Formula 1-B, chelating monomer units of Formula 6-B, and monomer units of Formula 7-B.
